(19) United States
(12) Patent Application Publication
(10) Pub. No.: US 2013/0057837 A1
(43) Pub. Date: Mar. 7, 2013

(54) EXPOSURE APPARATUS, EXPOSURE METHOD, DEVICE-MANUFACTURING METHOD, PROGRAM, AND RECORDING MEDIUM

(71) Applicants: Go ICHINOSE, Fukaya-shi (JP); Junichi CHONAN, Kumagaya-shi (JP); Yuichi SHIBAZAKI, Kumagaya-shi (JP); Kenichi SHIRAISHI, Saitama-shi (JP); Makoto Tokoro, Kawasaki-shi (JP)

(72) Inventors: Go ICHINOSE, Fukaya-shi (JP); Junichi CHONAN, Kumagaya-shi (JP); Yuichi SHIBAZAKI, Kumagaya-shi (JP); Kenichi SHIRAISHI, Saitama-shi (JP); Makoto Tokoro, Kawasaki-shi (JP)

(73) Assignee: NIKON CORPORATION, Tokyo (JP)

(21) Appl. No.: 13/432,717

(22) Filed: Mar. 28, 2012

Related U.S. Application Data
(60) Provisional application No. 61/599,137, filed on Feb. 15, 2012.
(60) Provisional application No. 61/476,842, filed on Apr. 19, 2011.

(30) Foreign Application Priority Data
Apr. 6, 2011 (JP) 2011-084704
Jun. 8, 2011 (JP) 2011-128519

(51) Int. Cl. G03B 27/52

(52) U.S. Cl. 355/30

(57) ABSTRACT

An exposure apparatus capable of suppressing the occurrence of exposure defects is provided. The exposure apparatus exposes a substrate with exposure light via a liquid. The exposure apparatus includes an optical member having an emission surface from which exposure light is emitted; a substrate holding apparatus including a first holding portion that releasably holds the lower surface of the substrate, a first surface that defines an aperture in which the substrate can be disposed and that is disposed around the upper surface of the substrate in a state where the substrate is held on the first holding portion, and a first space portion that is in communication with a gap between the upper surface of the substrate and the first surface; a drive apparatus that moves the substrate holding apparatus in a state where an immersion space is formed with the liquid between the optical member and at least one of the upper surface of the substrate and the first surface; a suction port through which fluid in the first space portion is suctioned; and a control apparatus that sets a suction force of the suction port in at least a part of a first period in which exposure of the substrate is executed so as to be smaller than a suction force of the suction port in a second period in which exposure of the substrate is not executed.

### CROSS-REFERENCE TO RELATED APPLICATION

This application is a non-provisional application claiming priority to and the benefit of U.S. provisional application No. 61/476,842, filed on Apr. 19, 2011, and of U.S. provisional application No. 61/599,137, filed on Feb. 15, 2012. Also, priority is claimed on Japanese Patent Application No. 2011-084704, filed on Apr. 6, 2011, and Japanese Patent Application No. 2011-128519, filed on Jun. 8, 2011. The contents of which are incorporated herein by reference.

### BACKGROUND

1. Field of the Invention

The present invention relates to an exposure apparatus, an exposure method, a device-manufacturing method, a program, and a recording medium.

2. Description of Related Art

In the process of manufacturing microdevices such as a semiconductor device or an electronic device, an immersion exposure apparatus that exposes a substrate with exposure light via a liquid, as disclosed in US Patent Application Publication No. 2006/0132737, for example, is known. The exposure apparatus includes a substrate stage capable of moving while holding a substrate, and the substrate is exposed whilst being held on the substrate stage.

### SUMMARY

In an immersion exposure apparatus, when the temperature of the liquid or the temperature of the substrate stage is changed, for example, exposure defects may occur. As a result, defective devices may be produced.

An object of some aspects of the present invention is to provide an exposure apparatus and an exposing method capable of suppressing the occurrence of exposure defects. Another object of some aspects of the present invention is to provide a device-manufacturing method, a program, and a recording medium capable of suppressing the occurrence of defective devices.

According to a first aspect of the present invention, there is provided an exposure apparatus that exposes a substrate with exposure light via a liquid, including: an optical member having an emission surface from which the exposure light is emitted; a substrate holding apparatus including a first holding portion that releasably holds the lower surface of the substrate, a first surface that defines an aperture in which the substrate can be disposed and that is disposed around the upper surface of the substrate in a state where the substrate is held on the first holding portion, and a first space portion that is in communication with a gap between the upper surface of the substrate and the first surface; a drive apparatus that moves the substrate holding apparatus in a state where an immersion space is formed with the liquid between the optical member and at least one of the upper surface of the substrate and the first surface; a suction port through which fluid in the first space portion is suctioned; and a control apparatus that sets a suction force of the suction port in at least a part of a first period in which exposure of the substrate is executed so as to be smaller than a suction force of the suction port in a second period in which exposure of the substrate is not executed.

According to a second aspect of the present invention, there is provided an exposure apparatus that exposes a substrate with exposure light via a liquid, including: an optical member having an emission surface from which the exposure light is emitted; a substrate holding apparatus including a first holding portion that releasably holds the substrate; a chamber member that forms a space in which at least the optical member and the substrate holding apparatus are disposed; a conditioning system that includes a gas supply portion supplying gas to the space and that adjusts an environment of the space; and a suppression mechanism that suppresses gas from being supplied from the gas supply portion in at least a part of a first period in which the exposure of the substrate is executed and that suppresses at least a part of the gas from the gas supply portion from being supplied to the substrate holding apparatus in at least a part of a second period in which the exposure of the substrate is not executed.

According to a third aspect of the present invention, there is provided an exposure apparatus that exposes a substrate with exposure light via a liquid, including: an optical member having an emission surface from which the exposure light is emitted; a substrate holding apparatus including a first holding portion that releasably holds a lower surface of the substrate, a first surface that defines an aperture in which the substrate can be disposed and that is disposed around an upper surface of the substrate in a state where the substrate is held on the first holding portion, a second surface which a side surface of the substrate can face, and a first space portion that is in communication with a gap between the upper surface of the substrate and the first surface; and a suction port through which fluid in the first space portion is suctioned, wherein a contact angle of the second surface with respect to the liquid is smaller than a contact angle of the side surface of the substrate.

According to a fourth aspect of the present invention, there is provided an exposure apparatus that exposes a substrate with exposure light via a liquid, including: an optical member having an emission surface from which the exposure light is emitted; a first holding portion that releasably holds a lower surface of the substrate; a first surface that defines an aperture in which the substrate can be disposed and that is disposed around an upper surface of the substrate in a state where the substrate is held on the first holding portion; a first space portion that is in communication with a gap between the upper surface of the substrate and the first surface; a porous member disposed in the first space portion; and a second surface in which at least a part thereof faces an upper surface of the porous member and which is inclined downward toward an outer side about the center of the aperture, wherein an immersion space is formed between the optical member and at least one of the upper surface of the substrate and the first surface, and at least a part of the liquid of the immersion space, which has been flowed into between the second surface of the first space portion and the upper surface of the porous member via the gap is recovered through the holes of the porous member.

According to a fifth aspect of the present invention, there is provided an exposure apparatus that exposes a substrate with exposure light via a liquid, including: an optical member having an emission surface from which the exposure light is emitted; a first holding portion that releasably holds a lower surface of the substrate; a first surface that defines an aperture in which the substrate can be disposed and that is disposed around an upper surface of the substrate in a state where the substrate is held on the first holding portion; a first space portion that is in communication with a gap between the upper surface of the substrate and the first surface; a porous member disposed in the first space portion; a second surface in which at least a part thereof faces a side surface of the substrate and which is inclined upward toward an outer side about the center of the aperture; and a third surface which faces in a direction opposed to a facing direction of the first surface and in which at least a part thereof faces the upper surface of the porous member, wherein an immersion space is formed between the optical member and at least one of the upper surface of the substrate, the first surface, and the second surface, and at least a part of liquid of the immersion space, which has been flowed into between the third surface of the first space portion and the upper surface of the porous member via the gap is recovered via the holes of the porous member.

According to a sixth aspect of the present invention, there is provided an exposure apparatus that exposes a substrate with exposure light via a liquid, including: an optical member having an emission surface from which the exposure light is emitted; a substrate holding apparatus including a first holding portion that releasably holds the lower surface of the substrate, a first surface that defines an aperture in which the substrate can be disposed and that is disposed around an upper surface of the substrate in a state where the substrate is held on the first holding portion, and a first space portion that is in communication with a gap between the upper surface of the substrate and the first surface; and a porous member that is disposed in the first space portion, that has an upper surface that faces the gap, and which has holes through which fluid in the first space portion is suctioned, wherein a contact angle of an upper surface of the porous member with respect to the liquid is larger than a contact angle of the upper surface of the substrate.

According to a seventh aspect of the present invention, there is provided an exposure apparatus that exposes a substrate with exposure light via a liquid, including: an optical member having an emission surface from which the exposure light is emitted; a substrate holding apparatus including a first holding portion that releasably holds a lower surface of the substrate, a first surface that defines an aperture in which the substrate can be disposed and that is disposed around an upper surface of the substrate in a state where the substrate is held on the first holding portion, and a first space portion that is in communication with a gap between the upper surface of the substrate and the first surface; a porous member that is disposed in the first space portion, that has an upper surface that faces the gap, and that has holes through which fluid in the first space portion is suctioned; and a liquid-repellent member which is disposed in at least a part of the upper surface, and which has a surface of which a contact angle with respect to the liquid is larger than that of the upper surface of the substrate.

According to an eighth aspect of the present invention, there is provided an exposure apparatus that exposes a substrate with exposure light via a liquid, including: an optical member having an emission surface from which the exposure light is emitted; a substrate holding apparatus including a first holding portion that releasably holds a lower surface of the substrate, a first surface that defines an aperture in which the substrate can be disposed and that is disposed around an upper surface of the substrate in a state where the substrate is held on the first holding portion, and a first space portion that is in communication with a gap between the upper surface of the substrate and the first surface; a first porous member that is disposed in the first space portion and that has first holes through which fluid in the first space portion is suctioned; and a second porous member that is disposed in the upper surface of the first porous member so as to face the gap and that has second holes smaller than the first holes.

According to a ninth aspect of the present invention, there is provided an exposure apparatus that exposes a substrate with exposure light via a liquid, including: an optical member having an emission surface from which the exposure light is emitted; a substrate holding apparatus including a first holding portion that releasably holds the lower surface of the substrate, a first surface that defines an aperture in which the substrate can be disposed and that is disposed around the upper surface of the substrate in a state where the substrate is held on the first holding portion, and a first space portion that is in communication with a gap between the upper surface of the substrate and the first surface; a porous member that is disposed in the first space portion and that has first holes through which fluid in the first space portion is suctioned; and a wire member disposed in the gap so that at least a part thereof is in contact with the porous member.

According to a tenth aspect of the present invention, there is provided an exposure apparatus that exposes a substrate with exposure light via a liquid, including: an optical member having an emission surface from which the exposure light is emitted; a first member that includes a first upper surface in which an immersion space of the liquid is formed between the emission surface and the first upper surface and that is movable to an irradiation position such that the first member is irradiated with the exposure light from the emission surface; and a second member that includes a second upper surface which is disposed with a gap between the first upper surface and the second upper surface and in which the immersion space of the liquid is formed between the emission surface and the second upper surface, and that is movable to the irradiation position together with the first member, wherein at least one of a first side surface of the first member that faces the second member and a second side surface of the second member that faces the first member is inclined upward toward an outer side about the center of the first member.

According to an eleventh aspect of the present invention, there is provided an exposure apparatus that exposes a substrate with an exposure light via a liquid, including: an optical member having an emission surface from which the exposure light is emitted; a first member that includes a first upper surface in which an immersion space of the liquid is formed between the emission surface and the first upper surface and that is movable to an irradiation position such that the first member is irradiated with the exposure light from the emission surface; and a second member that includes a second upper surface which is disposed with a gap between the first upper surface and the second upper surface and in which the immersion space of the liquid is formed between the emission surface and the second upper surface, and that is movable to the irradiation position together with the first member, wherein at least one of a first side surface of the first member that faces the second member and a second side surface of the second member that faces the first member is inclined downward toward an outer side about the center of the first member.

According to a twelfth aspect of the present invention, there is provided an exposure apparatus that exposes a substrate with an exposure light via a liquid interposed, including: an optical member having an emission surface from which the exposure light is emitted; a first member that includes a first upper surface; and a second member that includes a second upper surface, wherein the first member and the second member are movable to a position in a state where the first upper surface and the second upper surface are arranged in parallel with a gap interposed, an immersion space formed close to the emission surface is formed on the gap, and wherein a first side surface of the first member that faces the second member includes an inclined surface that extends upward toward the second member.

According to a thirteenth aspect of the present invention, there is provided a device-manufacturing method including: exposing a substrate using the exposure apparatus according to any one of the first to eleventh aspects; and developing the exposed substrate.

According to a fourteenth aspect of the present invention, there is provided an exposure method of exposing a substrate with exposure light via a liquid, including: executing the exposure of the substrate while moving a substrate holding apparatus including a first holding portion that releasably holds a lower surface of the substrate, a first surface that defines an aperture in which the substrate can be disposed and that is disposed around the upper surface of the substrate in a state where the substrate is held on the first holding portion, and a first space portion that is in communication with a gap between the upper surface of the substrate and the first surface, in a state where an immersion space is formed with the liquid between an optical member having an emission surface from which the exposure light is emitted and at least one of the first surface of the substrate holding apparatus and the upper surface of the substrate; suctioning fluid in the first space portion from a suction port with a first suction force in at least a part of a first period in which the exposure of the substrate is executed; and suctioning fluid in the first space portion from the suction port with a second suction force larger than the first suction force in a second period in which the exposure of the substrate is not executed.

According to a fifteenth aspect of the present invention, there is provided an exposure method of exposing a substrate with exposure light via a liquid, including: executing the exposure of the substrate in a state where an immersion space is formed with the liquid between an optical member having an emission surface from which the exposure light is emitted and a substrate held on a first holding portion of a substrate holding apparatus; adjusting the environment of a space in which the optical member and the substrate holding apparatus are disposed by supplying gas from a gas supply portion of a conditioning system to the space in at least a part of a first period in which the exposure of the substrate is executed; and executing a process of suppressing at least a part of the gas from the gas supply portion from being supplied to the substrate holding apparatus in at least a part of a second period in which the exposure of the substrate is not executed.

According to a sixteenth aspect of the present invention, there is provided an exposure method of exposing a substrate with exposure light via a liquid, including: executing the exposure of the substrate in a state where an immersion space is formed with the liquid between an optical member having an emission surface from which the exposure light is emitted and at least one of a first surface of a substrate holding apparatus and an upper surface of the substrate, the substrate holding apparatus including a first holding portion that releasably holds a lower surface of the substrate, the first surface that defines an aperture in which the substrate can be disposed and that is disposed around the upper surface of the substrate in a state where the substrate is held on the first holding portion, a second surface which a side surface of the substrate faces, and of which a contact angle with respect to the liquid is smaller than that of the side surface of the substrate, and a first space portion that is in communication with a gap between the upper surface of the substrate and the first surface; suctioning fluid in the first space portion from a suction port in at least a part of a first period in which the exposure of the substrate is executed; and suctioning fluid from the suction port in a state where an object is held on the first holding portion in at least a part of a second period in which the exposure of the substrate is not executed.

According to a seventeenth aspect of the present invention, there is provided an exposure method of exposing a substrate with exposure light via a liquid, including: executing the exposure of the substrate in a state where an immersion space is formed with the liquid between an optical member having an emission surface from which the exposure light is emitted and at least one of a first surface of a substrate holding apparatus and an upper surface of the substrate, the substrate holding apparatus including a first holding portion that releasably holds a lower surface of the substrate, the first surface that defines an aperture in which the substrate can be disposed and that is disposed around the upper surface of the substrate in a state where the substrate is held on the first holding portion, a second surface which a side surface of the substrate faces, and a first space portion that is in communication with a gap between the upper surface of the substrate and the first surface; suctioning fluid in the first space portion from a suction port in at least a part of a first period in which the exposure of the substrate is executed; and suctioning fluid in the first space portion from the suction port in a state where an immersion space is formed with the liquid between the optical member and the first surface and the upper surface of an object held on the first holding portion in at least a part of a second period in which the exposure of the substrate is not executed.

According to an eighteenth aspect of the present invention, there is provided an exposure method of exposing a substrate with exposure light via a liquid, including: exposing the substrate in a state where an immersion space is formed with the liquid between an optical member having an emission surface from which the exposure light is emitted and at least one of an upper surface of the substrate held on a first holding portion that releasably holds a lower surface of the substrate and a first surface that defines an aperture in which the substrate can be disposed and that is disposed around the upper surface of the substrate in a state where the substrate is held on the first holding portion; and recovering, through the holes of a porous member, at least a part of the liquid of the immersion space, which has been flowed via a gap between the upper surface of the substrate and the first surface and into between the upper surface of the porous member disposed in a first space portion is in communication with the gap and a second surface in which at least a part thereof faces the upper surface of the porous member and which is inclined downward toward an outer side about the center of the aperture.

According to a nineteenth aspect of the present invention, there is provided an exposure method of exposing a substrate with exposure light via a liquid, including: exposing the substrate in a state where an immersion space is formed with the liquid between an optical member having an emission surface from which the exposure light is emitted and at least one of an upper surface of the substrate held on a first holding portion that releasably holds a lower surface of the substrate, a first surface that defines an aperture in which the substrate can be disposed and that is disposed around the upper surface of the substrate in a state where the substrate is held on the first holding portion, and a second surface in which at least a part thereof faces the side surface of the substrate and which is inclined upward toward an outer side about the center of the aperture; and recovering, through the holes of a porous member, at least a part of the liquid of the immersion space, which has been flowed via a gap between an upper surface of the substrate and the first surface and into between the upper surface of the porous member disposed in a first space portion that is in communication with the gap and a third surface which faces in a direction opposed to a facing direction of the first surface, and in which at least a part thereof faces the upper surface of the porous member.

According to a twentieth aspect of the present invention, there is provided an exposure method of exposing a substrate with exposure light via a liquid interposed, the method including: exposing the substrate in a state where an immersion space is formed with the liquid between an optical member that includes an emission surface from which the exposure light is emitted and an upper surface of the substrate that is held on a first holding portion that releasably holds a lower surface of the substrate; and forming the immersion space between the emission surface and at least one of a first upper surface of a first member that is movable to an irradiation position such that the first member is irradiated with the exposure light from the emission surface and a second upper surface of a second member that is disposed with a gap interposed between the first upper surface and the second upper surface and is movable to the irradiation position together with the first member, wherein at least one of a first side surface of the first member that faces the second member and a second side surface of the second member that faces the first member is inclined upward toward an outer side about the center of the first member.

According to a twenty-first aspect of the present invention, there is provided an exposure method of exposing a substrate with an exposure light via a liquid interposed, including: exposing the substrate in a state where an immersion space is formed with the liquid between an optical member that includes an emission surface from which the exposure light is emitted and an upper surface of the substrate that is held on a first holding portion that releasably holds a lower surface of the substrate; and forming the immersion space between the emission surface and at least one of a first upper surface of a first member that is movable to an irradiation position such that the first member is irradiated with the exposure light from the emission surface and a second upper surface of a second member that is disposed with a gap interposed between the first upper surface and the second upper surface and is movable to the irradiation position together with the first member, wherein at least one of a first side surface of the first member that faces the second member and a second side surface of the second member that faces the first member is inclined downward toward an outer side about the center of the first member.

According to a twenty-second aspect of the present invention, there is provided a device-manufacturing method including: exposing a substrate using the exposure method according to any one of the thirteenth to twentieth aspects; and developing the exposed substrate.

According to a twenty-third aspect of the present invention, there is provided a program for causing a computer to execute control of an exposure apparatus that exposes a substrate with exposure light via a liquid, the control including: executing the exposure of the substrate while moving a substrate holding apparatus including a first holding portion that releasably holds a lower surface of the substrate, a first surface that defines an aperture in which the substrate can be disposed and that is disposed around the upper surface of the substrate in a state where the substrate is held on the first holding portion, and a first space portion that is in communication with a gap between the upper surface of the substrate and the first surface, in a state where an immersion space is formed with the liquid between an optical member having an emission surface from which the exposure light is emitted and at least one of the first surface of the substrate holding apparatus and the upper surface of the substrate; suctioning fluid in the first space portion from a suction port with a first suction force in at least a part of a first period in which the exposure of the substrate is executed; and suctioning fluid in the first space portion from the suction port with a second suction force larger than the first suction force in a second period in which the exposure of the substrate is not executed.

According to a twenty-fourth aspect of the present invention, there is provided a program for causing a computer to execute control of an exposure apparatus that exposes a substrate with exposure light via a liquid, the control including: executing the exposure of the substrate in a state where an immersion space is formed with the liquid between an optical member having an emission surface from which the exposure light is emitted and a substrate held on a first holding portion of a substrate holding apparatus; adjusting the environment of a space in which the optical member and the substrate holding apparatus are disposed by supplying gas from a gas supply portion of a conditioning system to the space in at least a part of a first period in which the exposure of the substrate is executed; and executing a process of suppressing at least a part of the gas from the gas supply portion from being supplied to the substrate holding apparatus in at least a part of a second period in which the exposure of the substrate is not executed.

According to a twenty-fifth aspect of the present invention, there is provided a program for causing a computer to execute control of an exposure apparatus that exposes a substrate with exposure light via a liquid, and to execute the steps of: executing the exposure of the substrate in a state where an immersion space is formed with the liquid between an optical member having an emission surface from which the exposure light is emitted and at least one of a first surface of a substrate holding apparatus and the upper surface of the substrate, the substrate holding apparatus including a first holding portion that releasably holds a lower surface of the substrate, the first surface that defines an aperture in which the substrate can be disposed and that is disposed around the upper surface of the substrate in a state where the substrate is held on the first holding portion, a second surface which the side surface of the substrate faces, and of which the contact angle with respect to the liquid is smaller than that of the side surface of the substrate, and a first space portion that is in communication with a gap between the upper surface of the substrate and the first surface; suctioning fluid in the first space portion from a suction port in at least a part of a first period in which the exposure of the substrate is executed; and suctioning fluid from the suction port in a state where an object is held on the first holding portion in at least a part of a second period in which the exposure of the substrate is not executed.

According to a twenty-sixth aspect of the present invention, there is provided a program for causing a computer to execute control of an exposure apparatus that exposes a substrate with exposure light via a liquid, and to execute the steps of: executing the exposure of the substrate in a state where an immersion space is formed with the liquid between an optical member having an emission surface from which the exposure light is emitted and at least one of a first surface of a substrate holding apparatus and the upper surface of the substrate, the substrate holding apparatus including a first holding portion that releasably holds a lower surface of the substrate, the first surface that defines an aperture in which the substrate can be disposed and that is disposed around the upper surface of the substrate in a state where the substrate is held on the first holding portion, a second surface which the side surface of the substrate faces, and a first space portion that is in communication with a gap between the upper surface of the substrate and the first surface; suctioning fluid in the first space portion from a suction port in at least a part of a first period in which the exposure of the substrate is executed; and suctioning fluid in the first space portion from the suction port in a state where an immersion space is formed with the liquid between the optical member and the first surface and the upper surface of an object held on the first holding portion in at least a part of a second period in which the exposure of the substrate is not executed.

According to a twenty-seventh aspect of the present invention, there is provided a program for causing a computer to execute control of an exposure apparatus that exposes a substrate with exposure light via a liquid, and to execute the steps of: exposing the substrate in a state where an immersion space is formed with the liquid between an optical member having an emission surface from which the exposure light is emitted and at least one of the upper surface of the substrate held on a first holding portion that releasably holds the lower surface of the substrate and a first surface that defines an aperture in which the substrate can be disposed and that is disposed around the upper surface of the substrate in a state where the substrate is held on the first holding portion; and recovering, through the holes of a porous member, at least a part of the liquid of the immersion space, which has been flowed via a gap between the upper surface of the substrate and the first surface and into between the upper surface of the porous member disposed in a first space portion that is in communication with the gap and a second surface in which at least a part thereof faces the upper surface of the porous member and which is inclined downward toward an outer side about the center of the aperture.

According to a twenty-eighth aspect of the present invention, there is provided a program for causing a computer to execute control of an exposure apparatus that exposes a substrate with exposure light via a liquid, and to execute the steps of: exposing the substrate in a state where an immersion space is formed with the liquid between an optical member having an emission surface from which the exposure light is emitted and at least one of an upper surface of the substrate held on a first holding portion that releasably holds a lower surface of the substrate, a first surface that defines an aperture in which the substrate can be disposed and that is disposed around the upper surface of the substrate in a state where the substrate is held on the first holding portion, and a second surface in which at least a part thereof faces a side surface of the substrate and which is inclined upward toward an outer side about the center of the aperture; and recovering, via holes of a porous member, at least a part of the liquid of the immersion space, which has been flowed via a gap between the upper surface of the substrate and the first surface and into between an upper surface of the porous member disposed in a first space portion that is in communication with the gap and a third surface which faces the opposite direction of the first surface, and in which at least a part thereof faces the upper surface of the porous member.

According to a twenty-ninth aspect of the present invention, there is provided a program for causing a computer to execute control of an exposure apparatus that exposes a substrate with exposure light via a liquid interposed, and to execute the steps of: exposing the substrate in a state where an immersion space is formed with the liquid between an optical member that includes an emission surface from which the exposure light is emitted and an upper surface of the substrate that is held on a first holding portion that releasably holds a lower surface of the substrate; and forming the immersion space between the emission surface and at least one of a first upper surface of a first member that is movable to an irradiation position such that the first member is irradiated with the exposure light from the emission surface and a second upper surface of a second member that is disposed with a gap interposed between the first upper surface and the second upper surface and is movable to the irradiation position together with the first member, wherein at least one of a first side surface of the first member that faces the second member and a second side surface of the second member that faces the first member is inclined upward toward an outer side about the center of the first member.

According to a thirtieth aspect of the present invention, there is provided a program for causing a computer to execute control of an exposure apparatus that exposes a substrate with exposure light via a liquid, and to execute the steps of: exposing the substrate in a state where an immersion space is formed with the liquid between an optical member that includes an emission surface from which the exposure light is emitted and an upper surface of the substrate that is held on a first holding portion that holds and can release a lower surface of the substrate; and forming the immersion space between the emission surface and at least one of a first upper surface of a first member that is movable to an irradiation position such that the first member is irradiated with the exposure light from the emission surface and a second upper surface of a second member that is disposed with a gap interposed between the first upper surface and the second upper surface and is movable to the irradiation position together with the first member, wherein at least one of a first side surface of the first member that faces the second member and a second side surface of the second member that faces the first member is inclined downward toward an outer side about the center of the first member.

According to a thirty-first aspect of the present invention, there is provided a computer-readable recording medium in which the program according to any one of the twenty-second to thirtieth aspects is recorded.

According to aspects of the present invention, the occurrence of exposure defects can be suppressed. Moreover, according to aspects of the present invention, the occurrence of defective devices can be suppressed.

### BRIEF DESCRIPTION OF THE DRAWINGS

FIG. 1 is a schematic block diagram showing an example of an exposure apparatus according to a first embodiment.

FIG. 2 is a diagram showing an example of a liquid immersion member and a substrate stage according to the first embodiment.

FIG. 3 is a diagram showing a part of the substrate stage according to the first embodiment.

FIG. 4 is a flowchart showing an example of an exposure method according to the first embodiment.

FIG. 5 is a diagram for explaining an example of the exposure method according to the first embodiment.

FIG. 6 is a diagram for explaining an example of the exposure method according to the first embodiment.

FIG. 7 is a diagram showing a part of the substrate stage according to the first embodiment.

FIG. 8 is a diagram showing a part of the substrate stage according to the first embodiment.

FIG. 9 is a diagram showing a part of a substrate stage according to a second embodiment.

FIG. 10 is a diagram showing a part of the substrate stage according to the second embodiment.

FIG. 11 is a diagram showing a part of a substrate stage according to a third embodiment.

FIG. 12 is a diagram showing an example of a substrate stage according to a fourth embodiment.

FIG. 13 is a diagram showing a part of a substrate stage according to a fourth embodiment.

FIG. 14 is a diagram showing an example of a substrate stage.

FIG. 15 is a diagram showing an example of a substrate stage.

FIG. 16 is a diagram showing an example of a substrate stage.

FIG. 17 is a diagram showing an example of an exposure apparatus according to a fifth embodiment.

FIG. 18 is a diagram showing an example of the exposure apparatus according to the fifth embodiment.

FIG. 19 is a diagram showing an example of the exposure apparatus according to the fifth embodiment.

FIG. 20 is a diagram showing an example of an exposure apparatus according to a sixth embodiment.

FIG. 21 is a diagram showing an example of an exposure apparatus according to a seventh embodiment.

FIG. 22 is a diagram showing an example of an exposure apparatus according to an eighth embodiment.

FIG. 23 is a diagram showing an example of the exposure apparatus according to the eighth embodiment.

FIG. 24 is a diagram showing an example of an exposure apparatus according to a ninth embodiment.

FIG. 25 is a diagram showing an example of the exposure apparatus according to the ninth embodiment.

FIG. 26 is a diagram showing an example of the exposure apparatus according to the ninth embodiment.

FIG. 27 is a diagram showing an example of an exposure apparatus according to a tenth embodiment.

FIG. 28 is a diagram showing an example of the exposure apparatus according to the tenth embodiment.

FIG. 29 is a diagram showing an example of an exposure apparatus according to an eleventh embodiment.

FIG. 30 is a diagram showing an example of an exposure apparatus according to a twelfth embodiment.

FIG. 31 is a diagram showing an example of an exposure apparatus according to a thirteenth embodiment.

FIG. 32 is a diagram showing an example of an exposure apparatus according to a fourteenth embodiment.

FIG. 33 is a diagram showing an example of an exposure apparatus according to a fifteenth embodiment.

FIG. 34 is a diagram showing an example of an exposure apparatus according to the fifteenth embodiment.

FIG. 35 is a diagram showing an example of an exposure apparatus according to the fifteenth embodiment.

FIG. 36 is a diagram showing an example of an exposure apparatus according to the fifteenth embodiment.

FIG. 37 is a diagram showing an example of an exposure apparatus according to the fifteenth embodiment.

FIG. 38 is a diagram showing an example of an exposure apparatus according to the fifteenth embodiment.

FIG. 39 is a diagram showing an example of an exposure apparatus according to the fifteenth embodiment.

FIG. 40 is a diagram showing an example of an exposure apparatus according to the fifteenth embodiment.

FIG. 41 is a diagram showing an example of an exposure apparatus according to the fifteenth embodiment.

FIG. 42 is a diagram showing an example of an exposure apparatus according to the fifteenth embodiment.

FIG. 43 is a diagram showing an example of an exposure apparatus according to the fifteenth embodiment.

FIG. 44 is a diagram showing an example of an exposure apparatus according to the fifteenth embodiment.

FIG. 45 is a diagram showing an example of an exposure apparatus according to the fifteenth embodiment.

FIG. 46 is a flowchart showing an example of a device-manufacturing process.

### DESCRIPTION OF EMBODIMENTS

Hereinafter, although embodiments of the present invention will be described with reference to the drawings, the present invention is not limited thereto. In the following description, an XYZ orthogonal coordinate system is defined, and the positional relationship of respective parts will be described with reference to the XYZ orthogonal coordinate system. A predetermined direction within a horizontal plane is defined as the X-axis direction, a direction orthogonal to the X-axis direction within the horizontal plane as the Y-axis direction, and a direction orthogonal (that is, a direction perpendicular) to the X-axis direction and the Y-axis direction as the Z-axis direction. Moreover, the rotational (inclination) directions around the X, Y, and Z axes are defined as the θX, θY, and θZ directions, respectively.

### First Embodiment

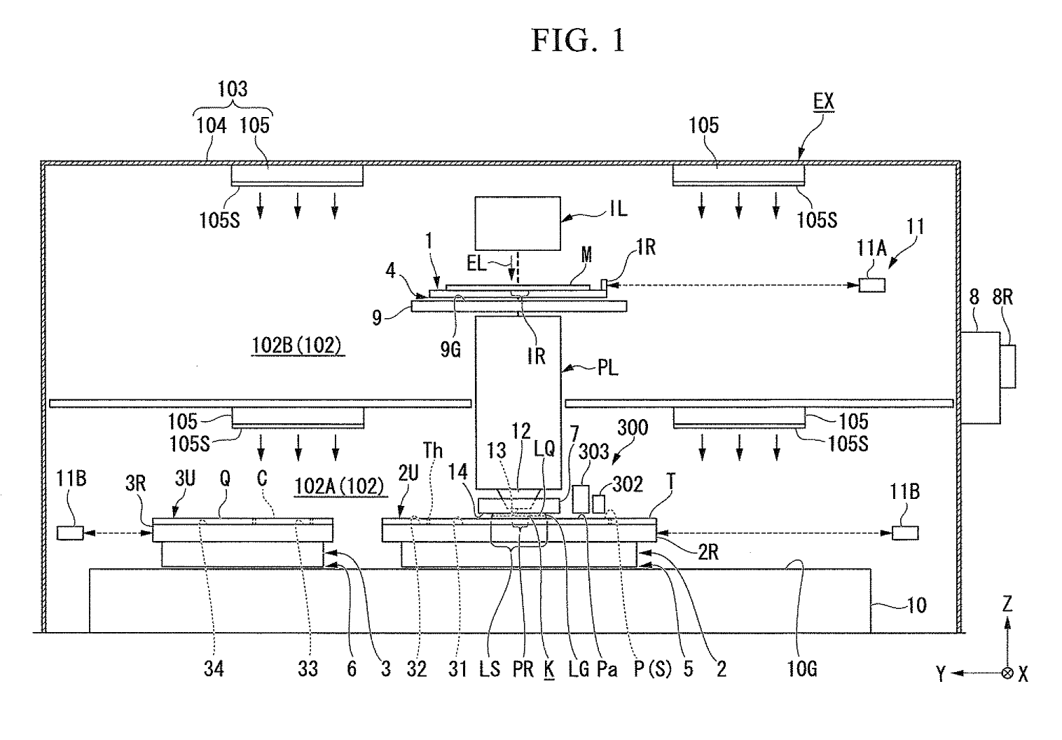

A first embodiment will be described. FIG. 1 is a schematic block diagram showing an example of an exposure apparatus EX according to the first embodiment. The exposure apparatus EX of the present embodiment is an immersion exposure apparatus that exposes a substrate P with exposure light EL via a liquid LQ. In the present embodiment, an immersion space LS is formed so that at least a part of an optical path of exposure light EL is filled with the liquid LQ. The immersion space refers to a portion (space or region) filled with a liquid. The substrate is exposed to exposure light EL via the liquid LQ of the immersion space LS. In the present embodiment, water (pure water) is used as the liquid LQ.

Moreover, the exposure apparatus EX of the present embodiment is an exposure apparatus which includes a substrate stage and a measuring stage, as disclosed, for example, in the specification of U.S. Pat. No. 6,897,963, the specification of European Patent Application Publication No. 1713113, and the like.

In FIG. 1, the exposure apparatus EX includes: a mask stage 1 capable of moving while holding a mask M; a substrate stage 2 capable of moving while holding a substrate P; a measuring stage 3 capable of moving while mounting a measuring member C and a measuring device that measure exposure light EL without holding the substrate P; a driving system 4 that moves the mask stage 1; a driving system 5 that moves the substrate stage 2; a driving system 6 that moves the measuring stage 3; an illumination system IL that illuminates the mask M with exposure light EL; a projection optical system PL that projects an image of a pattern of the mask M illuminated with exposure light EL onto the substrate P; a liquid immersion member 7 capable of forming an immersion space LS so that at least a part of the optical path of exposure light EL is filled with the liquid LQ; a control apparatus 8 that controls the operation of the entire exposure apparatus EX; and a storage device 8R that is connected to the control apparatus 8 so as to store various items of information related to exposure. The storage device 8R includes a memory such as a RAM and a recording medium such as a hard disk or a CD-ROM, for example. An operating system (OS) for controlling a computer system is installed in the storage device 8R, and a program for controlling the exposure apparatus EX is stored in the storage device 8R.

Moreover, the exposure apparatus EX includes an interferometer system 11 that measures the positions of the mask stage 1, the substrate stage 2, and the measuring stage 3 and a detection system 300. The detection system 300 includes an alignment system 302 that is detectable for an alignment mark of the substrate P and a surface position detection system 303 that is detectable for the position of an upper surface (front surface) Pa of the substrate P. In addition, the detection system 300 may include an encoder system that detects the position of the substrate stage 2, as disclosed in the specification of US Patent Application Publication No. 2007/0288121, for example. The detection system 300 may include only one of an interferometer system and an encoder system.

The mask M may be a reticle on which a device pattern projected onto the substrate P is formed. The mask M may be a transmissive mask that includes a transparent plate such as a glass plate and a pattern which is formed on the transparent plate using a shielding material such as chromium, for example. In addition, a reflective mask may be used as the mask M.

The substrate P is a substrate for manufacturing devices. The substrate P includes a base such as a semiconductor wafer and a photosensitive film formed on the base, for example. The photosensitive film is a film formed of a photosensitive material (photoresist). Moreover, the substrate P may include another film in addition to the photosensitive film. For example, the substrate P may include an anti-reflection film and may include a protective film (top-coat film) that protects the photosensitive film.

Moreover, the exposure apparatus EX includes a chamber apparatus 103 that regulates the environment (at least one of temperature, humidity, pressure, and cleanness) of the space 102 through which exposure light EL passes. The chamber apparatus 103 includes a chamber member 104 that forms the space 102 and a conditioning system 105 that regulates the environment of the space 102.

The space 102 includes a space 102A and a space 102B. The space 102A is a space in which the substrate P is processed. The substrate stage 2 and the measuring stage 3 move through the space 102A.

The conditioning system 105 includes a gas supply portion 105S that supplies gas to the spaces 102A and 102B, and supplies gas from the gas supply portion 105S to the spaces 102A and 102B to regulate the environment of the spaces 102A and 102B. In the present embodiment, at least the substrate stage 2, the measuring stage 3, and a terminating optical element (an optical element) 12 of the projection optical system PL are disposed in the space 102A.

The illumination system IL irradiates a predetermined illumination region IR with exposure light EL. The illumination region IR includes a position that can be irradiated with exposure light EL emitted from the illumination system IL. The illumination system IL illuminates at least a part of the mask M disposed in the illumination region IR with exposure light EL having a uniform luminance distribution. Examples of light that can be used as exposure light EL emitted from the illumination system IL include deep ultraviolet (DUV) light such as emission lines (g-ray, h-ray, i-ray) emitted, for example, from a mercury lamp and KrF excimer laser light (wavelength: 248 nm), and vacuum ultraviolet (VUV) light such as ArF excimer laser light (with a wavelength of 193 nm) and F2 laser light (wavelength: 157 nm). In the present embodiment, ArF excimer laser light, which is ultraviolet light (vacuum ultraviolet light), is used as exposure light EL.

The mask stage 1 can move on a guiding surface 9G of a base member 9 including the illumination region IR in a state of holding the mask M. The driving system 4 includes a planar motor for moving the mask stage 1 on the guiding surface 9G. The planar motor includes movable members disposed in the mask stage 1 and stationary members disposed in the base member 9, as disclosed in the specification of U.S. Pat. No. 6,452,292, for example. In the present embodiment, the mask stage 1 can move in six directions of the X, Y, and Z-axis directions and the θX, θY, and θZ directions on the guiding surface 9G by the operation of the driving system 4.

The projection optical system PL irradiates exposure light EL with a predetermined projection region PR. The projection region PR includes a position that can be irradiated with exposure light EL emitted from the projection optical system PL. The projection optical system PL projects an image of the pattern of the mask M onto at least a part of the substrate P disposed in the projection region PR with a predetermined projection magnification. The projection optical system PL of the present embodiment is a reduction system of which the projection magnification is ¼, ⅕, or ⅛, for example. The projection optical system PL may also be either a unity system or a magnification system. In the present embodiment, the optical axis of the projection optical system PL is parallel to the Z axis. Moreover, the projection optical system PL may be a dioptric system that does not include catoptric elements, a catoptric system that does not include dioptric elements, or a catadioptric system that includes both catoptric and dioptric elements. Furthermore, the projection optical system PL may form either an inverted image or an erect image.

The substrate stage 2 can move to a position (projection region PR) that can be irradiated with exposure light EL emitted from the projection optical system PL. The substrate stage 2 can move on a guiding surface 10G of a base member 10 including the projection region PR in a state of holding the substrate P. The measuring stage 3 can move to a position (projection region PR) that can be irradiated with exposure light EL emitted from the projection optical system PL. The measuring stage 3 can move the guiding surface 10G of the base member 10 including the projection region PR in a state of holding the measuring member C. The substrate stage 2 and the measuring stage 3 can move on the guiding surface 10G independently from each other.

The driving system 5 for moving the substrate stage 2 includes a planar motor for moving the substrate stage 2 on the guiding surface 10G. The planar motor includes movable members disposed in the substrate stage 2 and stationary members disposed in the base member 10, as disclosed in the specification of U.S. Pat. No. 6,452,292, for example. Similarly, the driving system 6 for moving the measuring stage 3 includes a planar motor which includes movable members disposed in the measuring stage 3 and stationary members disposed in the base member 10.

In the present embodiment, the substrate stage 2 includes a first holding portion 31 that releasably holds a lower surface Pb of the substrate P and an upper surface 2U that defines an aperture Th where the substrate P can be disposed and that is disposed around an upper surface Pa of the substrate P in a state where the substrate P is held on the first holding portion 31.

In the present embodiment, the substrate stage 2 includes a second holding portion 32 that is disposed around the first holding portion 31 so as to releasably hold a lower surface Tb of a cover member T, as disclosed in the specifications of US Patent Application Publication Nos. 2007/0177125 and 2008/0049209, for example. The cover member T is disposed around the substrate P that is held on the first holding portion 31. In the present embodiment, the cover member T includes the aperture Th in which the substrate P held on the first holding portion 31 is disposed. In the present embodiment, the cover member T includes the upper surface 2U.

In the present embodiment, the first holding portion 31 is capable of holding the substrate P so that the upper surface Pa of the substrate P and the XY plane are substantially parallel to each other. The second holding portion 32 is capable of holding the cover member T so that the upper surface 2U of the cover member T and the XY plane are substantially parallel to each other. In the present embodiment, the upper surface Pa of the substrate P held on the first holding portion 31 and the upper surface 2U of the cover member T held on the second holding portion 32 are disposed substantially within the same plane (are substantially flush with each other). Alternatively, the upper surface Pa of the substrate P and the upper surface 2U of the cover member T can be disposed no within the same plane.

In addition, the cover member T may be formed so as to be integrated with the substrate stage 2.

In the present embodiment, the measuring stage 3 includes a third holding portion 33 that releasably holds the measuring member C and a fourth holding portion 34 that is disposed around the third holding portion 33 so as to releasably hold a cover member Q. The third and fourth holding portions 33 and 34 include a pin chuck mechanism. The cover member Q is disposed around the measuring member C that is held on the third holding portion 33. In addition, a holding mechanism used in at least one of the third holding portion 33 and the fourth holding portion 34 is not limited to the pin chuck mechanism. Moreover, at least one of the measuring member C and the cover member Q may be formed so as to be integrated with the measuring stage 3.

In the present embodiment, the third holding portion 33 holds the measuring member C so that the upper surface of the measuring member C and the XY plane are substantially parallel to each other. The fourth holding portion 34 holds the cover member Q so that the upper surface of the cover member Q and the XY plane are substantially parallel to each other. In the present embodiment, the upper surface of the measuring member C held on the third holding portion 33 and the upper surface of the cover member Q held on the fourth holding portion 34 are disposed substantially within the same plane (are substantially flush with each other).

Here, in the following description, the upper surface 2U of the cover member T held on the second holding portion 32 will be referred to as the upper surface 2U of the substrate stage 2, and the upper surface of the measuring member C held on the third holding portion 33 and the upper surface of the cover member Q held on the fourth holding portion 34 will be collectively referred to as the upper surface 3U of the measuring stage 3.

The interferometer system 11 includes a laser interferometer unit 11A that measures the position of the mask stage 1 and a laser interferometer unit 11B that measures the positions of the substrate stage 2 and the measuring stage 3. The laser interferometer unit 11A can measure the position of the mask stage 1 using a measuring mirror IR disposed in the mask stage 1. The laser interferometer unit 11B can measure the positions of the substrate stage 2 and the measuring stage 3 using a measuring mirror 2R disposed in the substrate stage 2 and a measuring mirror 3R disposed in the measuring stage 3, respectively.

The alignment system 302 detects the alignment mark of the substrate P to thereby detect a shot area S of the substrate P. The alignment system 302 includes a lower surface which the substrate stage 2 (the substrate P) can face. The upper surface 2U of the substrate stage 2 and the upper surface (front surface) Pa of the substrate P held on the substrate stage 2 can face the lower surface of the alignment system 302 facing the −Z direction.

The surface position detection system 303 is, for example, irradiates the upper surface (front surface) Pa of the substrate P held on the substrate stage 2 with detection light to thereby detect the position of the upper surface Pa of the substrate P. The surface position detection system 303 includes a lower surface which the substrate stage 2 (the substrate P) can face. The upper surface 2U of the substrate stage 2 and the upper surface Pa of the substrate P held on the substrate stage 2 can face the lower surface of the surface position detection system 303 facing the −Z direction.

When executing an exposure process or a predetermined measuring process on the substrate P, the control apparatus 8 operates the driving systems 4, 5, and 6 based on the measurement results of the interferometer system 11 and the detection results of the detection system 300 and executes control of the positions of the mask stage 1 (the mask M), the substrate stage 2 (the substrate P), and the measuring stage 3 (the measuring member C).

The liquid immersion member 7 can form an immersion space LS so that at least a part of the optical path of exposure light EL is filled with the liquid LQ. The liquid immersion member 7 is disposed near the terminating optical element 12 closest to the upper surface of the projection optical system PL among a plurality of optical elements of the projection optical system PL. In the present embodiment, the liquid immersion member 7 is an annular member and is disposed around the optical path of exposure light EL. In the present embodiment, at least a part of the liquid immersion member 7 is disposed around the terminating optical element 12.

The terminating optical element 12 includes an emission surface 13 from which exposure light EL is emitted toward the upper surface of the projection optical system PL. In the present embodiment, the immersion space LS is formed on the emission surface 13 side. The immersion space LS is formed so that the optical path K of exposure light EL emitted from the emission surface 13 is filled with the liquid LQ. Exposure light EL emitted from the emission surface 13 moves in the −Z direction. The emission surface 13 faces the moving direction (−Z direction) of exposure light EL. In the present embodiment, the emission surface 13 is a plane substantially parallel to the XY plane. In addition, the emission surface 13 may be inclined with respect to the XY plane and may include a curved surface.

The liquid immersion member 7 includes a lower surface 14 in which at least a part thereof faces the −Z direction. In the present embodiment, the emission surface 13 and the lower surface 14 can hold the liquid LQ between the surfaces and an object that is disposed in a position (the projection region PR) that can be irradiated with exposure light EL emitted from the emission surface 13. The immersion space LS is formed by the liquid LQ held between at least part of the emission surface 13 and the lower surface 14 and the object disposed in the projection region PR. The immersion space LS is formed so that the optical path K of exposure light EL between the emission surface 13 and the object disposed in the projection region PR is filled with the liquid LQ. The liquid immersion member 7 can hold the liquid LQ between the liquid immersion member and the object so that the optical path K of exposure light EL between the terminating optical element 12 and the object is filled with the liquid LQ.

In the present embodiment, examples of the object that can be disposed in the projection region PR include an object which can move in relation to the projection region PR on the upper surface side of the projection optical system PL (the emission surface 13 side of the terminating optical element 12). The object can move in relation to the terminating optical element 12 and the liquid immersion member 7. The object includes an upper surface (front surface) that can face at least one of the emission surface 13 and the lower surface 14. The upper surface of the object can form the immersion space LS between the upper surface of the emission surface 13. In the present embodiment, the upper surface of the object can form the immersion space LS between the upper surface and at least part of the emission surface 13 and the lower surface 14. The liquid LQ is held between the emission surface 13 and the lower surface 14 on one side and the upper surface (the front surface) of the object on the other side, whereby the immersion space LS is formed so that the optical path K of exposure light EL between the terminating optical element 12 and the object is filled with the liquid LQ.

In the present embodiment, the object includes at least one of the substrate stage 2, the substrate P held on the substrate stage 2, the measuring stage 3, and the measuring member C held on the measuring stage 3. For example, at least a part of the upper surface 2U of the substrate stage 2, and the front surface (the upper surface) Pa of the substrate P held on the substrate stage 2 can face the emission surface 13 of the terminating optical element 12 facing the −Z direction and the lower surface 14 of the liquid immersion member 7 facing the −Z direction. Naturally, the object that can be disposed in the projection region PR is not limited to at least one of the substrate stage 2, the substrate P held on the substrate stage 2, the measuring stage 3, and the measuring member C held on the measuring stage 3. Moreover, these objects can face at least a part of the detection system 300.

In the present embodiment, when the substrate P is irradiated with exposure light EL, the immersion space LS is formed so that a partial region of the front surface of the substrate P including the projection region PR is filled with the liquid LQ. When the substrate P is exposed, the liquid immersion member 7 can hold the liquid LQ between the liquid immersion member and the substrate P so that the optical path K of exposure light EL between the terminating optical element 12 and the substrate P is filled with the liquid LQ. At least a part of the interface (meniscus or edge) LG of the liquid LQ is formed between the lower surface 14 of the liquid immersion member 7 and the front surface of the substrate P. That is, the exposure apparatus EX of the present embodiment adopts a local liquid immersion method.

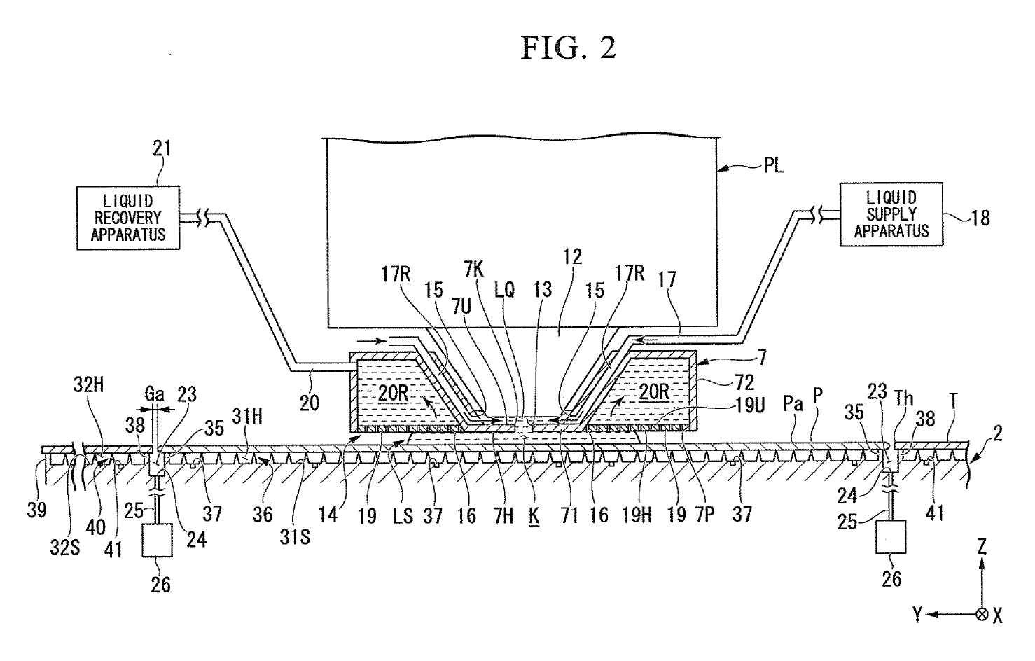

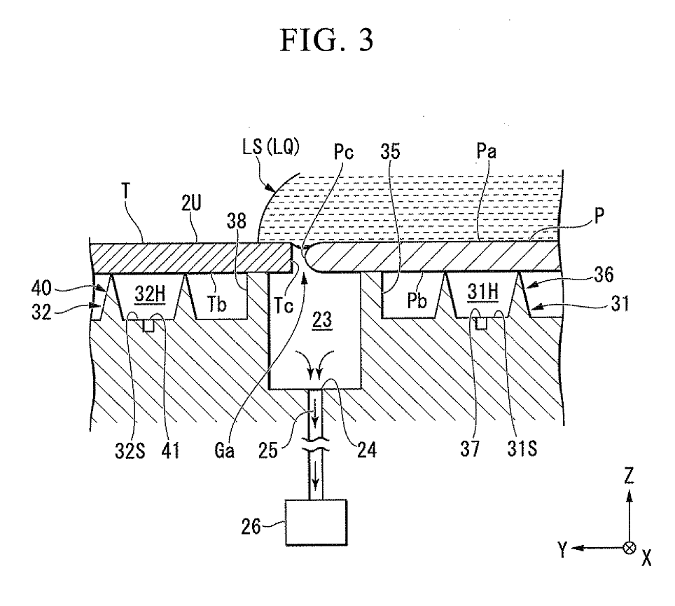

FIG. 2 is a side cross-sectional view showing an example of the liquid immersion member 7 and the substrate stage 2 according to the present embodiment. FIG. 3 is an enlarged view of a part of FIG. 2. In FIG. 2, although the substrate P is disposed in the projection region PR (the position facing the terminating optical element 12 and the liquid immersion member 7), the substrate stage 2 (the cover member T) and the measuring stage 3 (the cover member Q and the measuring member C) may be disposed as described above.

As shown in FIG. 2, the liquid immersion member 7 includes a facing portion 71 in which at least a part thereof faces the emission surface 13 of the terminating optical element 12 and a body portion 72 in which at least a part thereof is disposed around the terminating optical element 12. The facing portion 71 includes a hole (aperture) 7K at a position facing the emission surface 13. The facing portion 71 includes an upper surface 7U in which at least a part thereof faces the emission surface 13 with a gap interposed and a lower surface 7H that the substrate P (the object) can face. The hole 7K is formed so as to connect the upper surface 7U and the lower surface 7H. The upper surface 7U is disposed around the upper end of the hole 7K, and the lower surface 7H is disposed around the lower end of the hole 7K. Exposure light EL emitted from the emission surface 13 is in communication with the hole 7K, so that the substrate P can be irradiated with exposure light EL.

In the present embodiment, each of the upper surface 7U and the lower surface 7H is disposed around the optical path K. In the present embodiment, the lower surface 7H is a flat surface. The lower surface 7H can hold the liquid LQ between the lower surface and the substrate P (the object). In the following description, the lower surface 7H will be referred to as a holding surface 7H.

Moreover, the liquid immersion member 7 includes a supply port 15 capable of supplying the liquid LQ and a recovery port 16 capable of recovering the liquid LQ. The supply port 15 supplies the liquid LQ when the substrate P is exposed, for example.

The recovery port 16 recovers the liquid LQ when the substrate P is exposed, for example. In addition, the supply port 15 can supply the liquid LQ when the substrate P is exposed or/and no exposed. In addition, the recovery port 16 can recover the liquid LQ when the substrate P is exposed or/and no exposed.

The supply port 15 is disposed in the vicinity of the optical path K of exposure light EL emitted from the emission surface 13 so as to face the optical path K. In addition, the supply port 15 may face a space between the emission surface 13 and the aperture 7K or/and the side surface of the terminating optical element 12. In the present embodiment, the supply port 15 supplies the liquid LQ to a space between the upper surface 7U and the emission surface 13. The liquid LQ supplied from the supply port 15 flows through the space between the upper surface 7U and the emission surface 13 and is then supplied onto the substrate P (the object) through the aperture 7K.

The supply port 15 is connected to a liquid supply apparatus 18 through a flow channel 17. The liquid supply apparatus 18 can deliver the liquid LQ which is clean and temperature-adjusted. The flow channel 17 includes a flow channel including a supply flow channel 17R formed in the liquid immersion member 7 and a supply pipe connecting the supply flow channel 17R and the liquid supply apparatus 18. The liquid LQ delivered from the liquid supply apparatus 18 is supplied to the supply port 15 through the flow channel 17. The supply port 15 supplies the liquid LQ at least during the exposure of the substrate P.

The recovery port 16 can recover at least a part of the liquid LQ on the object facing the lower surface 14 of the liquid immersion member 7. The recovery port 16 is disposed in at least a part of the position around the aperture 7K through which exposure light EL passes. In the present embodiment, the recovery port 16 is disposed in at least a part of the position around the holding surface 7H. The recovery port 16 is disposed in a predetermined position of the liquid immersion member 7 facing the front surface of the object. The recovery port 16 faces the substrate P at least during the exposure of the substrate P. The recovery port 16 recovers the liquid LQ on the substrate P during the exposure of the substrate P.

In the present embodiment, the body portion 72 includes an aperture 7P facing the substrate P (the object). The aperture 7P is disposed in at least a part of the position around the holding surface 7H. In the present embodiment, the liquid immersion member 7 includes a porous member 19 disposed in the aperture 7P. In the present embodiment, the porous member 19 is a plate-shaped member including a plurality of holes (openings or pores). In addition, a mesh filter which is a porous member and in which a number of small holes are formed in a mesh form may be disposed in the aperture 7P.

In the present embodiment, the porous member 19 includes a lower surface 1914 that the substrate P (the object) can face, an upper surface 19U that faces the opposite direction of the lower surface 19H, and a plurality of holes connecting the upper surface 19U and the lower surface 19H. The lower surface 19H is disposed in at least a part of the position around the holding surface 7H. In the present embodiment, at least a part of the lower surface 14 of the liquid immersion member 7 includes a holding surface 7H and a lower surface 19H.

In the present embodiment, the recovery port 16 includes the holes of the porous member 19. In the present embodiment, the liquid LQ on the substrate P (the object) is recovered through the holes (the recovery port 16) of the porous member 19.

In addition, the porous member 19 may be not disposed.

The recovery port 16 is connected to a liquid recovery apparatus 21 through a flow channel 20. The liquid recovery apparatus 21 can connect the recovery port 16 to a vacuum system and suction the liquid LQ through the recovery port 16. The flow channel 20 includes a flow channel including a recovery flow channel 20R formed in the liquid immersion member 7 and a recovery pipe connecting the recovery flow channel 20R and the liquid recovery apparatus 21. The liquid LQ recovered from the recovery port 16 is recovered to the liquid recovery apparatus 21 through the flow channel 20.

In the present embodiment, the control apparatus 8 can form the immersion space LS with the liquid LQ between the terminating optical element 12 and the liquid immersion member 7 on one side and the object on the other side by executing an operation of recovering the liquid LQ from the recovery port 16 in parallel with an operation of supplying the liquid LQ from the supply port 15.

In addition, a liquid immersion member (nozzle member) as disclosed in the specification of US Patent Application Publication No. 2007/0132976 and the specification of European Patent Application Publication No. 1768170, for example, can be used as the liquid immersion member 7.

As shown in FIG. 2 and FIG. 3, the substrate stage 2 includes a space portion 23 that is in communication with a gap Ga between the upper surface Pa of the substrate P and the upper surface 2U of the substrate stage 2 and a suction port 24 that suctions fluid in the space portion 23. The suction port 24 can suction the liquid or/and the gas in the space portion 23.

The suction port 24 is connected to a fluid suction device 26 through a flow channel 25. The fluid suction device 26 can connect the suction port 24 to a vacuum system and suction the liquid or/and the gas through the suction port 24. At least a part of the flow channel 25 is formed in the substrate stage 2. Fluid (at least one of liquid and gas) from the suction port 24 is suctioned into the fluid suction device 26 through the flow channel 25.

In the present embodiment, the first holding portion 31 includes a pin chuck mechanism, for example. The first holding portion 31 includes a circumferential wall portion 35 that the lower surface Pb of the substrate P can face, a supporting portion 36 that is disposed in the underneath surface 31S on the inner side of the circumferential wall portion 35 and that includes a plurality of pin members, and a suction port 37 that is disposed at the underneath surface 31S at the inner side of the circumferential wall portion 35 so as to suction fluid. The suction port 37 is connected to the fluid suction device. The fluid suction device is controlled by the control apparatus 8. The upper surface of the circumferential wall portion 35 can face the lower surface Pb of the substrate P. A negative pressure space can be formed in at least a part of a space between the circumferential wall portion 35 and the lower surface Pb of the substrate P. The control apparatus 8 can create a negative pressure in a space 31H formed by the circumferential wall portion 35, the lower surface Pb of the substrate P, and the underneath surface 31S by executing the suction operation of the suction port 37 in a state where the lower surface Pb of the substrate P and the upper surface of the circumferential wall portion 35 are in contact with each other. In this way, the substrate P is held on the first holding portion 31. Moreover, the substrate P is released from the first holding portion 31 when the suction operation of the suction port 37 is cancelled.

In the present embodiment, the second holding portion 32 includes a pin chuck mechanism, for example. The second holding portion 32 includes a circumferential wall portion 38 that is disposed so as to surround the circumferential wall portion 35 and that the lower surface Tb of the cover member T can face, a circumferential wall portion 39 that is disposed so as to surround the circumferential wall portion 38 and that the lower surface Tb of the cover member T can face, a supporting portion 40 that is disposed in the underneath surface 32S between the circumferential wall portion 38 and the circumferential wall portion 39 and that includes a plurality of pin members, and a suction port 41 that is disposed in the underneath surface 32S so as to suction fluid. The suction port 41 is connected to the fluid suction device. The fluid suction device is controlled by the control apparatus 8. The upper surfaces of the circumferential wall portions 38 and 39 can face the lower surface Tb of the cover member T. A negative pressure space can be formed in at least a part of a space between the circumferential wall portion 38/39 and the lower surface Tb of the cover member T. The control apparatus 8 can create a negative pressure in a space 32H formed by the circumferential wall portion 38, the circumferential wall portion 39, the lower surface Tb of the cover member T, and the underneath surface 32S by executing the suction operation of the suction port 41 in a state where the lower surface Tb of the cover member T and the upper surfaces of the circumferential wall portions 38 and 39 are in contact with each other. In this way, the cover member T is held on the second holding portion 32. Moreover, the cover member T is released from the second holding portion 32 when the suction operation of the suction port 41 is cancelled.

The space portion 23 includes a space around the circumferential wall portion 35. In the present embodiment, the space portion 23 includes a space between the circumferential wall portion 35 and the circumferential wall portion 38.

For example, as shown in FIG. 3, there is a possibility that the immersion space LS is formed on the gap Ga. For example, there is a possibility that the immersion space LS is formed between the terminating optical element 12 and the liquid immersion member 7, and the substrate P held on the first holding portion 31 and the cover member T held on the second holding portion 32.

In the present embodiment, the upper surface Pa of the substrate P is liquid-repellent with respect to the liquid LQ. Moreover, the side surface Pc of the substrate P facing the inner surface of the cover member T (the aperture Th) is also liquid-repellent with respect to the liquid LQ. Moreover, the upper surface 2U of the cover member T is liquid-repellent with respect to the liquid LQ. Moreover, the inner surface Tc of the cover member T (the aperture Th) facing the side surface Pc of the substrate P is also liquid-repellent with respect to the liquid LQ. For example, the contact angle of the upper surface Pa and the side surface Pc of the substrate P with respect to the liquid LQ is 90° or more. Moreover, the contact angle of the upper surface 2U and the inner surface Tc of the cover member T with respect to the liquid LQ is 90° or more. Thus, the liquid LQ of the immersion space LS is suppressed from flowing into the space portion 23 through the gap Ga. Alternatively, in a case in which the liquid LQ is allowed to flow into the space portion 23, one of the side surface Pc of the substrate P and the inner surface Tc of the cover member T, or both of them may have no liquid-repellency.

There is a possibility that at least a part of the liquid LQ of the immersion space LS flows into the space portion 23 through the gap Ga. The suction port 24 can suction the liquid LQ flowing into the space portion 23.

In this way, the liquid LQ is removed from the space portion 23.

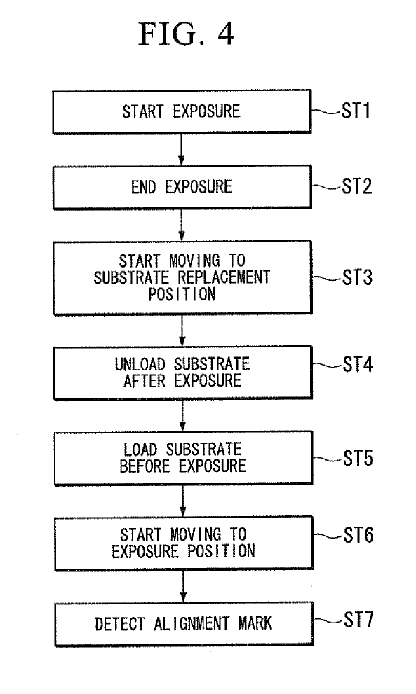

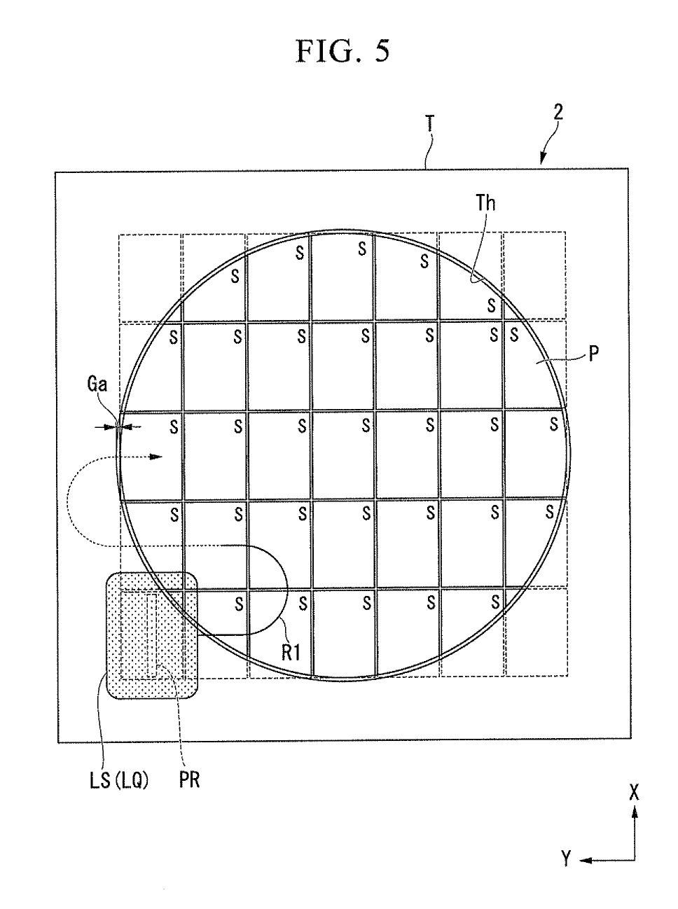

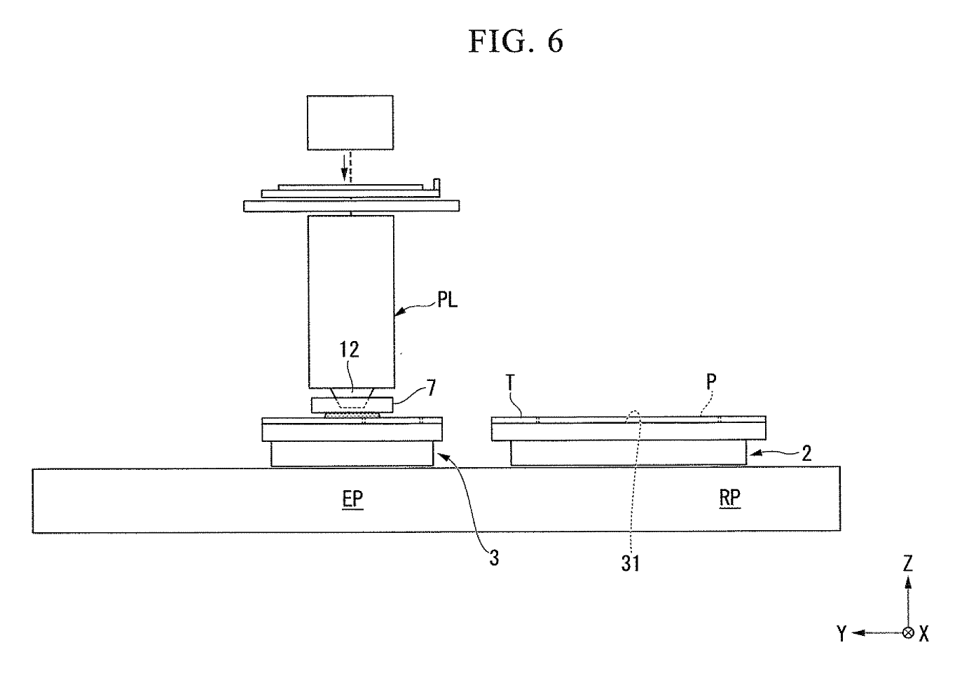

Next, an example of the operation of the exposure apparatus EX will be described with reference to FIG. 4, FIG. 5, and FIG. 6. FIG. 4 is a flowchart showing an example of the operation of the exposure apparatus EX according to the present embodiment. FIG. 5 is a diagram showing an example of the substrate P held on the first holding portion 31 (the substrate stage 2). FIG. 6 is a diagram showing an example of the operation of the substrate stage 2 and the measuring stage 3.

In the present embodiment, the substrate stage 2 can move at least between a first position EP and a second position RP. The first position EP is a position where the immersion space LS can be formed between the terminating optical element 12 and the liquid immersion member 7 and at least one of the upper surface Pa of the substrate P held on the first holding portion 31 and the upper surface 2U of the substrate stage 2. In other words, the first position EP is a position that faces the terminating optical element 12 and the liquid immersion member 7.

The second position RP is a position where the immersion space LS cannot be formed between the terminating optical element 12 and the liquid immersion member 7 and at least one of the upper surface Pa of the substrate P held on the first holding portion 31 and the upper surface 2U of the substrate stage 2.

The first position EP is a position where the substrate P held on the first holding portion 31 can be exposed. In the present embodiment, the first position EP comprises a position where the exposure light EL from the emission surface 13 can be irradiated onto. In the present embodiment, the first position EP comprises the projection region PR. In the present embodiment, the second position RP is a substrate replacement position, for example, where at least one of an operation of unloading the substrate P after exposure from the first holding portion 31 and an operation of loading the substrate P before exposure on the first holding portion 31 is executed.

In addition, the second position EP is not limited to the substrate replacement position.

In the following description, the first position EP will be referred to as the exposure position EP, and the second position RP will be referred to as the substrate replacement position RP.

Moreover, in the following description, a process of loading the substrate P before exposure on the first holding portion 31 at the substrate replacement position and a process of unloading the substrate P after exposure from the first holding portion 31 will be referred to as a substrate replacement process.

After the substrate stage 2 is moved to the exposure position EP in order to expose the substrate P held on the first holding portion 31 whereby the immersion space LS is formed with the liquid LQ between the terminating optical element 12 and the liquid immersion member 7 and the substrate stage 2 (the substrate P), the control apparatus 8 starts a process of exposing the substrate P (step ST1).

The exposure apparatus EX of the present embodiment is a scanning exposure apparatus (so-called scanner stepper) that projects the image of the pattern of the mask M onto the substrate P while synchronously moving the mask M and the substrate P in a predetermined scanning direction. In the present embodiment, the scanning direction (synchronous moving direction) of the substrate P is the Y-axis direction, and the scanning direction (synchronous moving direction) of the mask M is also the Y-axis direction. The control apparatus 8 irradiates the substrate P with exposure light EL with the projection optical system PL and the liquid LQ of the immersion space LS on the substrate P interposed while moving the substrate P in the Y-axis direction in relation to the projection region PR of the projection optical system PL and moving the mask M in the Y-axis direction in relation to the illumination region IR of the illumination system. IL in synchronization with the movement of the substrate P in the Y-axis direction. In this way, the substrate P is exposed to exposure light EL via the liquid LQ, and the image of the pattern of the mask M is projected onto the substrate P via the projection optical system PL and the liquid LQ.

As shown in FIG. 5, in the present embodiment, a plurality of shot areas S which are exposure target areas are disposed on the substrate P in a matrix form. The control apparatus 8 sequentially exposes the plurality of shot areas S defined on the substrate P.

When the shot areas S of the substrate P are exposed, the immersion space LS is formed so that the terminating optical element 12 and the liquid immersion member 7 face the substrate P, and the optical path K of exposure light EL between the terminating optical element 12 and the substrate P is filled with the liquid LQ. When the plurality of shot areas S of the substrate P are sequentially exposed, the substrate stage 2 is moved within the XY plane by the driving system 5 in a state where the immersion space LS is formed with the liquid LQ between the terminating optical element 12 and the liquid immersion member 7 and at least one of the upper surface Pa of the substrate P and the upper surface 2U of the substrate stage 2. The control apparatus 8 executes exposure of the substrate P while moving the substrate stage 2 in a state where the immersion space LS is formed with the liquid LQ between the terminating optical element 12 and the liquid immersion member 7 and at least one of the upper surface Pa of the substrate P and the upper surface 2U of the substrate stage 2.

For example, in order to expose a shot area (first shot area) S which is the first among the plurality of shot areas S on the substrate P, the control apparatus 8 moves the first shot area S to an exposure start position. The control apparatus 8 irradiates the first shot area S with exposure light EL while moving the first shot area S (the substrate P) in the Y-axis direction in relation to the projection region PR of the projection optical system PL in a state where the immersion space LS is formed.

After the exposure of the first shot area S ends, in order to expose the next second shot area S, the control apparatus 8 moves the substrate P in the X-axis direction (or in a direction inclined with respect to the X-axis direction within the XY plane) and moves the second shot area S to an exposure start position in a state where the immersion space LS is formed. The control apparatus 8 exposes the second shot area S in a manner similarly to the first shot area S.

The control apparatus 8 sequentially exposes the plurality of shot areas S on the substrate P via the projection optical system PL and the liquid LQ of the immersion space LS while repeating an operation (scanning exposure operation) of irradiating the shot area S with exposure light EL while moving the shot area S in the Y-axis direction in relation to the projection region PR and an operation (step operation) of moving the next shot area S to the exposure start position after the exposure of the shot area S ends. The plurality of shot areas S of the substrate P are sequentially irradiated with exposure light EL.

In the present embodiment, the control apparatus 8 irradiates the projection region PR with exposure light EL while moving the substrate stage 2 so that the projection region PR of the projection optical system PL and the substrate P move relatively along a moving trajectory indicated by the arrow R1 in FIG. 5, to thereby sequentially expose the plurality of shot areas S of the substrate P with exposure light EL via the liquid LQ. The immersion space LS is formed on the gap Ga at least partially during the movement of the substrate stage 2 during the exposure of the substrate P.

The exposure of the substrate P ends when the exposure of the last shot area S among the plurality of shot areas S on the substrate P ends, in other words, when irradiation with exposure light EL with respect to the plurality of shot areas S ends (step ST2).

After irradiation with exposure light EL with respect to the plurality of shot areas S ends (after the exposure of the substrate P ends), the control apparatus 8 moves the substrate stage 2 to the substrate replacement position RP in order to execute the substrate replacement process (step ST3).

As shown in FIG. 6, after the substrate stage 2 is disposed at the substrate replacement position RP, the control apparatus 8 unloads the substrate P after exposure from the first holding portion 31 using a substrate transport apparatus (not shown) (step ST4).

After the substrate P after exposure is unloaded from the first holding portion 31, the control apparatus 8 loads the substrate P before exposure on the first holding portion 31 using a substrate transport apparatus (not shown) (step ST5).

In addition, as shown in FIG. 6, when the substrate replacement process is executed, the measuring stage 3 is disposed at the exposure position EP. The control apparatus 8 executes a predetermined measuring process using the measuring stage 3 (the measuring member C and the measuring equipment) as necessary. After the substrate P before exposure is loaded on the first holding portion 31, and the measuring process using the measuring stage 3 ends, the control apparatus 8 moves the substrate stage 2 to the exposure position EP (step ST6).

In the present embodiment, during a moving period of the substrate stage 2 from the substrate replacement position RP to the exposure position EP, the control apparatus 8 detects the alignment mark of the substrate P held on the substrate stage 2 (the first holding portion 31) using the alignment system 302 (step ST7). Moreover, during a moving period of the substrate stage 2 from the substrate replacement position RP to the exposure position EP, the control apparatus 8 detects the position of the upper surface Pa of the substrate P held on the substrate stage 2 (the first holding portion 31) using the surface position detection system 303.

After the detection of the alignment mark of the substrate P and the detection of the position of the upper surface Pa of the substrate P end, the control apparatus 8 starts the exposure of the substrate P while adjusting the position of the substrate P based on the detection results. After that, the same process is repeated, and the plurality of substrates P are sequentially exposed.

In the present embodiment, the suction operation of the suction port 24 is executed in each of at least a part of a first period, in which the expose the substrate P is executed, and at least a part of a second period, in which the exposure of the substrate P is not executed.

In the present embodiment, the first period includes a period in which the substrate stage 2P is disposed at the exposure position EP. Moreover, the first period includes a period starting when the exposure of the substrate P starts (step ST1) and ending when the exposure of the substrate P ends (step ST2).

In the present embodiment, the first period includes a period starting when the exposure of the first shot area S among the plurality of shot areas S starts and ending when the exposure of the last shot area S ends. The control apparatus 8 continuously executes a fluid suction operation of the suction port 24 after the exposure of the first shot area S among the plurality of shot areas S starts and until the exposure of the last shot area S ends.

In this way, even when the immersion space LS is formed on the gap Ga in at least a part of the first period in which the plurality of shot areas S are sequentially irradiated with exposure light EL, for example, and the liquid LQ of the immersion space LS flows into the space portion 23 through the gap Ga, the liquid LQ flowing into the space portion 23 is immediately suctioned from the suction port 24 in the first period.

In the present embodiment, the second period includes a period occurring after irradiation with exposure light EL with respect to the substrate P ends. In the present embodiment, the second period includes a period occurring after irradiation with exposure light EL with respect to the plurality of shot areas S ends. In other words, the second period includes a period occurring after the exposure of the last shot area S among the plurality of shot areas S ends. Since the suction operation of the suction port 24 is executed in the second period, even when the liquid LQ of the space portion 23 is not suctioned (recovered) completely by the suction operation of the suction port 24 in the first period, the liquid LQ is removed from the space portion 23 by the suction operation of the suction port 24 in the second period.

Moreover, in the present embodiment, the second period includes a period occurring before irradiation with exposure light EL with respect to the substrate P starts. In the present embodiment, the second period includes a period occurring before irradiation with exposure light EL with respect to the plurality of shot areas S starts. In other words, the second period includes a period occurring before the exposure of the first shot area S among the plurality of shot areas S starts. Since the suction operation of the suction port 24 is executed in the second period, the exposure of the substrate P can be started after the liquid LQ is removed from the space portion 23.

In the present embodiment, the control apparatus 8 sets the suction force of the suction port 24 in at least a part of the first period in which the exposure of the substrate P is executed so as to be smaller than the suction force of the suction port 24 in the second period in which the exposure of the substrate P is not executed. That is, the control apparatus 8 suctions fluid in the space portion 23 from the suction port 24 with a first suction force in at least a part of the first period and suctions fluid in the space portion 23 from the suction port 24 with a second suction force larger than the first suction force in the second period. In other words, the control apparatus 8 suctions fluid from the suction port 24 with a first flow rate per unit time in at least a part of the first period and suctions fluid from the suction port 24 with a second flow rate per unit time larger than the first flow rate in the second period. For example, the flow rate of the recovered gas in the first period can be set to 0.3 to 5.5 [L/min], and the flow rate of the recovered gas in the second period can be set to 5.5 to 7.0 [L/min]. When it is desired to suppress the liquid LQ from flowing into the space portion 23, the flow rate of the recovered gas in the first period may be set to 1.0 [L/min] or less (for example, between 0.3 and 0.7 [L/min]). Moreover, when the flowing of the liquid LQ into the space portion 23 is permitted, or when it is desired to allow the liquid LQ to flow into the space portion 23, the flow rate of the recovered gas in the first period may be set to 4.0 [L/min] or more (for example, between 4.0 and 5.5 [L/min]).

In the present embodiment, the second period includes at least a part of the period starting when the exposure of the first substrate P among the plurality of substrates P exposed sequentially ends (the exposure of the last shot area S ends) and ending when the exposure of the next second substrate P starts (the exposure of the first shot area S starts).

For example, the second period may be a period starting when the exposure of the first substrate P ends (step ST2) and ending when the first substrate P after the exposure is unloaded from the first holding portion 31, the second substrate P is loaded on the first holding portion 31, and the detection of the alignment mark of the second substrate P before the exposure starts (step ST7). That is, in the present embodiment, the second period may be a period starting when the exposure of the substrate P ends (step ST2) and ending when the detection of the alignment mark of the next substrate P starts (step ST7).

Moreover, the second period may be a period starting when irradiation with exposure light EL with respect to the substrate P ends (step ST2) and ending when the movement of the substrate stage 2, in which the substrate P before exposure is held on the first holding portion 31, to the exposure position EP starts (step ST6).

Moreover, the second period may be a period starting when irradiation with exposure light EL with respect to the substrate P ends (step ST2) and ending when the substrate P before exposure is loaded on the first holding portion 31 (step ST5).

Moreover, the second period may be a period starting when irradiation with exposure light EL with respect to the substrate P ends (step ST2) and ending when the substrate P is unloaded from the first holding portion 31 (step ST4).

Moreover, the second period may be a period starting when irradiation with exposure light EL with respect to the substrate P ends (step ST2) and ending when the movement of the substrate stage 2, in which the substrate P after the exposure is held on the first holding portion 31, to the substrate replacement position EP starts (step ST3).

In addition, the second period may be a period in which the substrate stage 2 is disposed in the substrate replacement position RP. Moreover, the second period may be a period in which the substrate P is not held on the first holding portion 31. The period in which the substrate P is not held on the first holding portion 31 includes a period (the period of the substrate replacement process) starting when the substrate P after exposure is unloaded from the first holding portion 31 (step ST4) and ending when the substrate P before exposure is loaded on the first holding portion 31 (step ST5). In addition, the period in which the substrate P is not held on the first holding portion 31 is not limited to the period of the substrate replacement process.

In addition, the second period may be the period of steps ST3 to ST7, the period of steps ST3 to ST6, the period of steps ST3 to ST5, the period of steps ST3 to ST4, the period of steps ST4 to ST7, and the period of steps ST4 to ST6.

In the present embodiment, the control apparatus 8 suctions fluid from the suction port 24 with the first suction force during the exposure of the substrate P (the plurality of shot areas S) and changes the suction force of the suction port 24 from the first suction force and the second suction force when irradiation with exposure light EL with respect to the last shot area S of the substrate P ends (step ST2). In this case, the second period includes a period in which the immersion space LS is formed between the terminating optical element 12 and the liquid immersion member 7 and at least one of the upper surface of the substrate P and the upper surface 2U of the substrate stage 2 after irradiation with exposure light EL with respect to the substrate P (the plurality of shot areas S) ends.

In addition, the suction force of the suction port 24 may be changed from the first suction force to the second suction force when a state where the immersion space LS is formed on the substrate stage 2 is changed to a state where the immersion space LS is formed on the measuring stage 3 (for example, step ST3). In this case, after irradiation with exposure light EL ends, fluid is suctioned from the suction port 24 with the first suction force in a period in which the immersion space LS is formed on at least one of the upper surface of the substrate P and the upper surface 2U of the substrate stage 2.

In addition, the suction force of the suction port 24 may be changed from the first suction force to the second suction force when the substrate P after exposure is unloaded from the first holding portion 31 (step ST4).

In addition, the suction force of the suction port 24 may be changed from the second suction force to the first suction force when the substrate P before exposure is loaded on the first holding portion 31 (step ST5).

In addition, the suction force of the suction port 24 may be changed from the second suction force to the first suction force when a state where the immersion space LS is formed on the measuring stage 3 is changed to a state where the immersion space LS is formed on the substrate stage 2 (for example, step ST6).

In addition, the suction force of the suction port 24 may be changed from the second suction force to the first suction force when the alignment mark of the substrate P is detected (step ST7).

In addition, the suction force of the suction port 24 may be changed from the second suction force to the first suction force when irradiation with exposure light EL with respect to the first shot area S of the substrate P starts (step ST1).

In addition, in the present embodiment, the fluid suction operation of the suction port 24 may be executed in a scanning exposure operation in which the substrate P (the shot area S) is irradiated with exposure light EL, and the fluid suction operation of the suction port 24 may be stopped in a stepping operation in which the substrate P is not irradiated with exposure light EL. In addition, the fluid suction operation of the suction port 24 may be executed in a stepping operation in which the substrate P is not irradiated with exposure light EL, and the fluid suction operation of the suction port 24 may be stopped in a scanning exposure operation in which the substrate P (the shot area S) is irradiated with exposure light EL.

In addition, in the present embodiment, fluid may be suctioned from the suction port 24 with the first suction force during the scanning exposure operation, and fluid may be suctioned from the suction port 24 with the second suction force during the stepping operation.

As described above, according to the present embodiment, since fluid in the space portion 23 is suctioned from the suction port 24 in the first and second periods, even when the liquid LQ flows into the space portion 23 in the first period, for example, the liquid LQ of the space portion 23 can be recovered (suctioned) from the suction port 24. Thus, the liquid LQ of the space portion 23 is suppressed from flowing into a space on the upper surface Pa side (the upper surface 2U side of the cover member T) of the substrate P through the gap Ga during the exposure of the substrate P, for example, and the liquid LQ is suppressed from adhering (remaining) on the upper surface of the substrate P or flowing into the immersion space LS. Moreover, in the second period, the liquid LQ of the space portion 23 is recovered (suctioned) from the suction port 24, whereby the liquid LQ of the space portion 23 is suppressed from flowing from the space portion 23. Therefore, it is possible to suppress the occurrence of exposure defects and the occurrence of defective devices.

Moreover, according to the present embodiment, since the suction force of the suction port 24 in the first period is set so as to be smaller than the suction force of the suction port 24 in the second period, it is possible to suppress the generation of vaporization heat associated with the suction operation of the suction port 24 in the first period. Thus, it is possible to suppress a change of temperature of the substrate P, a change of temperature of the substrate stage 2 (the cover member T), a change of temperature of the liquid LQ of the immersion space LS, and the like, for example, in the first period. Therefore, it is possible to suppress the occurrence of exposure defects and the occurrence of defective devices.

In addition, in the first period, although the suction by the suction port 24 may be continued constantly, the suction may be performed intermittently. Moreover, in the second period, although the suction by the suction port 24 may be continued constantly, the suction may be performed intermittently.

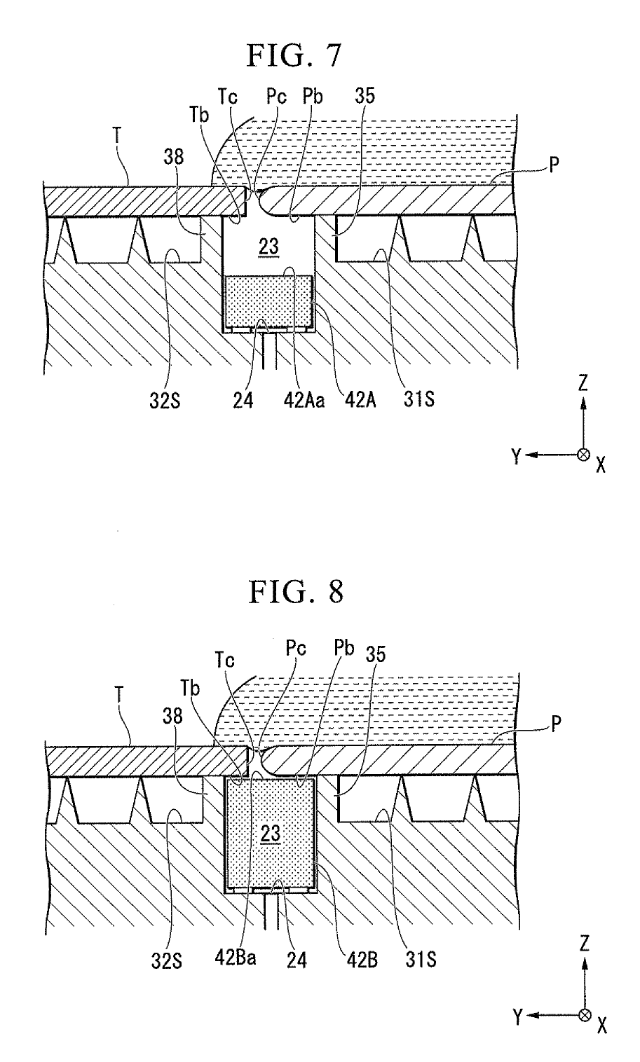

In addition, as shown in FIG. 7, for example, a porous member 42A may be disposed in the space portion 23. The suction port 24 can suction fluid of the space portion 23 through the holes of the porous member 42A.

In the example shown in FIG. 7, the holes of the porous member 42A function as the suction port through which fluid in the space portion 23A is suctioned, and the suction port 24 suctions fluid in the space portion 23A through the porous member 42A.

In addition, in the example shown in FIG. 7, an upper surface 42Aa of the porous member 42A is disposed at a position lower than the upper surfaces of the circumferential wall portions 35 and 38. Moreover, in the example shown in FIG. 7, the upper surface 42Aa of the porous member 42A is disposed at a position lower than the underneath surfaces 31S and 32S. Moreover, in the example shown in FIG. 7, the gap between the upper surface 42Aa of the porous member 42A and the lower surface Tb of the cover member T is larger than the gap between the inner surface Tc of the cover member T and the side surface Pc of the substrate P. Furthermore, in the example shown in FIG. 7, the gap between the upper surface 42Aa of the porous member 42A and the lower surface Pb of the substrate P is larger than the gap between the inner surface Tc of the cover member T and the side surface Pc of the substrate P.

In addition, a porous member 42B as shown in FIG. 8 may be disposed in the space portion 23. In the example shown in FIG. 8, the upper surface 42Ba of the porous member 42B is disposed at a position higher than the underneath surfaces 31S and 32S. Moreover, in the example shown in FIG. 8, the upper surface 42Ba of the porous member 42B is disposed approximately at the same position as the upper surfaces of the circumferential wall portions 35 and 38. Moreover, in the example shown in FIG. 8, the gap between the upper surface 42Ba of the porous member 42B and the lower surface Tb of the cover member T is smaller than the gap between the inner surface Tc of the cover member T and the side surface Pc of the substrate P. Furthermore, in the example shown in FIG. 8, the gap between the upper surface 42Ba of the porous member 42B and the lower surface Pb of the substrate P is smaller than the gap between the inner surface Tc of the cover member T and the side surface Pc of the substrate P.

### Second Embodiment

Next, a second embodiment will be described. In the following description, constituent portions that are identical or equivalent to those of the above embodiment will be denoted by the same reference symbols, and description thereof will be simplified or omitted.

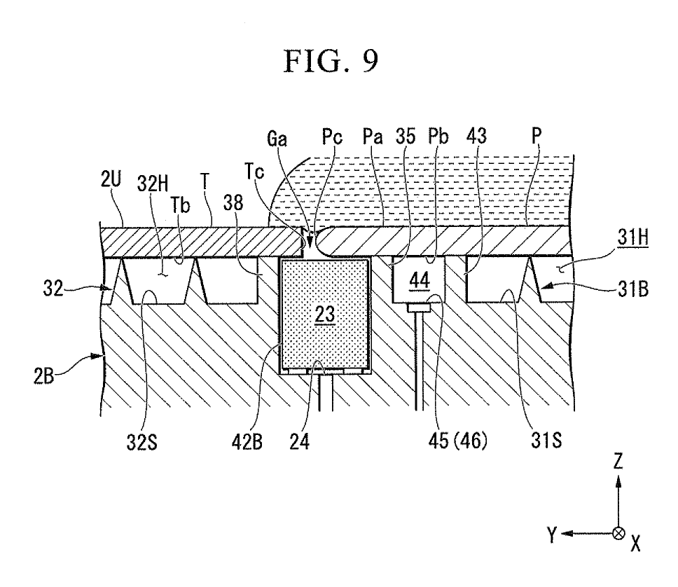

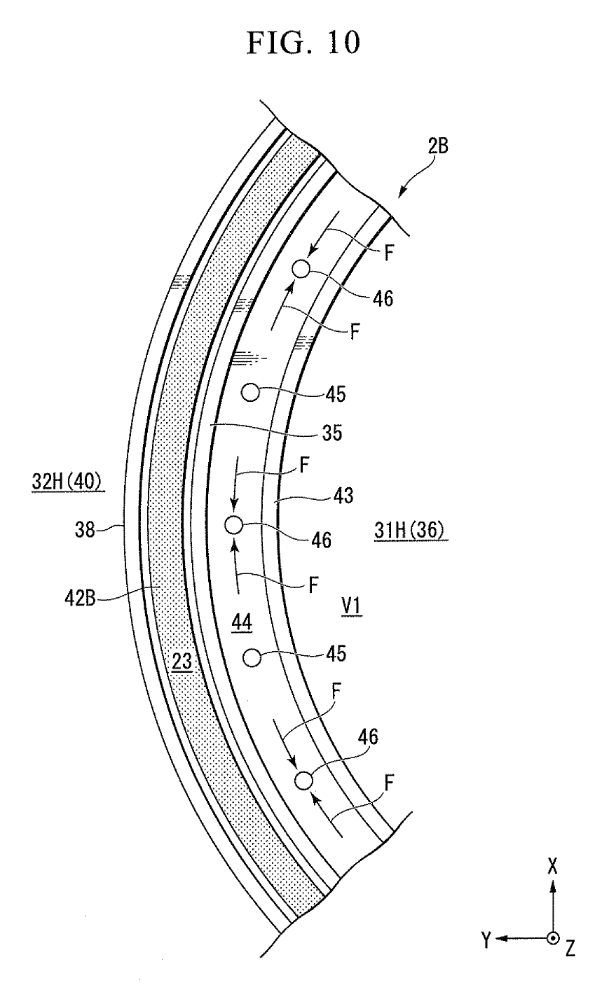

FIG. 9 is a side cross-sectional view showing a part of a substrate stage 2B according to the present embodiment, and FIG. 10 is a view of a part of the substrate stage 2B as viewed from the upper side (+Z side). In FIG. 9 and FIG. 10, the substrate stage 2B includes a first holding portion 31B that releasably holds the substrate P, a second holding portion 32 that releasably holds the cover member T, and a space portion 23 that is in communication with the gap Ga between the upper surface Pa of the substrate P and the upper surface 2U of the cover member T. The space portion 23 includes a space around the circumferential wall portion 35. In the present embodiment, the space portion 23 includes a space between the circumferential wall portion 35 and the circumferential wall portion 38.

In addition, FIG. 10 shows a state where the substrate P is not present on the first holding portion 31B, and the cover member T is not present on the second holding portion 32. In addition, in the example shown in FIG. 9 and FIG. 10, although the porous member 42B is disposed in the space portion 23, the porous member 4213 may be not disposed.

The first holding portion 31B includes a circumferential wall portion 43 that is disposed on the inner side of the circumferential wall portion 35 and that the lower surface Pb of the substrate P can face and a gas supply port 45 that supplies gas to a space portion 44 between the circumferential wall portion 35 and the circumferential wall portion 43. Moreover, the first holding portion 31B includes a discharge port 46 through which fluid (the liquid or/and the gas) of the space portion 44 is discharged.

The space portion 36 of the first holding portion 31B is disposed on the inner side of the circumferential wall portion 43. In the present embodiment, a space 31H is formed between the lower surface Pb of the substrate P, the circumferential wall portion 43, and the underneath surface 31S in a state where the lower surface Pb of the substrate P and the upper surface of the circumferential wall portion 43 face each other.

As shown in FIG. 10, a plurality of gas supply ports 45 is disposed along the circumferential wall portion 43 (the circumferential wall portion 35). A plurality of discharge ports 46 is disposed along the circumferential wall portion 43 (the circumferential wall portion 35). In the present embodiment, the discharge port 46 is disposed on each of one side of the gas supply port 45 and the other side thereof. In other words, the gas supply port 45 is disposed between two discharge ports 46. Moreover, in the present embodiment, the gas supply port 45 is disposed on each of one side of the discharge port 46 and the other side thereof. In other words, the discharge port 46 is disposed between two gas supply ports 45. That is, in the present embodiment, a plurality of gas supply ports 45 and a plurality of discharge ports 46 are alternately disposed around the circumferential wall portion 43. In addition, the plurality of gas supply ports 45 and the plurality of discharge ports 46 may not be alternately disposed. For example, the discharge port 46 may be disposed on one side of the gas supply port 45, and the gas supply port 45 may be disposed on the other side. For example, the gas supply port 45 may be disposed on one side of the discharge port 46, and the discharge port 46 may be disposed on the other side.

In the present embodiment, the gas supply port 45 is connected to a gas supply apparatus through a flow channel. Examples of the gas supply apparatus include a pump capable of delivering gas, a temperature regulator capable of regulating the temperature of supplied gas, a filter apparatus capable of removing foreign material in the supplied gas, and the like.

In the present embodiment, the discharge port 46 is connected to a fluid suction device through a flow channel. Examples of the fluid suction device include a pump capable of suctioning fluid (gas or/and liquid), a gas-liquid separator capable of separating suctioned gas and liquid, and the like.

The gas supply apparatus connected to the gas supply port 45 and the fluid suction device connected to the discharge port 46 are controlled by the control apparatus 8. The control apparatus 8 can control an operation of supplying gas from the gas supply port 45 and an operation (the suction operation) of discharging gas from the discharge port 46. When gas is supplied from the gas supply port 45, and fluid is discharged (suctioned) from the discharge port 46, a gasflow F is generated in the space portion 44 as shown in FIG. 10. For example, gas flows in the space portion 44 from the gas supply port 45 toward the discharge port 46.

As shown in FIG. 9, the gap Ga is formed between the substrate P held on the first holding portion 31B and the cover member T held on the second holding portion 32. There is a possibility that the liquid LQ (for example, the liquid LQ of the immersion space LS) present in a space facing at least one of the upper surface Pa of the substrate P and the upper surface 2U of the cover member T flows into the space portion 23 through the gap Ga. The suction port 24 can suction the liquid LQ of the space portion 23.

For example, there is a possibility that the liquid LQ flows into the space portion 44. For example, there is a possibility that the liquid LQ of the space portion 23 passes between the lower surface Pb of the substrate P and the upper surface of the circumferential wall portion 35 to flow into the space portion 44. In the present embodiment, the discharge port 46 can suction the liquid LQ of the space portion 44. The control apparatus 8 can remove the liquid LQ from the space portion 44 by executing the suction operation of the discharge port 46. In this way, the liquid LQ is suppressed from flowing into the space 31H. The amount of gas supplied from the air supply port 45 and the amount of gas discharged from the discharge port 46 may be regulated so that the pressure of the space portion 44 is higher than the pressure of the space portion 23. In this way, it is possible to suppress the liquid LQ from flowing from the space portion 23 into the space portion 44.

In the first holding portion 31B according to the present embodiment, by setting the suction force of the suction port 24 in at least a part of the first period so as to be smaller than the suction force of the suction port 24 in the second period, it is possible to suppress the occurrence of exposure defects and the occurrence of defective devices. The suction force of the suction port 24 in at least a part of the first period may not be set to be smaller than the suction force of the suction port 24 in the second period.

Moreover, the space portion 44 in which the air supply port 45 and the discharge port 46 are provided may be applied to the embodiments described later.

### Third Embodiment

Next, a third embodiment will be described. In the following description, constituent portions that are identical or equivalent to those of the above embodiments will be denoted by the same reference symbols, and description thereof will be simplified or omitted.

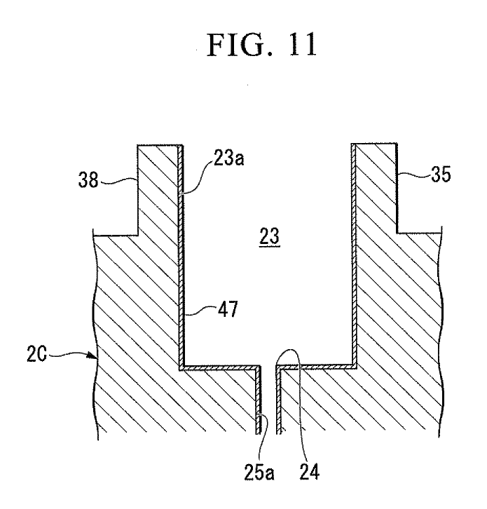

FIG. 11 is a diagram showing a part of a substrate stage 2C according to the third embodiment. As shown in FIG. 11, a thermal insulating material 47 may be disposed in the inner surface 23a that defines the space portion 23. In the example shown in FIG. 11, the thermal insulating material 47 is also disposed in the inner surface 25a that defines a flow channel 25, which is in communication with the suction port 24.

Alternatively, no thermal insulating material can be disposed in the inner surface 23a that defines the space portion 23 or in the inner surface 25a that defines the flow channel 25.

In the present embodiment, the thermal insulating material 47 is a PFA (Tetra fluoro ethylene-perfluoro alkylvinyl ether copolymer) film. In addition, the thermal insulating material 47 may be a PTFE (Poly tetra fluoro ethylene) film, a PEEK (polyetheretherketone) film, a Teflon® film, or the like. Moreover, the thermal insulating material 47 may contain polyolefin, urethane, or the like.

In addition, the thermal insulating material 47 may not be a film.

Since the thermal insulating material 47 is formed, even when fluid including the liquid LQ is suctioned from the suction port 24, it is possible to suppress a change of temperature of the substrate stage 2, a change of temperature of the immersion space LS, a change of temperature of the substrate P, and the like, for example.

In addition, in the example shown in FIG. 11, a porous member may be disposed in the space portion 23.

In the present embodiment, as described in the first embodiment, the suction force of the suction port 24 in at least a part of the first period may be set to be less than the suction force of the suction port 24 in the second period, and the suction force of the suction port 24 in at least a part of the first period may not be set to be smaller than the suction force of the suction port 24 in the second period.

### Fourth Embodiment

Next, a fourth embodiment will be described. In the following description, constituent portions that are identical or equivalent to those of the above embodiments will be denoted by the same reference symbols, and description thereof will be simplified or omitted.

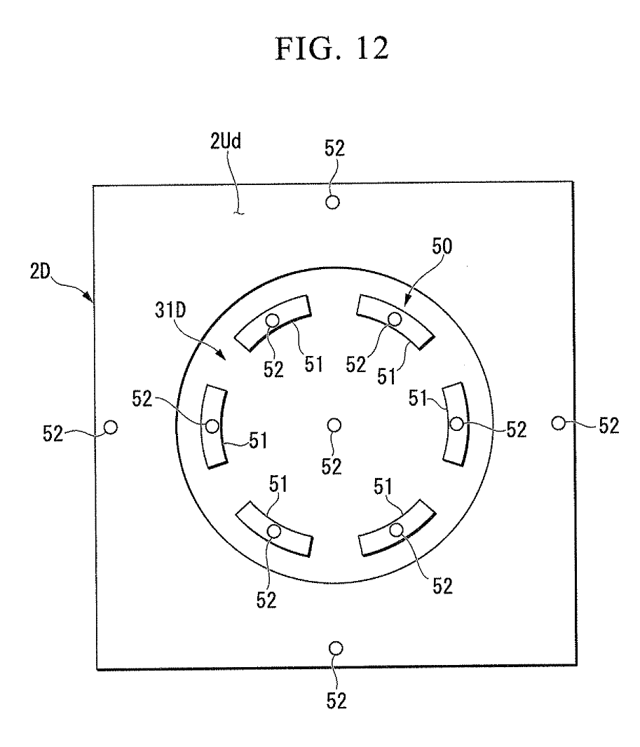

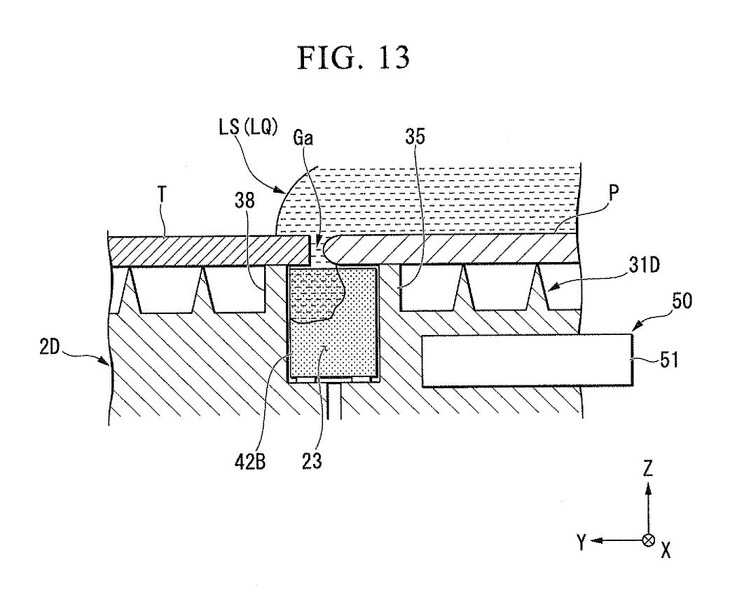

FIG. 12 is a plan view showing an example of a substrate stage 2D according to the fourth embodiment, and FIG. 13 is a side cross-sectional view showing a part of the substrate stage 2D. In FIG. 12 and FIG. 13, the substrate stage 2D includes a temperature regulator 50 that regulates the temperature of the substrate stage 2D. In the present embodiment, the temperature regulator 50 includes a plurality of temperature-regulating members 51. In the present embodiment, at least part of the temperature-regulating members 51 are disposed in the substrate stage 2D. In the present embodiment, a temperature-regulating member 51 is disposed in the substrate stage 2D of the first holding portion 31D. In the example shown in FIG. 12, six temperature-regulating members 51 are disposed in the first holding portion 31D.

The temperature-regulating member 51 can heat the substrate stage 2D. In addition, the temperature-regulating member 51 may be capable of cooling the substrate stage 2D. In the present embodiment, examples of the temperature-regulating member 51 include a Peltier device. Furthermore, the temperature-regulating member 51 may include a heater.

Moreover, in the present embodiment, the substrate stage 2D includes a temperature sensor 52 that detects the temperature of the substrate stage 2D. In the present embodiment, a plurality of temperature sensors 52 is disposed in the substrate stage 2D. The temperature sensors 52 are disposed in a plurality of locations of the substrate stage 2D. In the example shown in FIG. 12, a plurality of temperature sensors 52 is disposed in the first holding portion 31D. Moreover, a plurality of temperature sensors 52 is disposed on the upper surface 2Ud of the substrate stage 2D.

In addition, the upper surface 2Ud of the substrate stage 2D may include the upper surface of a member that constitutes a part of a spatial image measuring system as disclosed in the specification of US Patent Application Publication No. 2002/0041377, for example, and may include the upper surface of a scaling member detected by an encoder system as disclosed in the specification of US Patent Application Publication No. 2007/0288121, for example.

The temperature regulator 50 is controlled by the control apparatus 8. Moreover, the detection results of the temperature sensor 52 are output to the control apparatus 50. The control apparatus 8 controls the temperature regulator 50 based on the detection results of the temperature sensor 52 so that the temperature of the substrate stage 2D (the first holding portion 31D) reaches a target temperature (target value).

There is a possibility that the temperature of the substrate stage 2D changes with the suction operation of the suction port 24. For example, there is a possibility that the temperature of the substrate stage 2D decreases with the suction operation of the suction port 24. Moreover, there is a possibility that the temperature of the substrate stage 2D increases. According to the present embodiment, since the temperature of the substrate stage 2D is adjusted by the temperature regulator 50, it is possible to suppress a change of temperature of the substrate stage 2D.

In addition, in the present embodiment, although the temperature regulator 50 adjusts the temperature of the substrate stage 2D based on the detection results of the temperature sensor 52, the temperature of the substrate stage 2D may be adjusted without using the detection results of the temperature sensor 52, and the temperature sensor 52 may be omitted.

For example, it is possible to cause the temperature of the substrate stage 2D so as to reach a target temperature (target value) by changing the amount of control of the temperature regulator 50 (the amount of current supplied to a Peltier device, for example) between when the suction port 24 suctions fluid with a first suction force and when the suction port 24 suctions fluid with a second suction force larger than the first suction force. For example, the amount of heat generated by the temperature regulator 51 when the suction port 24 suctions fluid with a first suction force may be set to be smaller than the amount of heat generated by the temperature regulator 51 when the suction port 24 suctions fluid with a second suction force greater than the first suction force.

In addition, in the present embodiment, although a plurality of temperature-regulating members 51 is disposed in a dispersed manner, an annular temperature-regulating member may be disposed, for example.

In the present embodiment, as described in the first embodiment, the suction force of the suction port 24 in at least a part of the first period may be set to be smaller than the suction force of the suction port 24 in the second period, and the suction force of the suction port 24 in at least a part of the first period may not be set to be smaller than the suction force of the suction port 24 in the second period.

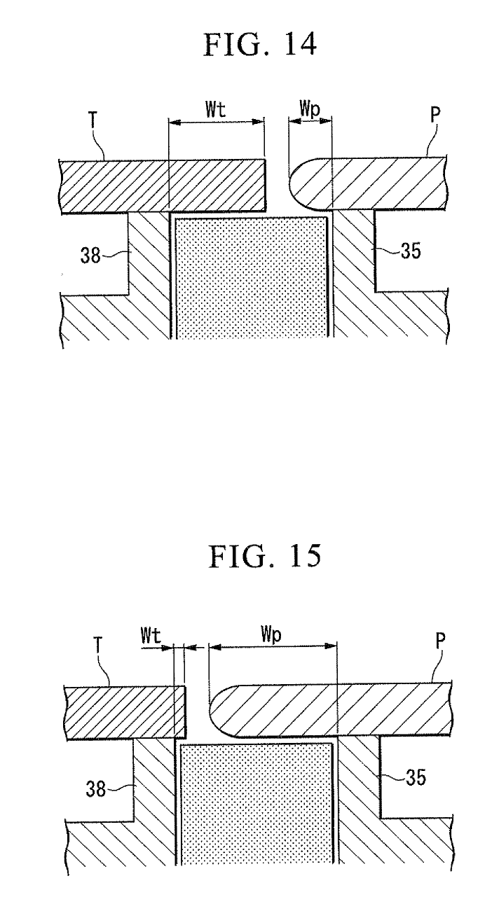

In addition, in the first to fourth embodiments described above, for example, the dimension Wp of a part of the substrate P protruding toward the outer side of the circumferential wall portion 35 may be smaller than the dimension Wt of a part of the cover member T protruding toward the inner side of the circumferential wall portion 38, as shown in FIG. 14, and the dimension Wp may be larger than the dimension Wt, as shown in FIG. 15. Moreover, the dimension Wp and the dimension Wt may be approximately the same as each other.

In addition, the first holding portion 31 may hold the substrate P so that the substrate P does not protrude from the circumferential wall portion 35. For example, the first holding portion 31 may hold the substrate P so that the dimension Wp becomes zero. In addition, the second holding portion 32 may hold the cover member T so that the cover member T does not protrude from the circumferential wall portion 38. For example, the second holding portion 32 may hold the cover member T so that the dimension Wt becomes zero.

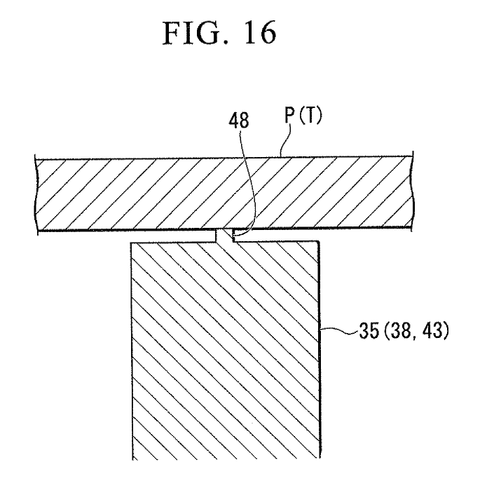

In addition, in the embodiments described above, as shown in FIG. 16, a convex portion 48 may be formed on the upper surface of the circumferential wall portion 35. In this way, it is possible to decrease the contact area between the circumferential wall portion 35 (the convex portion 48) and the lower surface Pb of the substrate P while maintaining the strength of the circumferential wall portion 35. Similarly, the convex portion 48 may be formed on the upper surface of the circumferential wall portion 38. Moreover, the convex portion 48 may be formed on the upper surface of the circumferential wall portion 43 described with reference to FIG. 9 and FIG. 10.

In the present embodiment, as described in the first embodiment, the suction force of the suction port 24 in at least a part of the first period may be set to be smaller than the suction force of the suction port 24 in the second period, and the suction force of the suction port 24 in at least a part of the first period may not be set to be smaller than the suction force of the suction port 24 in the second period.

### Fifth Embodiment

Next, a fifth embodiment will be described. In the following description, constituent portions that are identical or equivalent to those of the above embodiments will be denoted by the same reference symbols, and description thereof will be simplified or omitted.

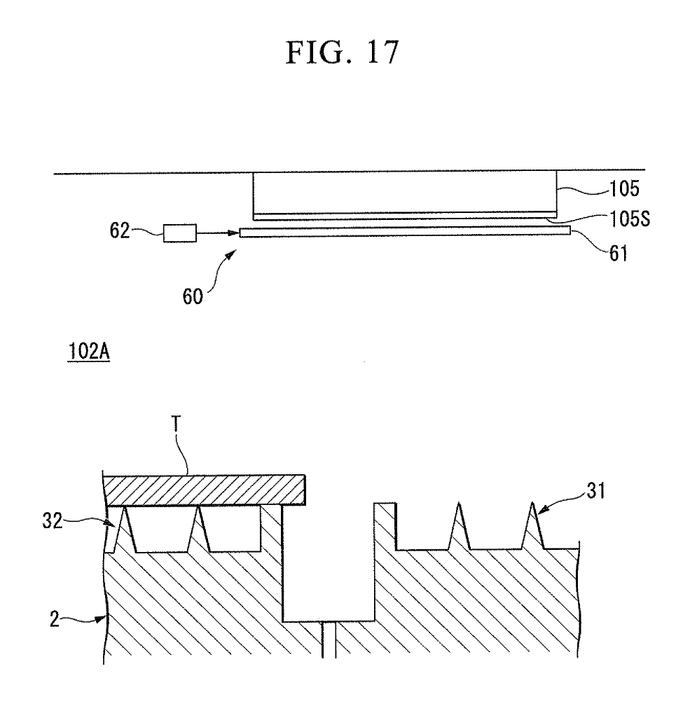

FIG. 17 is a diagram showing an example of an exposure apparatus EX according to the fifth embodiment. In FIG. 17, the exposure apparatus EX includes a suppression mechanism 60 that suppresses the supply of gas from the gas supply portion 105S of the conditioning system 105 to the space 102A in at least a part of the first period in which the exposure of the substrate P is executed and that suppresses the supply of at least a part of gas from the gas supply portion 1055 to the substrate stage 2 in at least a part of the second period in which the exposure of the substrate P is not executed.

In the present embodiment, the suppression mechanism 60 includes a shutter member 61 that shuts the gas supply portion 105S in at least a part of the second period. In the present embodiment, the suppression mechanism 60 includes a drive apparatus 62 capable of moving the shutter member 61. The suppression mechanism 60 can move the shutter member 61 to a position facing the gas supply portion 105S by operating the drive apparatus 62.

In the present embodiment, the second period includes a period in which the substrate P is not held on the first holding portion 31. The second period includes a period starting when the substrate P after exposure is unloaded from the first holding portion 31 and ending when the substrate P before exposure is loaded on the first holding portion 32.

In the present embodiment, the suppression mechanism 60 shuts the shutter member 61 and the gas supply portion 105S in at least a period in which the substrate P is not held on the first holding portion 31, and which starts when the substrate P after exposure is unloaded from the first holding portion 31 in the server certificate and which ends when the substrate P before exposure is loaded on the first holding portion 32.

In this way, the gas from the gas supply portion 1055 is suppressed from reaching the first holding portion 31, for example. Thus, a change of temperature (a decrease of temperature) of the first holding portion 31 is suppressed.

Moreover, the shutter member 61 is withdrawn from the gas supply portion 105S in at least the first period in which the exposure of the substrate P is executed. The suppression mechanism 60 can withdraw the shutter member 61 from the position facing the gas supply portion 105S by operating the drive apparatus 62. In this way, the gas from the gas supply portion 105S is supplied to the space 102A, and the environment of the space 102A is adjusted satisfactorily.

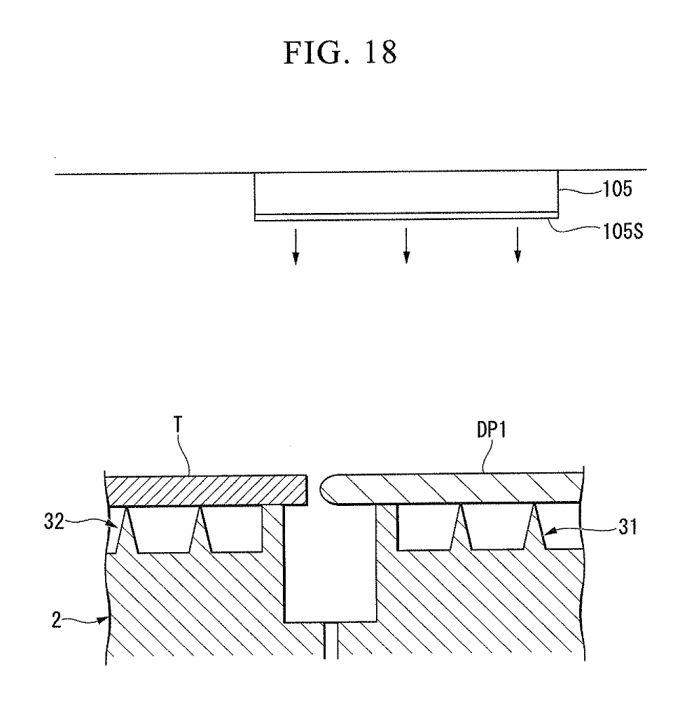

In addition, as shown in FIG. 18, a dummy substrate DP1 may be disposed so as to cover the first holding portion 31 in at least a part of the second period, for example, during an idling period. The outer shape of the dummy substrate DP1 is approximately the same as the outer shape of the substrate P for manufacturing devices. The dummy substrate DP1 is a substrate that emits foreign materials more scarcely than the substrate P. The first holding portion 31 can hold the dummy substrate DP1. The upper surface of the dummy substrate DP1 is liquid-repellent with respect to the liquid LQ. Moreover, the side surface of the dummy substrate DP1 facing the inner surface of the cover member T (the aperture Th) is also liquid-repellent with respect to the liquid LQ. For example, the contact angle of the upper surface and the side surface of the dummy substrate PP1 with respect to the liquid LQ is 90° or more.

By holding the first holding portion 31 using the first holding portion 31 in at least the second period, the gas from the gas supply portion 1055 is suppressed from reaching the first holding portion 31. Thus, a change of temperature of the first holding portion 31 is suppressed.

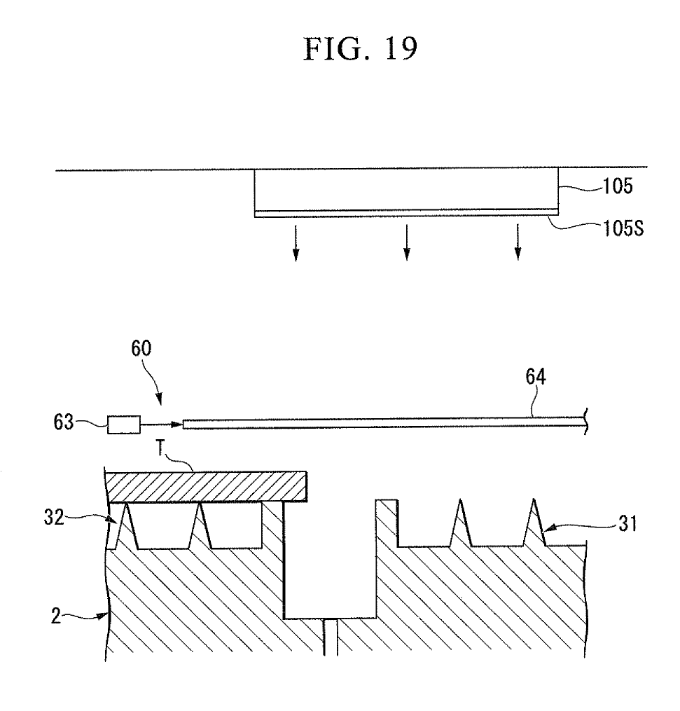

In addition, as shown in FIG. 19, the suppression mechanism 60 may include a shutter member 62 that covers at least a part of the substrate stage 2 in at least a part of the second period. The shutter member 62 can be moved by the drive apparatus 63. By doing so, the gas from the gas supply portion 105S is suppressed from reaching the first holding portion 31.

In at least a part of the second period, the supply of gas from the air supply portion 1055 may be stopped or the amount (flow rate) of the supplied gas may be decreased. In addition, in the present embodiment, fluid may be suctioned from the suction port 24 with a first suction force in the first period, and fluid may be suctioned from the suction port 24 with a second suction force larger than the first suction force in the second period. Moreover, and the suction force of the suction port 24 in at least a part of the first period may not be set to be smaller than the suction force of the suction port 24 in the second period.

### Sixth Embodiment

Next, a sixth embodiment will be described. In the following description, constituent portions that are identical or equivalent to those of the above embodiments will be denoted by the same reference symbols, and description thereof will be simplified or omitted.

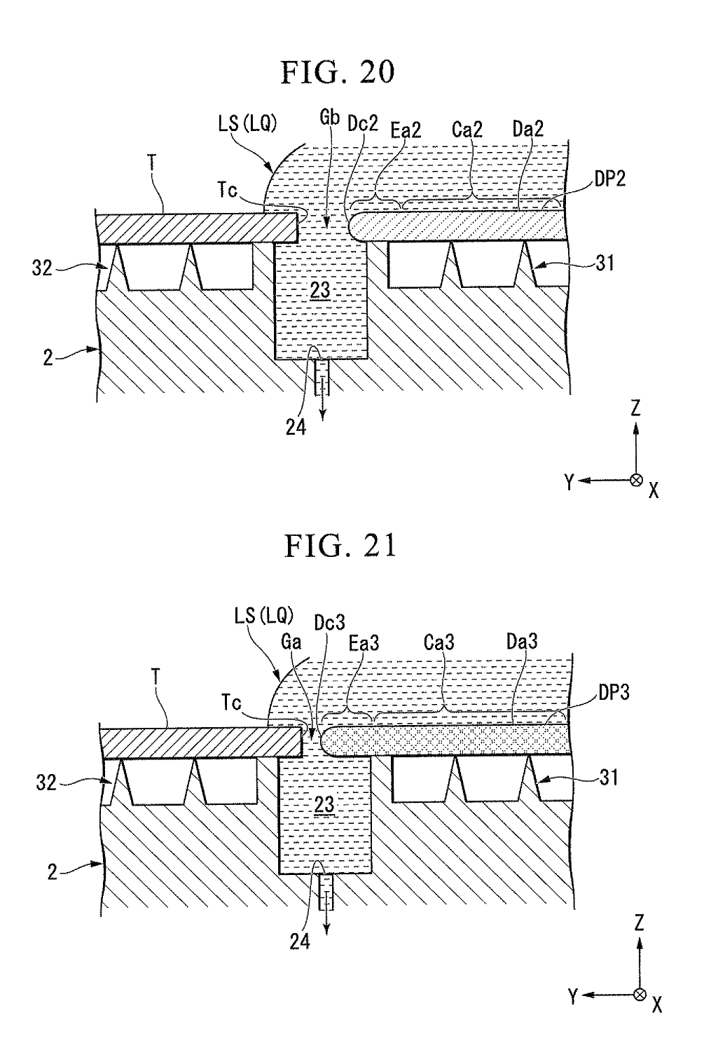

FIG. 20 shows an example of the operation of the exposure apparatus EX according to the present embodiment. A dummy substrate DP2 is held on the first holding portion 31 in the second period in which the exposure of the substrate P is not executed. In the present embodiment, the outer shape (dimensions and diameter) of the dummy substrate DP2 is smaller than the outer shape (dimensions and diameter) of the substrate P for manufacturing devices.

A gap Gb is formed between the dummy substrate DP2 held on the first holding portion 31 and the cover member T held on the second holding portion 32. The dimension of the gap Gb is larger than the dimension of the gap Ga formed between the substrate P and the cover member T.

In the present embodiment, a peripheral portion Ea2 of the upper surface Da2 of the dummy substrate DP2 is lyophilic with respect to the liquid LQ. The peripheral portion Ea2 of the upper surface Da2 of the dummy substrate DP2 is more lyophilic than a central portion Ca2 of the upper surface Da2 of the dummy substrate DP2. Moreover, the contact angle of the peripheral portion Ea2 of the upper surface Da2 of the dummy substrate DP2 with respect to the liquid LQ is smaller than that of the upper surface Pa of the substrate P. Moreover, a side surface Dc2 of the dummy substrate DP2 facing the inner surface Tc of the cover member T is also lyophilic with respect to the liquid LQ. Moreover, the side surface Dc2 of the dummy substrate DP2 facing the inner surface Tc of the cover member T is also more lyophilic than the central portion Ca2 of the upper surface Da2 of the dummy substrate DP2. Furthermore, the contact angle of the side surface Dc2 of the dummy substrate DP2 with respect to the liquid LQ is smaller than the side surface Pc of the substrate P. For example, the contact angle of the peripheral portion Ea2 of the upper surface Da2 and the side surface Dc2 of the dummy substrate DP2 with respect to the liquid LQ is smaller than 90°.

In the present embodiment, the second period includes a maintenance period of the exposure apparatus EX or an idling period, for example. The immersion space LS is formed with the liquid LQ between the terminating optical element 12 and the liquid immersion member 7 and the dummy substrate DP2 in at least a part of the second period (the maintenance period or the idling period) of the present embodiment. The immersion space LS is formed when the recovery of the liquid LQ from the recovery port 16 is executed in parallel with the supply of the liquid LQ from the supply port 15. In this way, at least a part of the liquid immersion member 7, for example, is cleaned with the liquid LQ. Moreover, the immersion space LS is formed with the liquid LQ between the terminating optical element 12 and the liquid immersion member 7 and the cover member T, whereby at least a part of the liquid immersion member 7 and at least a part of the cover member T are cleaned with the liquid LQ.

Moreover, in the present embodiment, the immersion space LS is formed with the liquid LQ between the terminating optical element 12 and the liquid immersion member 7, and the dummy substrate DP2 and the cover member T in at least a part of the second period. In the present embodiment, since the dimension of the gap Gb is larger than the dimension of the gap Ga, and the peripheral portion of the upper surface and the side surface of the dummy substrate DP2 are lyophilic with respect to the liquid LQ, at least a part of the liquid LQ of the immersion space LS flows smoothly into the space portion 23 which is in communication with the gap Gb.

The control apparatus 8 executes the suction operation of the suction port 24. In this way, the liquid LQ flowing into the space portion 23 through the gap Gb is recovered (suctioned) from the suction port 24. Thus, the inner surface that defines the space portion 23 is cleaned with the liquid LQ. Moreover, the inner surface of the cover member T, for example, is cleaned with the liquid LQ.

In the second period, the control apparatus 8 suctions fluid (the liquid LQ) of the space portion 23 from the suction port 24 with the first suction force. That is, the control apparatus 8 executes the suction operation of the suction port 24 in the second period with the same suction force as the suction force of the suction port 24 in the first period in which the exposure of the substrate P is executed. In addition, the suction port 24 may suction fluid (the liquid LQ) with the second suction force in the second period. In addition, fluid (the liquid LQ) may be suctioned from the suction port 24 with the first suction force when the dummy substrate DP2 is held on the first holding portion 31, and fluid (the liquid LQ) may be suctioned from the suction port 24 with the second suction force after the dummy substrate DP2 is unloaded from the first holding portion 31.

According to the present embodiment, in the second period in which the dummy substrate DP2 is held on the first holding portion 31, the liquid LQ flows into the space portion 23, so that the liquid LQ is vaporized in the space portion 23 (or the vicinity thereof). Therefore, the temperature of the substrate stage 2 in the first period (the period in which the exposure of the substrate P is executed) and the temperature of the substrate stage 2 in the second period (the maintenance period or the idling period) are maintained substantially at the same value.

In addition, the exposure of the substrate P may be executed after the second period (the maintenance period or the idling period).

In addition, in the present embodiment, although the peripheral portion of the upper surface of the dummy substrate DP2 and the side surface of the dummy substrate DP2 facing the inner surface of the cover member T are lyophilic with respect to the liquid LQ, they may be liquid-repellent with respect to the liquid LQ. For example, the contact angle of the peripheral portion of the upper surface and the side surface of the dummy substrate DP2 with respect to the liquid LQ may be 90° or more. Even when the peripheral portion of the upper surface and the side surface of the dummy substrate DP2 are liquid-repellent with respect to the liquid LQ, since the outer shape of the dummy substrate DP2 is smaller than the outer shape of the substrate P, at least a part of the liquid LQ of the immersion space LS flows smoothly into the space portion 23 through the gap Gb.

Moreover, in the present embodiment, as described in the first embodiment, the suction force of the suction port 24 in at least a part of the first period may be set to be smaller than the suction force of the suction port 24 in the second period, and the suction force of the suction port 24 in at least a part of the first period may not be set to be smaller than the suction force of the suction port 24 in the second period.

### Seventh Embodiment

Next, a seventh embodiment will be described. In the following description, constituent portions that are identical or equivalent to those of the above embodiments will be denoted by the same reference symbols, and description thereof will be simplified or omitted.

FIG. 21 shows an example of the operation of the exposure apparatus EX according to the present embodiment. A dummy substrate DP3 is held on the first holding portion 31 in the second period (the maintenance period or the idling period) in which the exposure of the substrate P is not executed. In the present embodiment, the outer shape (dimensions and diameter) of the dummy substrate DP3 is approximately the same as the outer shape (dimensions and diameter) of the substrate P for manufacturing devices. The gap Ga is formed between the dummy substrate DP3 held on the first holding portion 31 and the cover member T held on the second holding portion 32.

In the present embodiment, the peripheral portion Ea3 of the upper surface Da3 of the dummy substrate DP3 and the side surface Dc3 of the dummy substrate DP3 facing the inner surface Tc of the cover member T are lyophilic with respect to the liquid LQ. The peripheral portion Ea3 of the upper surface Da3 of the dummy substrate DP3 and the side surface Dc3 of the dummy substrate DP3 facing the inner surface Tc of the cover member T are more lyophilic with respect to the liquid LQ than the central portion Ca3 of the upper surface Da3 of the dummy substrate DP3. Moreover, the contact angle of the peripheral portion Ea3 of the upper surface Da3 of the dummy substrate DP3 with respect to the liquid LQ is smaller than that of the upper surface Pa of the substrate P. Moreover, the contact angle of the side surface Dc3 of the dummy substrate DP3 is smaller than that of the side surface Pc of the substrate P. For example, the contact angle of the peripheral portion Ea3 of the upper surface Da3 and the side surface Dc3 of the dummy substrate DP3 with respect to the liquid LQ is smaller than 90°.

The immersion space LS is formed with the liquid LQ between the terminating optical element 12 and the liquid immersion member 7, and the dummy substrate DP3 and the cover member T in at least a part of the second period (the maintenance period or the idling period).

Even when the outer shape of the dummy substrate DP3 is approximately the same as the outer shape of the substrate P, since the peripheral portion Ea3 of the upper surface Da3 and the side surface Dc3 of the dummy substrate DP3 are lyophilic with respect to the liquid LQ, at least a part of the liquid LQ of the immersion space LS flows smoothly into the space portion 23 which is in communication with the gap Ga in the second period (the maintenance period or the idling period).

The control apparatus 8 executes the suction operation of the suction port 24. In this way, the liquid LQ flowing into the space portion 23 through the gap Gb is recovered (suctioned) from the suction port 24. Thus, the inner surface that defines the space portion 23 is cleaned with the liquid LQ. Moreover, the inner surface of the cover member T, for example, is cleaned with the liquid LQ.

In addition, the suction operation of the suction port 24 may be executed in a state where the dummy substrate DP1 described with reference to FIG. 18 is held on the first holding portion 31, the cover member T is held on the second holding portion 32, and the immersion space LS is formed with the liquid LQ between the terminating optical element 12 and the liquid immersion member 7, and the dummy substrate DP1 and the cover member T.

Moreover, in the present embodiment, as described in the first embodiment, the suction force of the suction port 24 in at least a part of the first period may be set to be smaller than the suction force of the suction port 24 in the second period, and the suction force of the suction port 24 in at least a part of the first period may not be set to be smaller than the suction force of the suction port 24 in the second period.

### Eighth Embodiment

Next, an eighth embodiment will be described. In the following description, constituent portions that are identical or equivalent to those of the above embodiments will be denoted by the same reference symbols, and description thereof will be simplified or omitted.

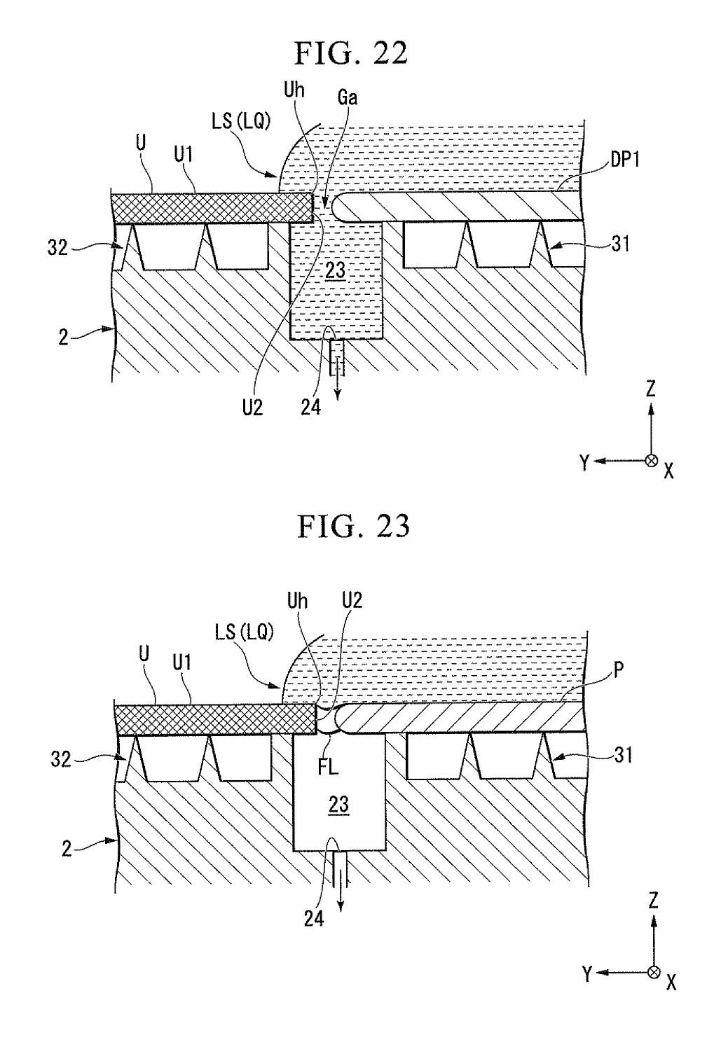

FIG. 22 shows an example of the operation of the exposure apparatus EX according to the present embodiment. In the present embodiment, the dummy substrate DP1 described with reference to FIG. 18 is held on the first holding portion 31 in the second period (the maintenance period or the idling period). In addition, the dummy substrate DP2 described with reference to FIG. 20 may be held on the first holding portion 31, and the dummy substrate DP3 described with reference to FIG. 21 may be held on the first holding portion 31.

In the present embodiment, a cover member U is held on the second holding portion 32. The cover member U includes an aperture Uh in which the dummy substrate DP1 held on the first holding portion 31 is disposed. Moreover, the cover member U includes an upper surface U1 that defines the aperture Uh and is disposed around the upper surface of the dummy substrate DP1 and an inner surface U2 facing the side surface of the dummy substrate DP1. A gap Ga is formed between the dummy substrate DP1 held on the first holding portion 31 and the cover member U held on the second holding portion 32. The substrate stage 2 includes a space portion 23 that is in communication with the gap Ga and a suction port 24 that suctions fluid in the space portion 23.

In the present embodiment, at least a part of the inner surface U2 of the cover member U (the aperture Uh) is lyophilic with respect to the liquid LQ. For example, the contact angle of the inner surface U2 with respect to the liquid LQ is smaller than 90°. In the present embodiment, the contact angle of the inner surface U2 with respect to the liquid LQ is smaller than the contact angle of the side surface of the dummy substrate DP1. Moreover, in the present embodiment, the contact angle of the inner surface U2 with respect to the liquid LQ is smaller than the contact angle of the side surface of the substrate P.

In addition, the upper surface U1 of the cover member U that can face the emission surface 13 is liquid-repellent with respect to the liquid LQ. For example, the contact angle of the upper surface U1 of the liquid LQ is 90° or more. In the present embodiment, the contact angle of the inner surface U2 with respect to the liquid LQ is smaller than the contact angle of the upper surface U1.

In addition, the inner surface U2 may not be entirely lyophilic. For example, only the lower portion of the inner surface U2 may be lyophilic.

Moreover, the lyophilic property of the upper portion of the inner surface U2 may be different from the lyophilic property of the lower portion. For example, the lower portion of the inner surface U2 may be more lyophilic than the upper portion. That is, the contact angle of the lower portion of the inner surface U2 with respect to the liquid LQ may be smaller than the contact angle of the upper portion with respect to the liquid LQ.

In addition, a ring-shaped region of the upper surface U1 around the aperture Uh connected to the inner surface U2 may be lyophilic with respect to the liquid LQ.

The suction operation of the suction port 24 is executed in a state where the dummy substrate DP1 is held on the first holding portion 31 in at least a part of the second period (the maintenance period or the idling period).

In the present embodiment, since the inner surface U2 of the cover member U is lyophilic with respect to the liquid LQ, at least a part of the liquid LQ of the immersion space LS smoothly flows into the space portion 23 through the gap Ga in the second period (the maintenance period or the idling period).

Moreover, the suction operation of the suction port 24 is executed in a state where the substrate P is held on the first holding portion 31 in at least a part of the first period in which the exposure of the substrate P is executed. As shown in FIG. 23, there is a possibility that a film FL of the liquid LQ is formed between the inner surface U2 of the cover member U and the side surface of the substrate P in the first period. In the present embodiment, since the inner surface U2 of the cover member U is lyophilic with respect to the liquid LQ, the film FL of the liquid LQ is smoothly removed between the inner surface U2 of a bar member U and the side surface of the substrate P by the suction operation of the suction port 24. In this case, by disposing the porous member (42B) as described using FIG. 8, the liquid LQ flowing into the gap between the cover member U and the substrate P is removed more smoothly.

Moreover, since the liquid LQ of the inner surface U2 of the cover member U is lyophilic, when the suction operation of the suction port 24 is executed in the first period, the liquid LQ of the immersion space LS smoothly flows into the space portion 23 through the gap Ga between the substrate P and the cover member U. In this way, the space portion 23 is cleaned with the liquid LQ in the first period.

Moreover, when the suction operation of the suction port 24 is executed in steps ST1 to ST7 shown in FIG. 4, for example, the liquid LQ of the immersion space LS can flow into the space portion 23 in each of the first and second periods in steps ST1 to ST7. In addition, the suction force of the suction port 24 in the first period may be smaller than the suction force of the suction port 24 in the second period and may be the same as the suction force of the suction port 24 in the second period.

In addition, in the present embodiment, the cover member U may be formed so as to be integrated with the substrate stage 2.

Moreover, in the present embodiment, as described in the first embodiment, the suction force of the suction port 24 in at least a part of the first period may be set to be smaller than the suction force of the suction port 24 in the second period, and the suction force of the suction port 24 in at least a part of the first period may not be set to be smaller than the suction force of the suction port 24 in the second period.

### Ninth Embodiment

Next, a ninth embodiment will be described. In the following description, constituent portions that are identical or equivalent to those of the above embodiments will be denoted by the same reference symbols, and description thereof will be simplified or omitted.

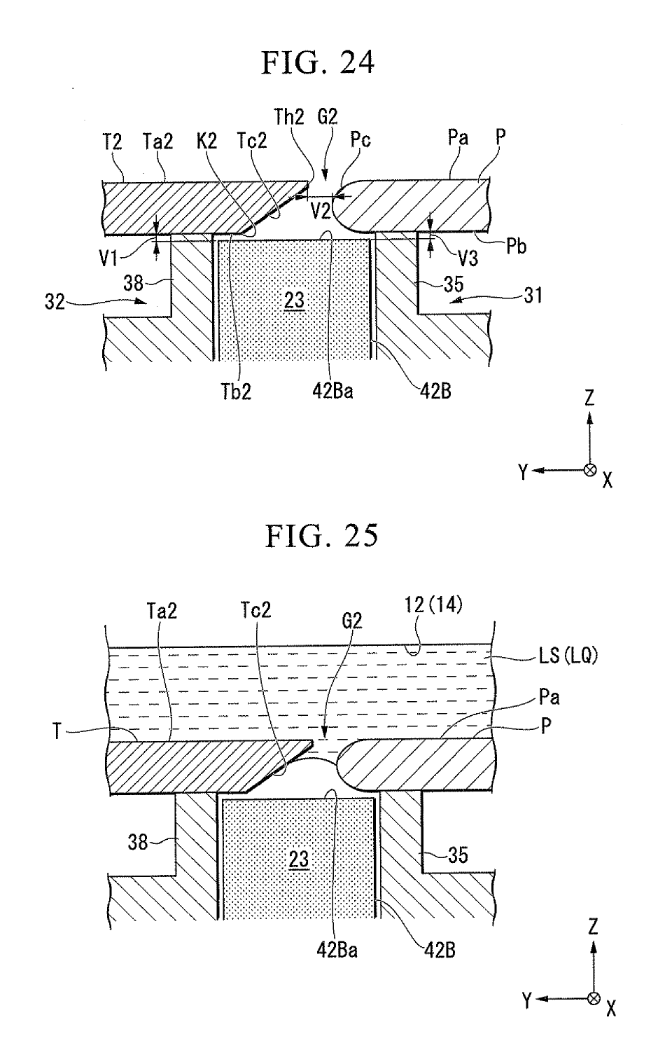

FIG. 24 shows an example of the operation of the exposure apparatus EX according to the present embodiment. In the present embodiment, the substrate stage 2 includes an upper surface Ta2 that defines an aperture Th2 in which the substrate P can be disposed and that is disposed around the upper surface Pa of the substrate P in a state where the substrate P is held on the first holding portion 31, a space portion 23 that is in communication with a gap G2 between the upper surface Pa of the substrate P and the upper surface Ta2, a porous member 42B disposed in the space portion 23, and an inclined surface Tc2 in which at least a part thereof faces the upper surface 42Ba of the porous member 42B and which is inclined downward in an outward direction about the center of the aperture Th2. The inclined surface Tc2 has an outward declination (an outward and downward inclination) in an radial direction.

Moreover, the substrate stage 2 includes a lower surface Tb2 that faces the opposite direction of the upper surface Ta2 and is connected to the lower end of the inclined surface Tc2. A boundary portion K2 between the inclined surface Tc2 and the lower surface Tb2 faces the upper surface 42Ba of the porous member 42B.

In addition, the boundary portion K2 may not face the upper surface 42Ba. That is, in the example shown in FIG. 24, although both the inclined surface Tc2 and the lower surface Tb2 face the upper surface 42Ba, the inclined surface Tc2 may face the upper surface 42Ba and the lower surface Tb2 may not face the upper surface 42Ba. Moreover, the lower surface Tb2 may face the upper surface 42Ba, and the inclined surface Tc2 may not face the upper surface 42Ba.

In the present embodiment, the substrate stage 2 includes a second holding portion 32 that is disposed around the first holding portion 31 so as to releasably hold the cover member T2. In the present embodiment, the cover member T2 includes the upper surface Ta2, the inclined surface Tc2, and the lower surface Tb2.

In addition, the cover member T2 may be formed so as to be integrated with the substrate stage 2.

In the present embodiment, at least a part of the inclined surface Tc2 faces the side surface Pc of the substrate P. In addition, the inclined surface Tc2 may not face the side surface Pc of the substrate P.

In the example shown in FIG. 24, the gap V1 between the upper surface 42Ba of the porous member 42B and the lower surface Tb2 of the cover member T2 is smaller than the gap V2 between the inclined surface Tc2 of the cover member T2 and the side surface Pc of the substrate P. Moreover, in the example shown in FIG. 24, the gap V3 between the upper surface 42Ba of the porous member 42B and the lower surface Pb of the substrate P is smaller than the gap V2 between the inclined surface Tc2 of the cover member T2 and the side surface Pc of the substrate P.

In the present embodiment, the contact angle of the inclined surface Tc2 with respect to the liquid LQ is smaller than the contact angle of the side surface Pc of the substrate P. In the present embodiment, the inclined surface Tc2 is lyophilic with respect to the liquid LQ. The contact angle of the inclined surface Tc2 with respect to the liquid LQ is smaller than 90°, for example. In addition, the contact angle of the inclined surface Tc2 with respect to the liquid LQ may be smaller than 80°, may be smaller than 70°, may be smaller than 60°, may be smaller than 50°, may be smaller than 40°, may be smaller than 30°, and may be smaller than 20°. As an example, the contact angle of the inclined surface Tc2 with respect to the liquid LQ may be equal to or smaller than approximately 85°, 80°, 75°, 70°, 65°, 60°, 55°, 50°, 45°, 40°, 35°, 30°, 25°, 20°, 15°, 10°, or 5′.

In addition, the contact angle of the inclined surface Tc2 with respect to the liquid LQ may be larger than the contact angle of the side surface Pc of the substrate P. For example, the inclined surface Tc2 may be lyophilic with respect to the liquid LQ. For example, the contact angle of the inclined surface Tc2 with respect to the liquid LQ may be 90° or more, may be 100° or more, and may be 110° or more. As an example, the contact angle of the inclined surface Tc2 with respect to the liquid LQ may be equal to or smaller than approximately 90°, 95°, 100°, 105°, 110°, or 115°.

Moreover, in FIG. 24, the angle between the upper surface Ta2 and the inclined surface Tc2 is an acute angle. The angle between the upper surface Ta2 and the inclined surface Tc2 may be equal to or smaller than 45°, 30°, or 20°, for example. As an example, the angle between the upper surface Ta2 and the inclined surface Tc2 may be 35°, 30°, 25°, 20°, 15°, 10°, or 5°.

Similarly to the embodiment described with reference to FIG. 8 and the like, the substrate stage 2 includes a suction port 24 that suctions fluid in the space portion 23. The suction port 24 can suction fluid in the space portion 23 through the holes of the porous member 42B.

FIG. 25 is a diagram showing an example of a state where the immersion space LS is formed on the gap G2. As shown in FIG. 25, there is a possibility that the liquid LQ of the immersion space LS formed between the terminating optical element 12 and at least one of the upper surface Pa and the upper surface Ta2 of the substrate P flows into the space portion 23 through the gap G2. In the present embodiment, at least a part of the liquid LQ of the immersion space LS flowing between the inclined surface Tc2 of the space portion 23 and the upper surface 42Ba of the porous member 4213 through the gap G2 is recovered through the holes of the porous member 42B. The control apparatus 8 can recover the liquid LQ of the space portion 23 through the holes of the porous member 42B by executing the suction operation of the suction port 24.

In the present embodiment, since the inclined surface Tc2 is formed, the liquid LQ of the immersion space LS on the gap G2 can smoothly flow into the space portion 23.

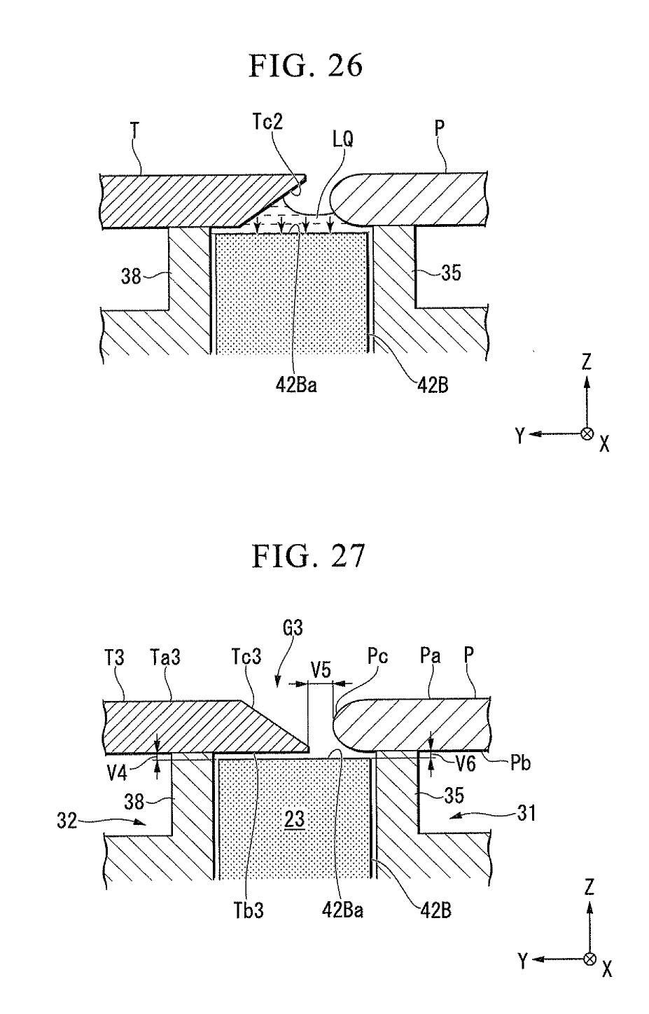

Moreover, as shown in FIG. 26, since the inclined surface Tc2 is formed, when the suction operation of the suction port 24 is executed, the liquid LQ of the space portion 23 (the liquid LQ between the inclined surface Tc2 and the upper surface 42Ba) is smoothly recovered through the porous member 42B.

In addition, the porous member 42A described with reference to FIG. 7 and the like may be disposed in the space portion 23.

For example, the gap V1 between the upper surface 42Aa of the porous member 42A and the lower surface Tb2 of the cover member T2 may be larger than the gap V2 between the inclined surface Tc2 of the cover member T2 and the side surface Pc of the substrate P. Moreover, the gap V3 between the upper surface 42Aa of the porous member 42A and the lower surface Pb of the substrate P may be larger than the gap V2 between the inclined surface Tc2 of the cover member T2 and the side surface Pc of the substrate P.

In the embodiment, no porous member may be disposed in the space portion 23.

In addition, in FIG. 24 to FIG. 26, although an example in which the substrate P is held on the first holding portion 31 is described, the dummy substrate DP1 described with reference to FIG. 18 and the like may be held on the first holding portion 31, the dummy substrate DP2 described with reference to FIG. 20 and the like may be held on the first holding portion 31, and the dummy substrate DP3 described with reference to FIG. 21 and the like may be held on the first holding portion 31.

Moreover, in the present embodiment, as described in the first embodiment, the suction force of the suction port 24 in at least a part of the first period may be set to be smaller than the suction force of the suction port 24 in the second period, and the suction force of the suction port 24 in at least a part of the first period may not be set to be smaller than the suction force of the suction port 24 in the second period.

### Tenth Embodiment

Next, a tenth embodiment will be described. In the following description, constituent portions that are identical or equivalent to those of the above embodiments will be denoted by the same reference symbols, and description thereof will be simplified or omitted.

FIG. 27 shows an example of the operation of the exposure apparatus EX according to the present embodiment. In the present embodiment, the substrate stage 2 includes an upper surface Ta3 that defines an aperture Th3 in which the substrate P can be disposed and that is disposed around the upper surface Pa of the substrate P in a state where the substrate P is held on the first holding portion 31, a space portion 23 that is in communication with a gap G3 between the upper surface Pa of the substrate P and the upper surface Ta3, a porous member 42B disposed in the space portion 23, an inclined surface Tc3 in which at least a part thereof faces the side surface Pc of the substrate P and which is inclined upward in an outward direction about the center of the aperture Th3, and a lower surface Tb3 that faces the opposite direction of the upper surface Ta3 and in which at least a part thereof faces the upper surface 42Ba of the porous member 42B. The inclined surface Tc3 has an outward and upward inclination in an radial direction.

In addition, the inclined surface Tc3 may not face the side surface Pc of the substrate P.

In the present embodiment, the substrate stage 2 includes a second holding portion 32 that is disposed around the first holding portion 31 so as to releasably hold the cover member T3. In the present embodiment, the cover member T3 includes the upper surface Ta3, the inclined surface Tc3, and the lower surface Tb3.

In addition, the cover member T3 may be formed so as to be integrated with the substrate stage 2.

In the example shown in FIG. 27, the gap V4 between the upper surface 42Ba of the porous member 42B and the lower surface Tb3 of the cover member T3 is smaller than the gap V5 between the inclined surface Tc3 of the cover member T3 and the side surface Pc of the substrate P. Moreover, in the example shown in FIG. 27, the gap V6 between the upper surface 42Ba of the porous member 42B and the lower surface Pb of the substrate P is smaller than the gap V6 between the inclined surface Tc3 of the cover member T3 and the side surface Pc of the substrate P.

In the present embodiment, the contact angle of the inclined surface Tc3 with respect to the liquid LQ is smaller than the contact angle of the side surface Pc of the substrate P. In the present embodiment, the inclined surface Tc3 is lyophilic with respect to the liquid LQ. The contact angle of the inclined surface Tc3 with respect to the liquid LQ is smaller than 90°, for example. In addition, the contact angle of the inclined surface Tc3 with respect to the liquid LQ may be smaller than 80°, may be smaller than 70°, may be smaller than 60°, may be smaller than 50°, may be smaller than 40°, may be smaller than 30°, and may be smaller than 20°. As an example, the contact angle of the inclined surface Tc3 with respect to the liquid LQ may be equal to or smaller than approximately 85°, 80°, 75°, 70°, 65°, 60°, 55°, 50°, 45°, 40°, 35°, 30°, 25°, 20°, 15°, 10°, or 5°.

In addition, the contact angle of the inclined surface Tc3 with respect to the liquid LQ may be larger than the contact angle of the side surface Pc of the substrate P. For example, the inclined surface Tc3 may be lyophilic with respect to the liquid LQ. For example, the contact angle of the inclined surface Tc3 with respect to the liquid LQ may be 90° or more, may be 100° or more, and may be 110° or more. As an example, the contact angle of the inclined surface Tc3 with respect to the liquid LQ may be equal to or smaller than approximately 90°, 95°, 100°, 105°, 110°, or 115°.

Moreover, in FIG. 27, the angle between the lower surface Tb3 and the inclined surface Tc3 is an acute angle. The angle between the lower surface Tb3 and the inclined surface Tc3 may be equal to or smaller than 45°, 30°, or 20°, for example. As an example, the angle between the lower surface Tb3 and the inclined surface Tc3 may be equal to or smaller than approximately 85°, 80°, 75°, 70°, 65°, 60°, 55°, 50°, 45°, 40°, 35°, 30°, 25°, 20°, 15°, 10°, or 5°.

Similarly to the embodiment described with reference to FIG. 8 and the like, the substrate stage 2 includes a suction port 24 that suctions fluid in the space portion 23. The suction port 24 can suction fluid in the space portion 23 through the holes of the porous member 42B.

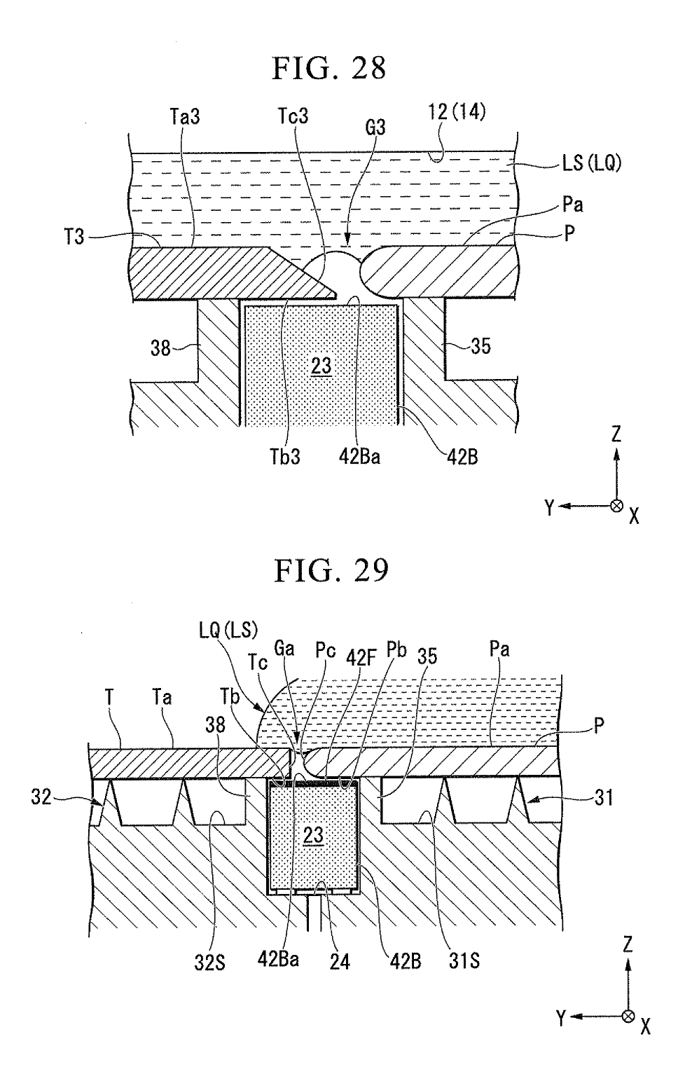

FIG. 28 is a diagram showing an example of a state where the immersion space LS is formed on the gap G3. As shown in FIG. 28, there is a possibility that the liquid LQ of the immersion space LS formed between the terminating optical element 12 and at least one of the upper surface Pa, the upper surface Ta3, and the inclined surface Tc3 of the substrate P flows into the space portion 23 through the gap G3. In the present embodiment, at least a part of the liquid LQ of the immersion space LS flowing between the lower surface Tb3 of the space portion 23 and the upper surface 42Ba of the porous member 42B through the gap G3 is recovered through the holes of the porous member 42B. The control apparatus 8 can recover the liquid LQ of the space portion 23 through the holes of the porous member 42B by executing the suction operation of the suction port 24.

In the present embodiment, since the inclined surface Tc3 is formed, the liquid LQ of the immersion space LS on the gap G2 can smoothly flow into the space portion 23. The liquid LQ flowing into the space portion 23 is smoothly recovered through the porous member 42B when the suction operation of the suction port 24 is executed.

In addition, the porous member 42A described with reference to FIG. 7 and the like may be disposed in the space portion 23.

For example, the gap V4 between the upper surface 42Aa of the porous member 42A and the lower surface Tb3 of the cover member T3 may be larger than the gap V5 between the inclined surface Tc3 of the cover member T3 and the side surface Pc of the substrate P. Moreover, the gap V6 between the upper surface 42Aa of the porous member 42A and the lower surface Pb of the substrate P may be larger than the gap V5 between the inclined surface Tc3 of the cover member T3 and the side surface Pc of the substrate P.

In the embodiment, no porous member may be disposed in the space portion 23.

In addition, in FIG. 27 and FIG. 28, although an example in which the substrate P is held on the first holding portion 31 is described, the dummy substrate DP1 described with reference to FIG. 18 and the like may be held on the first holding portion 31, the dummy substrate DP2 described with reference to FIG. 20 and the like may be held on the first holding portion 31, and the dummy substrate DP3 described with reference to FIG. 21 and the like may be held on the first holding portion 31,

In the present embodiment, as described in the first embodiment, the suction force of the suction port 24 in at least a part of the first period may be set to be less than the suction force of the suction port 24 in the second period, and the suction force of the suction port 24 in at least a part of the first period may not be set to be smaller than the suction force of the suction port 24 in the second period.

### Eleventh Embodiment

Next, an eleventh embodiment will be described. In the following description, constituent portions that are identical or equivalent to those of the above embodiments will be denoted by the same reference symbols, and description thereof will be simplified or omitted.

FIG. 29 shows an example of a substrate stage 2 according to the eleventh embodiment. The substrate stage 2 includes a first holding portion 31 that releasably holds the lower surface Pb of the substrate P, an upper surface Ta that defines an aperture Th in which the substrate P can be disposed and that is disposed around the upper surface Pa of the substrate P in a state where the substrate P is held on the first holding portion 31, a space portion 23 that is in communication with the gap Ga between the upper surface Pa of the substrate P and the upper surface Ta, and a porous member 42B that is disposed in the space portion 23, that includes an upper surface 42Ba that faces the gap G, and that has holes through which fluid in the space portion 23 is suctioned. The contact angle of the upper surface 42Ba of the porous member 42B with respect to the liquid LQ is larger than the contact angle of the upper surface Pa of the substrate P. Moreover, in the present embodiment, the contact angle of the upper surface 42Ba with respect to the liquid LQ is larger than the contact angle of the side surface Pc of the substrate P. In the present embodiment, the contact angle of the upper surface 42Ba of the porous member 42B with respect to the liquid LQ is about 100°, for example. In addition, the contact angle of the upper surface 42Ba with respect to the liquid LQ may be about 110° and may be about 120°.

In the present embodiment, the porous member 42B is formed of titanium. The upper surface 42Ba is coated with a liquid-repellent material containing fluorine. That is, a film 42F containing a liquid-repellent material is disposed on the upper surface 42Ba. Examples of the liquid-repellent material include PFA (Tetra fluoro ethylene-perfluoro alkylvinyl ether copolymer), PTFE (Poly tetra fluoro ethylene), PEEK (polyetheretherketone), and Teflon®.

Since the contact angle of the upper surface 42Ba of the porous member 42B with respect to the liquid LQ is larger than at least one of the contact angle of the upper surface Pa of the substrate P and the contact angle of the side surface Pc, the liquid LQ flowing into the space portion 23 through the gap Ga is suppressed from entering into the gap between the lower surface Tb of the cover member T and the upper surface 42Ba of the porous member 42B. In other words, the liquid LQ of the picture signals 23 is suppressed from entering the space on the lower surface Tb side of the cover member T, and the lower surface Tb is suppressed from getting wet with the liquid LQ. Moreover, the liquid LQ flowing into the space portion 23 is suppressed from entering into the gap between the lower surface Pb of the substrate P and the upper surface 42Ba of the porous member 42B. In other words, the liquid LQ of the space portion 23 is suppressed from entering into the gap on the lower surface Pb side of the substrate P, and the lower surface Pb is suppressed from getting wet with the liquid LQ.

In addition, a liquid-repellent member may be disposed in at least a part of the upper surface 42Ba. For example, a sheet member (a tape member) may be disposed as the liquid-repellent member. The contact angle of the surface of the liquid-repellent member with respect to the liquid LQ is larger than the contact angle of the upper surface Pa of the substrate P with respect to the liquid LQ. As the liquid-repellent member, for example, a tape (Teflon tape) containing Teflon® may be disposed, and a sheet (Gore sheet) containing Gore-Tex (product name) may be disposed.

In addition, in FIG. 29, although an example in which a gap is formed between the lower surface Tb and the upper surface 42Ba and between the lower surface Pb and the upper surface 42Ba is shown, the lower surface Pb and the upper surface 42Ba (the film 42F or the liquid-repellent member) may be in contact with each other, and the lower surface Tb and the upper surface 42Ba (the film 42F or the liquid-repellent member) may be in contact with each other.

### Twelfth Embodiment

Next, a twelfth embodiment will be described. In the following description, constituent portions that are identical or equivalent to those of the above embodiments will be denoted by the same reference symbols, and description thereof will be simplified or omitted.

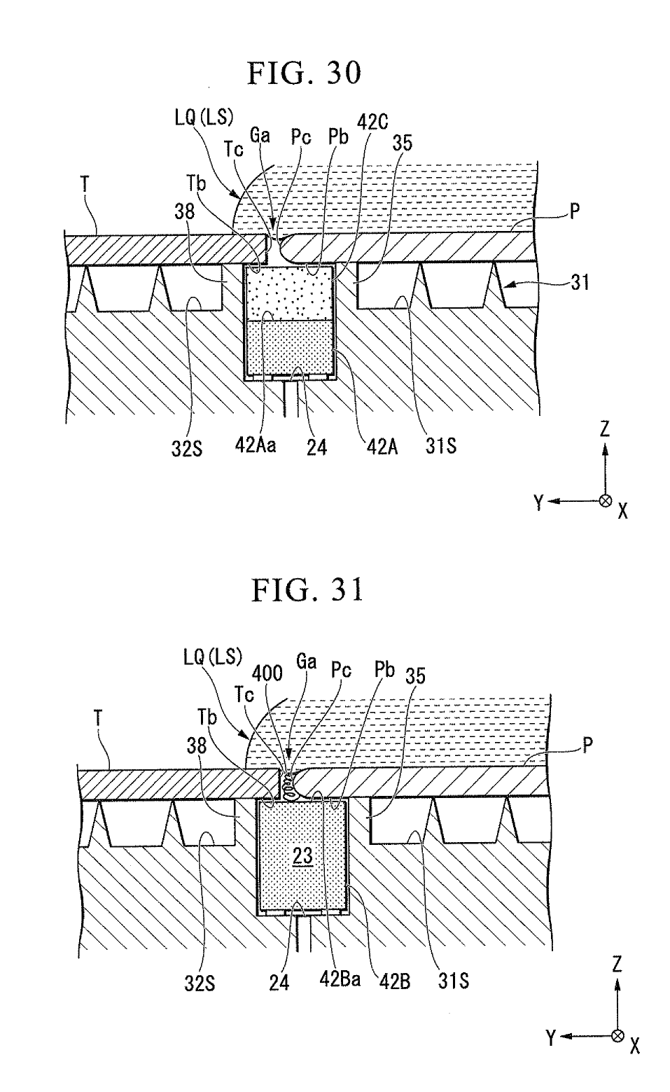

FIG. 30 shows an example of a substrate stage 2 according to the twelfth embodiment. As shown in FIG. 30, a porous member 42A having holes through which fluid in the space portion 23 is suctioned may be disposed in the space portion 23, and a porous member 42C may be disposed in the upper surface 42Aa of the porous member 42A. In FIG. 30, the porous member 42C is disposed on the upper surface of the porous member 42A so as to face the gap Ga. The holes of the porous member 42C are smaller than the holes of the porous member 42A.

In the present embodiment, the porous member 42A is formed of titanium, for example. The porous member 42A can be formed by a sintering method, for example. The porous member 42C is a fabric (wick), for example.

According to the present embodiment, the liquid LQ flowing into the space portion 23 through the gap Ga is absorbed by the porous member 42C. In this way, the liquid LQ is suppressed from entering into the space on the lower surface Tb side and the space on the lower surface Pb side. When the suction operation of the suction port 24 is executed, the liquid LQ absorbed into the porous member 42C is suctioned from the suction port 24 through the porous member 42A.

### Thirteenth Embodiment

Next, a thirteenth embodiment will be described. In the following description, constituent portions that are identical or equivalent to those of the above embodiments will be denoted by the same reference symbols, and description thereof will be simplified or omitted.

FIG. 31 shows an example of a substrate stage 2 according to the thirteenth embodiment. As shown in FIG. 31, a wire member 400 may be disposed in the gap Ga. The wire member 400 is disposed in the gap Ga so that at least a part thereof makes contact with the upper surface 42Ba of the porous member 42B. In addition, a thread may be disposed in the gap Ga. Moreover, a wire member (thread) of which the surface is liquid-repellent with respect to the liquid LQ may be disposed. For example, a wire member (thread) of which the contact angle with respect to the lq is 90° or more may be disposed.

According to the present embodiment, the liquid LQ of the immersion space LS is suppressed from flowing into the space portion 23 through the gap Ga. Moreover, even when the liquid LQ flows into the space portion 23, the liquid LQ is suppressed from entering into the space on the lower surface Tb side and the space on the lower surface Pb side.

### Fourteenth Embodiment

Next, a fourteenth embodiment will be described. In the following description, constituent portions that are identical or equivalent to those of the above embodiments will be denoted by the same reference symbols, and description thereof will be simplified or omitted.

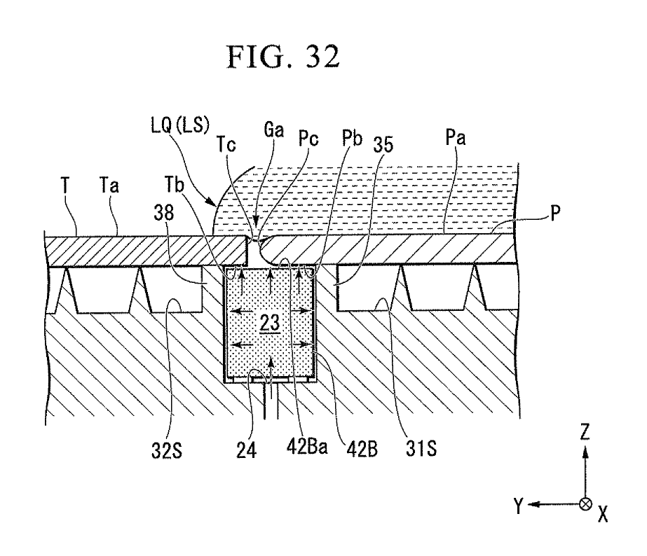

FIG. 32 shows an example of a substrate stage 2 according to the fourteenth embodiment. As shown in FIG. 32, in the present embodiment, when at least the immersion space LS is disposed on the gap Ga, gas is supplied from the suction port 24 to the space portion 23 through the porous member 42B. In the present embodiment, the suction port 24 functions as a gas supply port that supplies gas to the space portion 23 through the porous member 42B. In this way, the pressure of the space portion 23 becomes higher than the pressure of the space (the space that the upper surfaces Pa and Ta face) on the gap Ga. When the pressure of the space portion 23 increases, the liquid LQ of the immersion space LS is suppressed from flowing into the space portion 23 through the gap Ga.

### Fifteenth Embodiment

Next, a fifteenth embodiment will be described. In the following description, constituent portions that are identical or equivalent to those of the above embodiments will be denoted by the same reference symbols, and description thereof will be simplified or omitted.

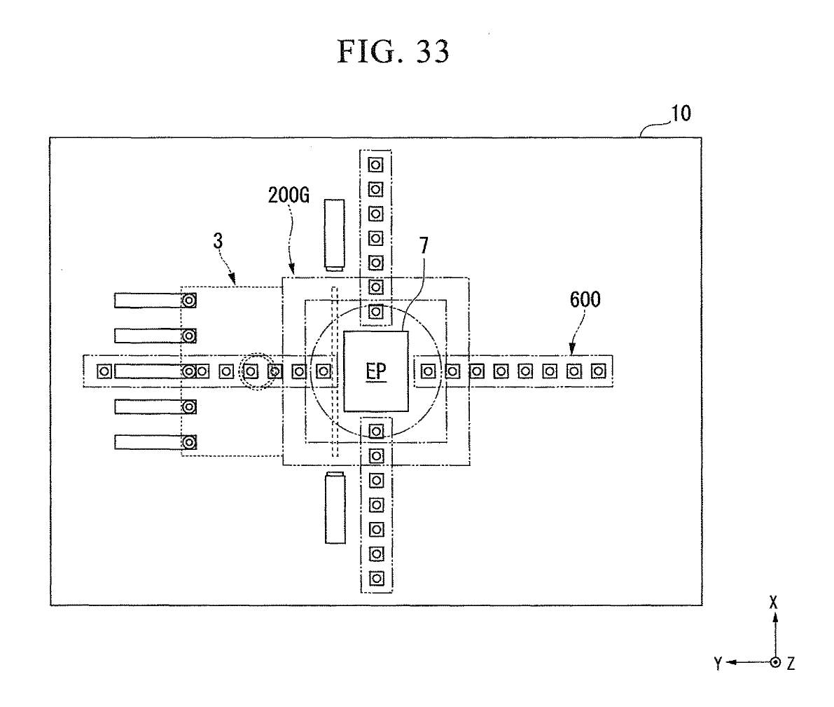

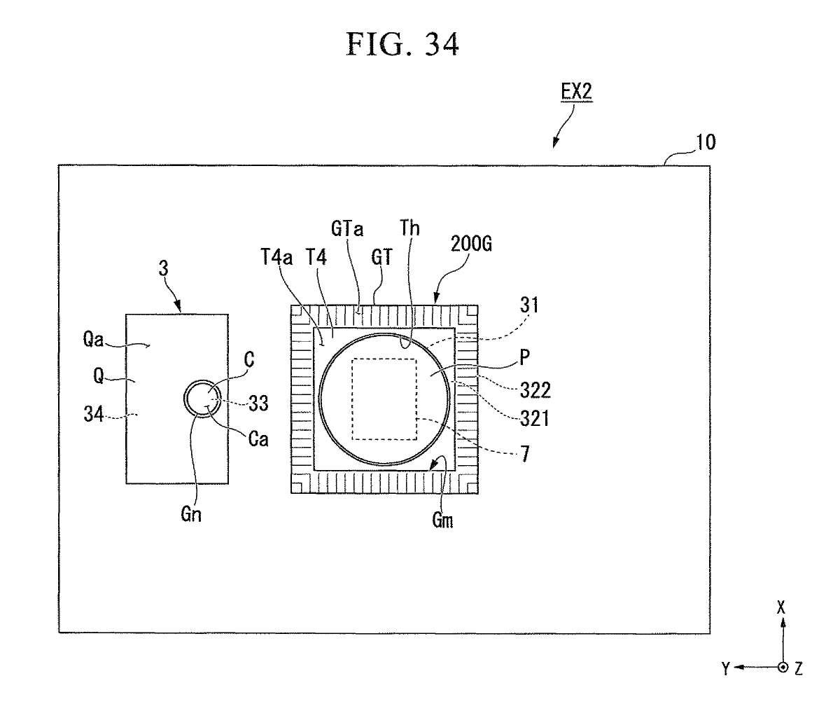

FIG. 33 and FIG. 34 are diagrams illustrating an example of an exposure apparatus EX according to the present embodiment. The exposure apparatus EX of the present embodiment includes an encoder system 600 that measures the position of a substrate stage 200G using a scaling member GT included in the substrate stage 200G, as disclosed in US Patent Application Publication No. 2007/0288121, for example. The scaling member GT functions as a measuring member that measures the position of the substrate stage 200G. FIG. 33 is a diagram illustrating the encoder system 600, and FIG. 34 is a diagram illustrating the substrate stage 200G and a measuring stage 3.

The substrate stage 200G is movable to a position (exposure position) EP that can be irradiated with an exposure light EL emitted from an emission surface 13. The measuring stage 3 is movable to the position (exposure position) EP that can be irradiated with the exposure light EL emitted from the emission surface 11

In FIG. 34, the substrate stage 200G includes a first holding portion 31 that holds and can release the lower surface of the substrate P, a scaling member GT which is disposed in at least a part of the position around the first holding portion 31, and in which the immersion space LS can be formed, and a cover member T4 which is provided to be adjacent to the scaling member GT and in which the immersion space LS can be formed.

In the present embodiment, the cover member T4 is disposed around the substrate P that is held on the first holding portion 31. The scaling member GT is disposed in at least a part of the position around the cover member T4. In the present embodiment, the scaling member GT is disposed around the cover member T4. In the present embodiment, the scaling member GT includes an aperture, and the cover member T4 is disposed in the aperture of the scaling member GT.

In addition, the scaling member GT may be disposed around the substrate P that is held on the first holding portion 31, and the cover member T4 may be disposed around the scaling member GT. The scaling member GT includes a grating that is measured by an encoder head of the encoder system 600. The cover member T4 does not include a grating.

The cover member T4 includes an upper surface T4a in which the immersion space LS of the liquid LQ can be formed between the emission surface 13 of the terminating optical element 12 and the lower surface 14 of the liquid immersion member 7. The scaling member GT includes an upper surface GTa in which the immersion space LS of the liquid LQ can be formed between the emission surface 13 and the lower surface 14.

In the present embodiment, a gap Gm is formed between the scaling member GT and the cover member T4. The upper surface GTa is disposed with the upper surface T4a and the gap Gm interposed.

In the present embodiment, the substrate stage 200G includes a second holding portion 321 that holds and can release the lower surface of the cover member T4 and a fifth holding portion 322 that holds and can release the lower surface of the scaling member GT. The second holding portion 321 is disposed in at least a part of the position around the first holding portion 31. The fifth holding portion 322 is disposed in at least a part of the position around the second holding portion 321. In the present embodiment, the second holding portion 321 and the fifth holding portion 322 include a pin chuck mechanism.

The cover member T4 and the scaling member GT are held on the substrate stage 200G. When the substrate stage 200G is moved, the cover member T4 and the scaling member GT held on the substrate stage 200G are also moved together with the substrate stage 200G. That is, with the movement of the substrate stage 2000, the cover member T4 and the scaling member GT can be moved to the exposure position EP. The cover member T4 held on the second holding portion 321 and the scaling member GT held on the fifth holding portion 322 can be moved together in a state where the gap Gm is maintained.

In the present embodiment, at least a part of the immersion space LS can be formed between the emission surface 13 and the lower surface 14, and the upper surface T4a of the cover member T4. Moreover, at least a part of the immersion space LS can be formed between the emission surface 13 and the lower surface 14, and the upper surface GTa of the scaling member GT. Moreover, at least a part of the immersion space LS can be formed on the gap Gm. In other words, the immersion space LS can be formed to extend over the upper surface T4a and the upper surface GTa.

Moreover, when the substrate stage 200G is moved within the XY plane in a state where the immersion space LS is formed between the terminating optical element 12 and the liquid immersion member 7, and the substrate stage 200G, the immersion space LS can be moved from the upper surface T4a of the cover member T4 to the upper surface GTa of the scaling member GT and can be moved from the upper surface GTa of the scaling member GT to the upper surface T4a of the cover member T4. That is, the immersion space LS can be moved from one of the upper surface T4a and the upper surface GTa to the other upper surface. In other words, in the present embodiment, the cover member T4 and the scaling member GT can be moved together in a state where the gap Gm is maintained so that the immersion space LS is moved from one of the upper surface T4a and the upper surface GTa to the other upper surface. Moreover, the immersion space LS can pass above the gap Gm when the immersion space LS moves from one of the upper surface T4a and the upper surface GTa to the other upper surface. In addition, in the present embodiment, the immersion space LS passes above the gap Gm that is formed on the +Y-axis side of the cover member T4.

Moreover, as shown in FIG. 34, the measuring stage 3 includes a measuring member C in which the immersion space LS can be formed and a cover member Q which is provided to be adjacent to the measuring member C and in which the immersion space LS can be formed. The measuring member C functions as a measuring member that measures the exposure light EL, for example. The measuring stage 3 includes a third holding portion 33 that holds and can release the lower surface of the measuring member C and a fourth holding portion 34 that is disposed in at least a part of the position around the third holding portion 33 so as to hold and release the lower surface of the cover member Q.

In the present embodiment, the cover member Q is disposed in at least a part of the position around the measuring member C that is held on the third holding portion 33. In the present embodiment, the cover member Q includes an aperture. The measuring member C is disposed in the aperture of the cover member Q.

The measuring member C includes an upper surface Ca in which the immersion space LS of the liquid LQ can be formed between the emission surface 13 and the lower surface 14. The cover member Q includes an upper surface Qa in which the immersion space LS of the liquid LQ can be formed between the emission surface 13 of the terminating optical element 12 and the lower surface 14 of the liquid immersion member 7.

In the present embodiment, a gap Gn is formed between the measuring member C and the cover member Q. The upper surface Ca is disposed with the upper surface Qa and the gap Gn interposed.

The measuring member C and the cover member Q are held on the measuring stage 3. When the measuring stage 3 is moved, the measuring member C and the cover member Q held on the measuring stage 3 are also moved together with the measuring stage 3. That is, with the movement of the measuring stage 3, the measuring member C and the cover member Q can be moved to the exposure position EP. The measuring member C held on the third holding portion 33 and the cover member Q held on the fourth holding portion 34 can be moved together in a state where the gap Gn is maintained.

In the present embodiment, at least a part of the immersion space LS can be formed between the emission surface 13 and the lower surface 14, and the upper surface Ca of the measuring member C. Moreover, at least a part of the immersion space LS can be formed between the emission surface 13 and the lower surface 14, and the upper surface Qa of the cover member Q. Moreover, at least a part of the immersion space LS can be formed on the gap Gn. In other words, the immersion space LS can be formed to extend over the upper surface Ca and the upper surface Qa.

Moreover, when the measuring stage 3 is moved within the XY plane in a state where the immersion space LS is formed between the terminating optical element 12 and the liquid immersion member 7, and the measuring stage 3, the immersion space LS can be moved from the upper surface Ca of the measuring member C to the upper surface Qa of the cover member Q and can be moved from the upper surface Qa of the cover member Q to the upper surface Ca of the measuring member C. That is, the immersion space LS can be moved from one of the upper surface Ca and the upper surface Qa to the other upper surface. In other words, in the present embodiment, the measuring member C and the cover member Q can be moved together in a state where the gap Gn is maintained so that the immersion space LS is moved from one of the upper surface Ca and the upper surface Qa to the other upper surface. Moreover, the immersion space LS can pass above the gap Gn when the immersion space LS moves from one of the upper surface Ca and the upper surface Qa to the other upper surface.

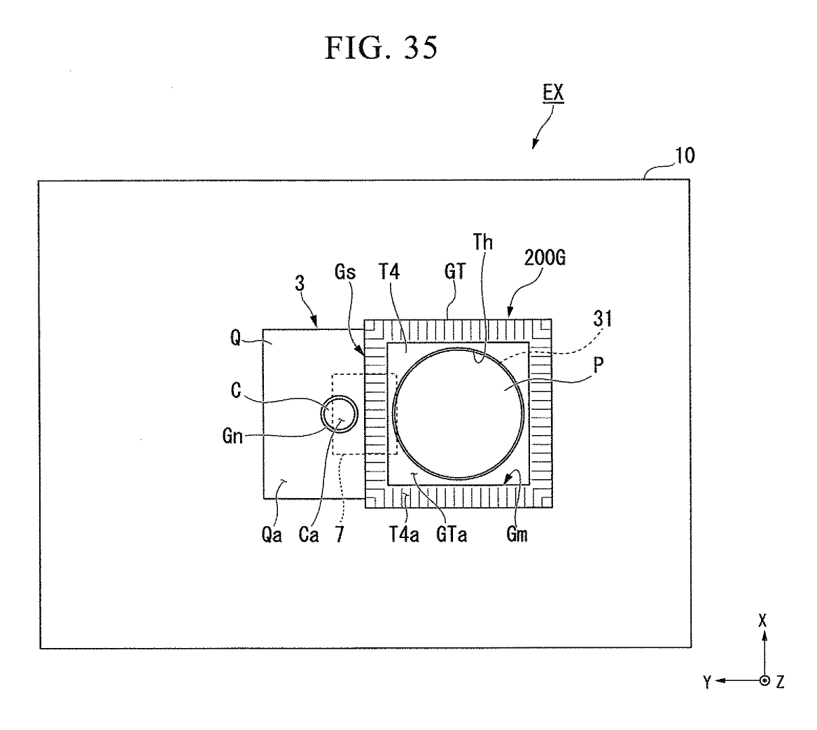

FIG. 35 is a diagram illustrating an example of the operation of the exposure apparatus EX. In the present embodiment, as disclosed in US Patent Application Publication Nos. 2006/0023186 and 2007/0127006 and the like, the controller 8 moves the substrate stage 200G and the measuring stage 3 within the XY plane with respect to the terminating optical element 12 and the liquid immersion member 7 while allowing the terminating optical element 12 and the liquid immersion member 7 to face at least one of the substrate stage 2000 and the measuring stage 3 in a state where the upper surface (the upper surface GTa of the scaling member GT) of the substrate stage 200G and the upper surface (the upper surface Qa of the cover member Q) of the measuring stage 3 are close to each other or in contact with each other so that the immersion space LS of the liquid LQ is continuously formed between the terminating optical element 12 and the liquid immersion member 7, and at least one of the substrate stage 200G and the measuring stage 3. In this way, the leakage of the liquid LQ is suppressed, and a state where the immersion space LS is formed between the terminating optical element 12 and the liquid immersion member 7, and the measuring stage 3 is changed to a state where the immersion space LS is formed between the terminating optical element 12 and the liquid immersion member 7, and the substrate stage 200G. Moreover, the controller 8 may change the state where the immersion space LS is formed between the terminating optical element 12 and the liquid immersion member 7, and the substrate stage 200G to the state where the immersion space LS is formed between the terminating optical element 12 and the liquid immersion member 7, and the measuring stage 3.

In the following description, an operation of allowing the substrate stage 200G and the measuring stage 3 to move synchronously within the XY plane with respect to the terminating optical element 12 and the liquid immersion member 7 in a state where the upper surface of the substrate stage 200G and the upper surface of the measuring stage 3 are close to each other or in contact with each other will be referred to as a scrum movement operation.

During the scrum movement operation, a gap Gs is formed between the upper surface (the upper surface GTa of the scaling member GT) of the substrate stage 200G and the upper surface (the upper surface Qa of the cover member Q) of the measuring stage 3. During the scrum movement operation, the substrate stage 200G and the measuring stage 3 move together. In the present embodiment, during the scrum movement operation, the substrate stage 200G and the measuring stage 3 can be moved together in a state where the gap Gs is maintained.

At least a part of the immersion space LS can be formed on the gap Gs. In other words, the immersion space LS can be formed to extend over the upper surface GTa and the upper surface Qa.

During the scrum movement operation, the immersion space LS can be moved from the upper surface GTa of the scaling member GT to the upper surface Qa of the cover member Q and can be moved from the upper surface Qa of the cover member Q to the upper surface GTa of the scaling member GT. That is, the immersion space LS can be moved from one of the upper surface GTa and the upper surface Qa to the other upper surface. In other words, in the present embodiment, the substrate stage 200G and the measuring stage 3 can be moved together in a state where the gap Gs is maintained so that the immersion space LS is moved from one of the upper surface GTa and the upper surface Qa to the other upper surface. Moreover, the immersion space LS can pass above the gap Gs when the immersion space LS moves from one of the upper surface GTa and the upper surface Qa to the other upper surface.

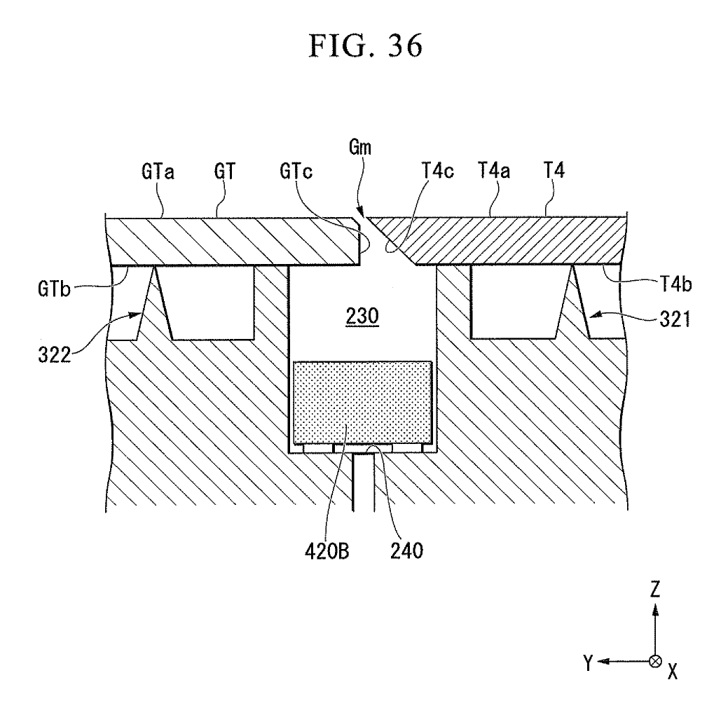

FIG. 36 is a side cross-sectional view illustrating the vicinity of the gap Gm between the scaling member GT and the cover member T4. As shown in FIG. 36, in the present embodiment, the cover member T4 includes a side surface T4c that faces the scaling member GT. The scaling member GT includes a side surface GTc that faces the cover member T4.

In the present embodiment, the side surface T4c of the cover member T4 is inclined upward in an outward direction with respect to the center of the cover member T4. That is, the side surface T4c is an inclined surface that extends upward from the lower surface T4b toward the scaling member GT. The side surface T4c has an inclination that rises toward the scaling member GT. In the present embodiment, the upper surface T4a of the cover member T4 is substantially parallel to the XY plane. The side surface T4c is inclined with respect to the XY plane. The angle between the upper surface T4a and the side surface T4c is an acute angle. The angle between the upper surface T4a and the side surface T4c may be equal to or smaller than 45°, 30°, or 20°, for example. As an example, the angle between the upper surface T4a and the side surface T4c may be equal to or smaller than approximately 85°, 80°, 75°, 70°, 65°, 60°, 55°, 50°, 45°, 40°, 35°, 30°, 25°, 20°, 15°, 10°, or 5°.

In the present embodiment, the side surface GTc of the scaling member GT is substantially parallel to the Z axis. In the present embodiment, the upper surface GTa of the scaling member GT is substantially parallel to the XY plane. The angle between the upper surface GTa and the side surface GTc is substantially a right angle.

Since the side surface T4c is inclined, the gap Gm expands gradually from the upper surface side of the cover member T4 and the scaling member GT toward the lower surface side thereof.

In the present embodiment, the contact angles of the side surfaces T4c and GTc with respect to the liquid LQ are smaller than the contact angle of the side surface Pc of the substrate P. In the present embodiment, the side surfaces T4c and GTc are lyophilic with respect to the liquid LQ. The contact angles of the side surfaces T4c and GTc with respect to the liquid LQ are smaller than 90°, for example. The contact angles of the side surfaces T4c and GTc with respect to the liquid LQ may be smaller than 80°, 70°, 60°, 50°, 40°, 30°, or 20°. As an example, the contact angles of the side surfaces T4c and GTc with respect to the liquid LQ may be equal to or smaller than approximately 85°, 80°, 75°, 70°, 65°, 60°, 55°, 50°, 45°, 40°, 35°, 30°, 25°, 20°, 15°, 10°, or 5°.

In addition, the contact angles of the side surfaces T4c and GTc with respect to the liquid LQ may be larger than the contact angle of the side surface Pc of the substrate P. For example, the side surfaces T4c and GTc may be lyophilic with respect to the liquid LQ. For example, the contact angles of the side surfaces T4c and GTc with respect to the liquid LQ may be equal to or larger than 90°, 100°, or 110°. As an example, the contact angles of the side surfaces T4c and GTc with respect to the liquid LQ may be equal to or larger than approximately, 90°, 95°, 100°, 105°, 110°, or 115°.

The substrate stage 200G includes a space portion 230 that is in communication with the gap Gm and a suction port 240 that suctions the fluid of the space portion 230. For example, the liquid LQ of the immersion space LS that flowed into the space portion 230 through the gap Gm is suctioned from the suction port 240.

Moreover, in the present embodiment, the substrate stage 200G includes a porous member 420B that is disposed in the space portion 230. The suction port 240 can suction the fluid (the liquid LQ or/and the gas) in the space portion 230 through the holes of the porous member 420B.

In addition, for example, like the example illustrated in FIG. 24 or the like, the upper surface of the porous member 420B disposed in the space portion 230 may approach the lower surface of the cover member T4 and the lower surface of the scaling member GT.

The porous member 420B may be not provided.

As described with reference to FIG. 24 and FIG. 25, for example, in the present embodiment, the liquid LQ of the immersion space LS formed between the terminating optical element 12 and at least one of the upper surface T4a of the cover member T and the upper surface GTa of the scaling member GT can be flowed into the space portion 230 through the gap Gm. The controller 8 can recover the liquid LQ of the space portion 230 by executing the suction operation of the suction port 240.

In the present embodiment, although the side surface T4c of the cover member T4 that faces the scaling member GT is inclined upward in an outward direction (toward the scaling member GT) with respect to the center of the cover member T4, the side surface GTc of the scaling member GT that faces the cover member T4, for example, may be inclined upward in an outward direction with respect to the center of the scaling member GT. That is, the side surface GTc is an inclined surface that extends upward from the lower surface G4b toward a cover member 4T. In this case, the side surface T4c may be inclined as in FIG. 36 and may be not inclined.

Moreover, only a part of the side surface T4c of the cover member T4 that faces the scaling member GT may be inclined as in FIG. 36.

In addition, in the present embodiment, at least one of the structures described with reference to FIG. 3, FIG. 7 to FIG. 16, and FIG. 24 to FIG. 32 can be appropriately applied to the structure around the gap Ga that is formed between the cover member 4T and the substrate P.

Moreover, the shape of an edge portion of the cover member 4T that forms the gap Ga may be different from the shape of an edge portion of the cover member 4T that forms the gap Gm.

Moreover, the size of the gap Ga may be different from or the same as the size of the gap Gm.

Moreover, the side surface of the cover member Q that faces the measuring member C may be inclined upward in an outward direction with respect to the center of the cover member Q. That is, the side surface of the cover member Q may be inclined upward from the lower surface of the cover member Q toward the measuring member C. Moreover, the side surface of the measuring member C that faces the cover member Q may be inclined upward in an outward direction with respect to the center of the measuring member C. That is, the side surface of the measuring member C may be inclined upward from the lower surface of the measuring member C toward the cover member Q. In this case, the side surface of the cover member Q may be inclined upward as described above and may be not inclined.

Moreover, during the scrum movement operation, the side surface (the side surface of the scaling member GT) of the substrate stage 200G that faces the measuring stage 3 may be inclined upward in an outward direction with respect to the center of the substrate stage 200G (the scaling member GT). That is, the side surface of the substrate stage 200G may be inclined upward toward the measuring stage 3. Moreover, the side surface (the side surface of the cover member Q) of the measuring stage 3 that faces the substrate stage 200G may be inclined upward in an outward direction with respect to the center of the measuring stage 3 (the cover member Q). That is, the side surface of the measuring stage 3 may be inclined upward toward the substrate stage 200G. In this case, the side surface of the substrate stage 200G may be inclined upward as described above and may be not inclined.

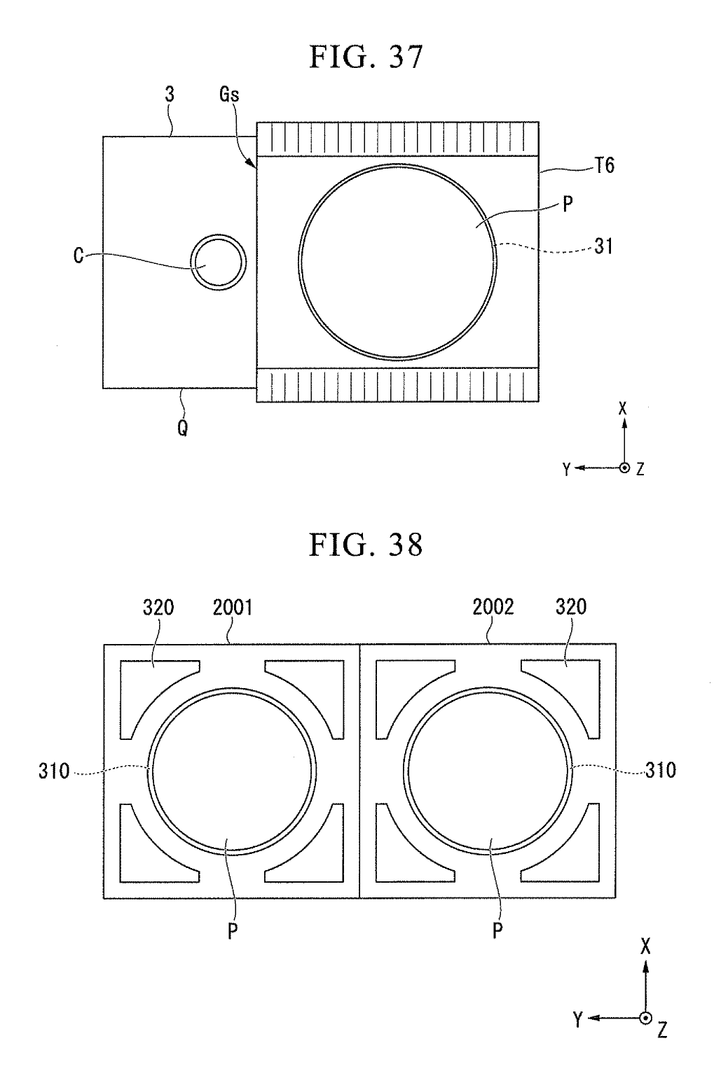

In addition, in the present embodiment, although the scale (grating) of the scaling member GT is disposed so as to surround the substrate P (the cover member T4), the above structure (for example, the structure of FIG. 36) may be not applied to all gaps Gm. For example, the gap between the scaling member GT on the +Y side and the cover member (T4 or the like) may not have the above structure. Moreover, the sizes of all gaps Gm may be not the same. Moreover, in the present embodiment, although the scale (grating) of the scaling member GT is disposed so as to surround the substrate P (the cover member T4), the above structure can be applied to the gap Gm between the scaling member GT and the cover member (T6 or the like) even when the scaling member GT is displayed on the +X side and −X side only, for example, as illustrated in FIG. 37. In this case, the scrum movement operation is performed so that the gap Gs is formed between the linear edge on the −Y side of the cover member Q of the measuring member 3 and the linear edge on the +Y side of the cover member T6 of the substrate stage 200G.

In addition, in the above-described embodiments, although the substrate stage and the measuring stage perform the scrum movement operation, a first substrate stage 2001 and a second substrate stage 2002 may perform the scrum movement operation as illustrated in FIG. 38, for example. In this case, an end portion of at least one member that forms a gap between the first substrate stage 2001 and the second substrate stage 2002 may be inclined similarly to the end portion of the cover member (T4 or the like). Each of the first and second substrate stages 2001 and 2002 includes a holding portion 310 that holds and can release the lower surface of the substrate P. Moreover, each of the first and second substrate stages 2001 and 2002 can be moved to the exposure position EP. In FIG. 38, the side surface of the second substrate stage 2002 that faces the first substrate stage 2001 may be inclined similarly to the above-described embodiments. Moreover, the side surface of the first substrate stage 2001 that faces the second substrate stage 2002 may be inclined similarly to the above-described embodiments. In addition, a technique related to a twin stage type exposure apparatus which includes a plurality of substrate stages is disclosed, for example, in U.S. Pat. Nos. 6,341,007, 6,208,407, and 6,262,796.

Moreover, in the example illustrated in FIG. 38, each of the first and second substrate stages 2001 and 2002 include an optical sensor 320. The optical sensor 320 includes a spatial image sensor, for example. The optical sensor 320 is disposed in an aperture that is formed on the upper surface of each of the first and second substrate stages 2001 and 2002. The first and second substrate stages 2001 and 2002 may hold and can release a cover member. In addition, the first and second substrate stages 2001 and 2002 may not include the holding portion that holds and can release the cover member. A gap is formed between the first substrate stage 2001 and the optical sensor 320 that is disposed in the aperture of the first substrate stage 2001. Moreover, a gap is formed between the second substrate stage 2002 and the optical sensor 320 that is disposed in the aperture of the second substrate stage 2002. The side surface of the optical sensor 320 that faces the inner surface of the aperture of the first substrate stage 2001 may be inclined similarly to the above-described embodiments. The inner surface of the aperture of the first substrate stage 2001 that faces the optical sensor 320 may be inclined similarly to the above-described embodiments.

Hereinafter, modification examples of a first member M1 and a second member M2 will be described. The first member M1 and the second member M2 may be the cover member T4 and the scaling member GT; the measuring stage 3 and the measuring member C; the substrate stage and the measuring stage during the scrum movement operation; the first substrate stage and the second substrate stage during the scrum movement operation; and the substrate stage 2001 (2002) and the optical sensor 320. Moreover, the first member M1 and the second member M2 may be the substrate P held on the first holding portion 31 and a part (for example, the cover member T) of the substrate stage 2 that is disposed in the vicinity of the substrate P.

Moreover, in the above-described embodiments, although the cover member (the scaling member) has a scale (grating), the cover member may not have a scale (grating), as disclosed in US Patent Application Publication Nos. 2007/0177125 and 2008/0049209, for example. Moreover, the cover member may have a plate-like shape and a block-like shape. Moreover, in the above-described embodiments, although the substrate stage releasably holds the cover member, the cover member and the substrate stage may be integrated. Moreover, in the above-described embodiments, although the measuring stage holds and can release the cover member, the cover member and the measuring stage may be integrated.

Moreover, during the scrum movement operation, in a state where a bridge member is disposed between two stages, the immersion space LS may be moved from the upper surface of one stage to the upper surface of the other stage. In this case, the first member M1 and the second member M2 are the stage and the bridge member.

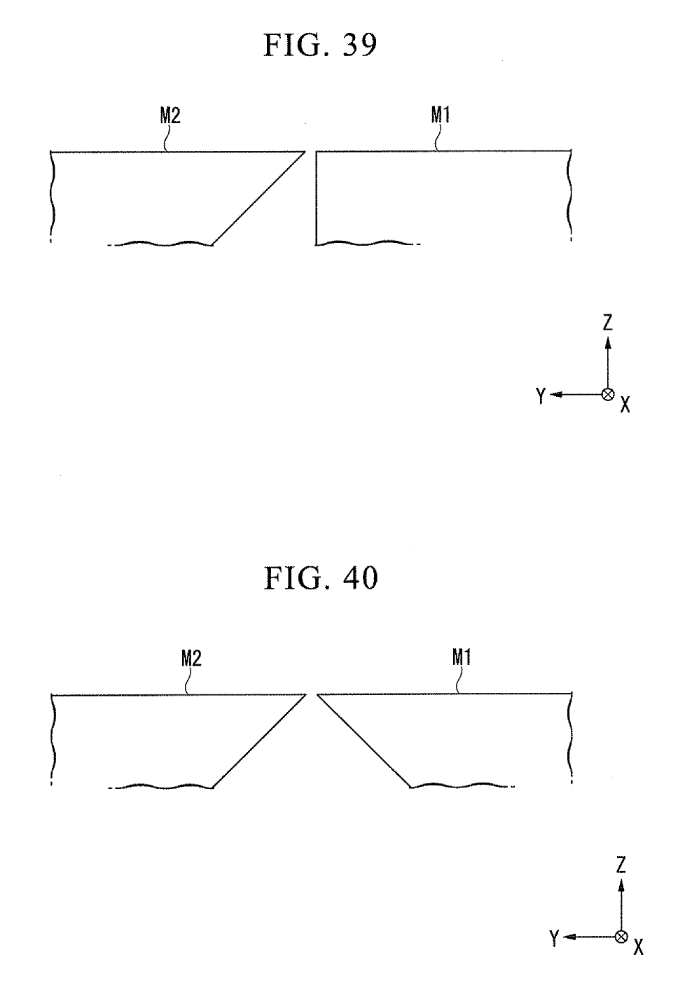

As illustrated in FIG. 39, the side surface of the second member M2 that faces the first member M1 may be inclined upward in an outward direction with respect to the center of the second member M2. That is, the side surface of the second member M2 may be inclined upward toward the first member M1. In FIG. 39, the side surface of the first member M1 that faces the second member M2 is substantially parallel to the Z axis.

As illustrated in FIG. 40, the side surface of the second member M2 that faces the first member M1 may be inclined upward in an outward direction with respect to the center of the second member M2, and the side surface of the first member M1 that faces the second member M2 may be inclined upward in an outward direction with respect to the center of the first member M1. In other words, the side surface of the second member M2 that faces the first member M1 may be inclined downward in an outward direction with respect to the center of the first member, and the side surface of the first member M1 that faces the second member M2 may be inclined upward in an outward direction with respect to the center of the first member M1. That is, the side surface of the first member M1 may be inclined upward toward the second member M2, and the side surface of the second member M2 may be inclined upward toward the first member M1.

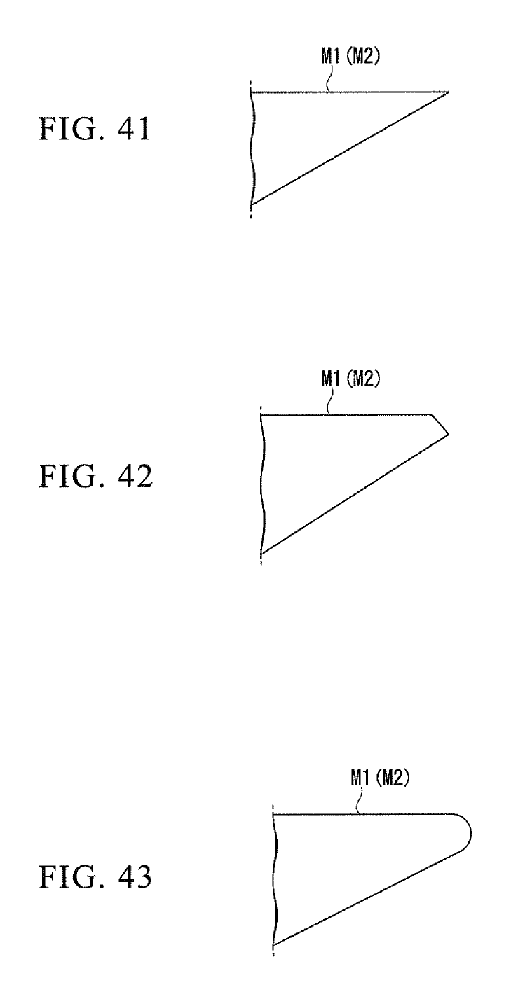

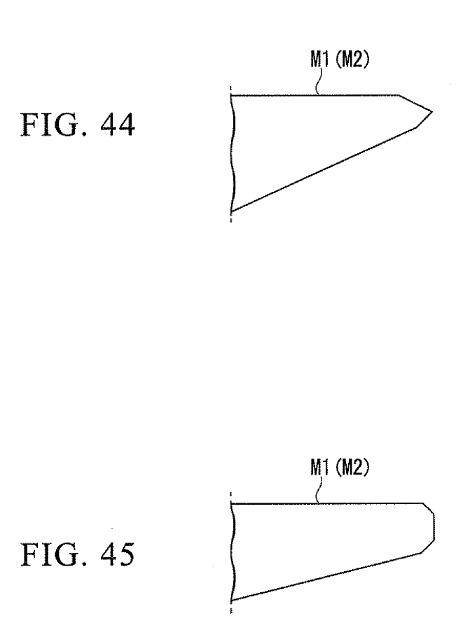

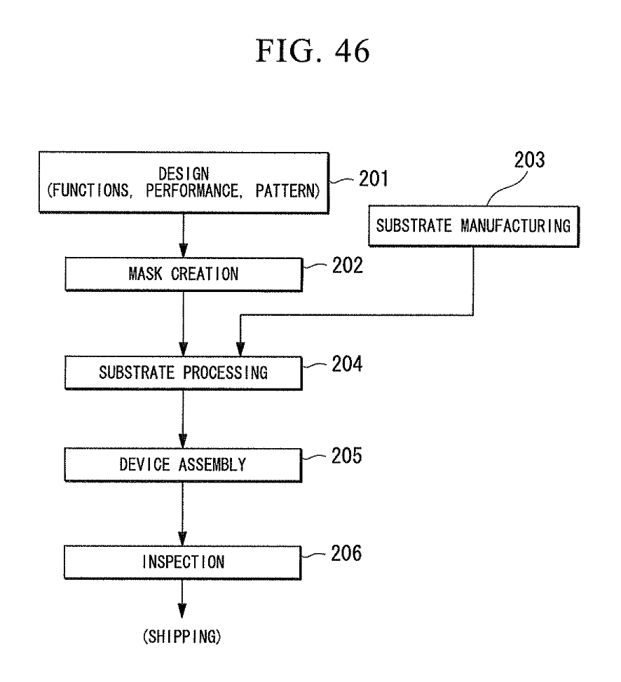

In addition, the angle between the upper surface and the side surface of at least one of the first member M1 and the second member M2 may be an acute angle as illustrated in FIG. 41, for example. The angle between the upper surface and the side surface may be between 10° and 60°, for example. For example, the angle between the upper surface and the side surface may be equal to or smaller than 45°, 30°, or 20°. In addition, a tip end of the corner formed by the upper surface and the side surface may be sharp as illustrated in FIG. 41. As illustrated in FIG. 42, the tip end may include a chamfered portion. When the tip end as illustrated in FIG. 42 is formed, a chamfering size may be selected between C0.01 mm and C0.1 mm, for example. As illustrated in FIG. 43, the tip end may include a curved surface. When the tip end as illustrated in FIG. 43 is formed, the chamfering size may be selected between R0.01 mm and R0.5 mm. As illustrated in FIG. 44, the tip end may include two chamfered portions. In addition, as illustrated in FIG. 45, the tip end may include three chamfered portions.

In addition, a liquid contacting surface (the upper surface or/and the side surface) of at least one of the first member M1 and the second member M2 may be liquid-repellent. For example, the contact angle of the liquid contacting surface with respect to the liquid LQ is equal to or larger than 90°. The contact angle of the liquid contacting surface with respect to the liquid LQ may be equal to or larger than 90°, 100°, or 110°, As an example, the contact angle of the liquid contacting surface with respect to the liquid LQ may be equal to or larger than approximately 90°, 95°, 100°, 105°, 110°, or 115°.

Alternatively, in the above-described embodiment, a suction port, which suctions fluid in a space portion that is in communication with a gap between the first member M1 and the second member M2, can be provided. For example, a suction port, which suctions fluid in a space portion that is in communication with the gap Gn between the measuring member C and the cover member Q. Furthermore, a suction port, which suctions fluid in a space portion that is in communication with the gap Gs between two stages in the scrum movement operation. Furthermore, a suction port, which suctions fluid in a space portion that is in communication with a gap between a substrate stage and an optical sensor. Also in the cases, fluid in a space portion can be suctioned via a porous member. Alternatively, a porous member can be removed from a space portion.

Furthermore, it is, of course, possible to use by combining at least one of the embodiments explained with FIGS. 1-32 and at least one of the embodiments explained with FIGS. 33-35, according to need.

As described above, the control apparatus 8 includes a computer system including a CPU and the like.

Moreover, the control apparatus 8 includes an interface that can execute communication between the computer system and an external apparatus. The storage device 8R includes a memory such as a RAM and a recording medium such as a hard disk or a CD-ROM, for example. An operating system (OS) for controlling a computer system is installed in the storage device 8R, and a program for controlling the exposure apparatus EX is stored in the storage device 8R.

In addition, an input device capable of inputting an input signal may be connected to the control apparatus 8. The input device includes an input apparatus such as a keyboard or a mouse, a communication apparatus capable of inputting data from an external apparatus, or the like. Moreover, a display device such as a liquid crystal display may be provided.

Various items regarding information including the programs recorded in the storage device 8R can be read by the control apparatus (computer system) 8. A program for causing the control apparatus 8 to execute control of the exposure apparatus EX exposing the substrate P with exposure light EL via the liquid LQ is recorded in the storage device 8R.

The program recorded in the storage device 8R may cause the control apparatus 8 to: execute the exposure of the substrate P in accordance with the embodiments described above while moving the substrate stage 2 in a state where the immersion space LS is formed with the liquid LQ between the terminating optical element 12 having the emission surface 13 from which exposure light EL is emitted and at least one of the upper surface 2U of the substrate stage 2 and the upper surface of the substrate, the substrate stage 2 including the first holding portion 31 that releasably holds the lower surface Pb of the substrate P, the upper surface 2U that defines the aperture Th in which the substrate P can be disposed and that is disposed around the upper surface Pa of the substrate P in a state where the substrate P is held on the first holding portion 31, and the space portion 23 that is in communication with the gap Ga between the upper surface of the substrate P and the upper surface 2U; suction fluid in the space portion 23 from the suction port 24 with a suction force in at least a part of the first period in which the exposure of the substrate P is executed; and suction fluid in the space portion 23 from the suction port 24 with a second suction force larger than the first suction force in the second period in which the exposure of the substrate P is not executed.

Moreover, the program recorded in the storage device 8R may cause the control apparatus 8 to: execute the exposure of the substrate P in accordance with the embodiments described above in a state where the immersion space LS is formed with the liquid LQ between the terminating optical element 12 having the emission surface 13 from which exposure light EL is emitted and the substrate P held on the first holding portion 31 of the substrate stage 2; adjust the environment of the space 102A by supplying gas from the gas supply portion 105S of the conditioning system 105 to the space 102A, in which the terminating optical element 12 and the substrate stage 2 are disposed, in at least a part of the first period in which the exposure of the substrate P is executed; and execute a process of suppressing at least a part of the gas from the gas supply portion 1055 from being supplied to the substrate stage 2 in at least a part of the second period in which the exposure of the substrate P is not executed.

Moreover, the program recorded in the storage device 8R may cause the control apparatus 8 to: execute the exposure of the substrate P in accordance with the embodiments described above in a state where the immersion space LS is formed with the liquid LQ between the terminating optical element 12 having the emission surface 13 from which exposure light EL is emitted and at least one of the upper surface U1 of the substrate stage 2 and the upper surface of the substrate P, the substrate stage 2 including the first holding portion 31 that releasably holds the lower surface Pb of the substrate P, the upper surface U1 that defines the aperture Th in which the substrate P can be disposed and that is disposed around the upper surface Pa of the substrate P in a state where the substrate P is held on the first holding portion 31, the inner surface U2 which the side surface of the substrate P faces and of which the contact angle with respect to the liquid LQ is smaller than that of the side surface of the substrate P, and the space portion 23 that is in communication with the gap Ga between the upper surface of the substrate P and the upper surface U1; suction fluid in the space portion 23 from the suction port 24 in at least a part of the first period in which the exposure of the substrate P is executed; and suction fluid from the suction port 24 in a state where an object such as the dummy substrate DP1 is held on the first holding portion 31 in at least a part of the second period in which the exposure of the substrate P is not executed.

Moreover, the program recorded in the storage device 8R may cause the control apparatus 8 to: execute the exposure of the substrate P in accordance with the embodiments described above in a state where the immersion space LS is formed with the liquid LQ between the terminating optical element 12 having the emission surface 13 from which exposure light EL is emitted and at least one of the upper surface 2U of the substrate stage 2 and the upper surface Pa of the substrate P, the substrate stage 2 including the first holding portion 31 that releasably holds the lower surface Pb of the substrate P, the upper surface U2 that defines the aperture Th in which the substrate P can be disposed and that is disposed around the upper surface Pa of the substrate P in a state where the substrate P is held on the first holding portion 31, the inner surface Tc which the side surface Pc of the substrate P faces, and the space portion 23 that is in communication with the gap Ga between the upper surface Pa of the substrate P and the upper surface 2U; suction fluid in the space portion 23 from the suction port 24 in at least a part of the first period in which the exposure of the substrate P is executed; and suction fluid in the space portion 23 from the suction port 24 in a state where the immersion space LS is formed with the liquid LQ between the terminating optical element 12 and the upper surface 2U and the dummy substrate held on the first holding portion 31 in at least a part of the second period in which the exposure of the substrate P is not executed.

Moreover, the program recorded in the storage device 8R may cause the control apparatus 8 to: expose the substrate P in accordance with the embodiments described above in a state where the immersion space LS is formed with the liquid LQ between the terminating optical element 12 having the emission surface 13 from which exposure light EL is emitted and at least one of the upper surface Pa of the substrate P held on the first holding portion 31 that releasably holds the lower surface Pb of the substrate P and the upper surface Ta2 that defines the aperture Th2 in which the substrate P can be disposed and is disposed around the upper surface Pa of the substrate P in a state where the substrate P is held on the first holding portion 31; and recovering, through the holes of the porous member 42B, at least a part of the liquid LQ of the immersion space LS flowing through the gap G2 between the upper surface Pa of the substrate P and the upper surface Ta2, between the upper surface 42Ba of the porous member 42B disposed in the space portion 23 that is in communication with the gap G2 and the inclined surface Tc2 in which at least a part thereof faces the upper surface 42Ba of the porous member 42B and which is inclined downward in an outward direction with respect to the center of the aperture Th2.

Moreover, the program recorded in the storage device 8R may cause the control apparatus 8 to: expose the substrate P in accordance with the embodiments described above in a state where the immersion space LS is formed with the liquid LQ between the terminating optical element 12 having the emission surface 13 from which exposure light EL is emitted and at least one of the upper surface Pa of the substrate P held on the first holding portion 31 that releasably holds the lower surface Pb of the substrate P, the upper surface Ta3 that defines the aperture Th3 in which the substrate P can be disposed and is disposed around the upper surface Pa of the substrate P in a state where the substrate P is held on the first holding portion 31, and the inclined surface Tc3 in which at least a part thereof faces the side surface Pc of the substrate P and which is inclined upward in an outward direction with respect to the center of the aperture Th3; and recovering, through the holes 42Ba of the porous member 42B, at least a part of the liquid LQ of the immersion space LS flowing through the gap G3 between the upper surface Pa of the substrate P and the upper surface Ta3, between the upper surface 42Ba of the porous member 42B disposed in the space portion 23 that is in communication with the gap G3 and the lower surface Tb3 which faces the opposite direction of the upper surface Ta3, and in which at least a part thereof faces the upper surface 42Ba of the porous member 42B.

Moreover, the program recorded in the storage device 8R may cause the controller 8 to: expose a substrate in accordance with the embodiments described above in a state where an immersion space is formed via a liquid between an optical member that includes an emission surface from which an exposure light is emitted and an upper surface of the substrate that is held on a first holding portion that holds and can release a lower surface of the substrate; and form the immersion space between the emission surface and at least one of a first upper surface of a first member that is movable to an irradiation position such that the first member is irradiated with the exposure light from the emission surface and a second upper surface of a second member that is disposed with a gap interposed between the first upper surface and the second upper surface and is movable to the irradiation position together with the first member. In this case, at least one of a first side surface of the first member that faces the second member and a second side surface of the second member that faces the first member is inclined upward in an outward direction with respect to the center of the first member.

Moreover, the program recorded in the storage device 8R may cause the controller 8 to: expose a substrate in accordance with the embodiments described above in a state where an immersion space is formed with a liquid between an optical member that includes an emission surface from which an exposure light is emitted and an upper surface of the substrate that is held on a first holding portion that holds and can release a lower surface of the substrate; and form the immersion space between the emission surface and at least one of a first upper surface of a first member that is movable to an irradiation position such that the first member is irradiated with the exposure light from the emission surface and a second upper surface of a second member that is disposed with the first upper surface interposed and is movable to the irradiation position together with the first member. In this case, at least one of a first side surface of the first member that faces the second member and a second side surface of the second member that faces the first member is inclined downward in an outward direction with respect to the center of the first member.

The program stored in the storage device 8R is read by the control apparatus 8, and thereby the various processes, such as the immersion exposure of the substrate P in the state wherein the first immersion space LS is formed, are executed in cooperation with the various apparatuses of the exposure apparatus EX, such the substrate stage 2, the liquid immersion member 7, the driving system 5, fluid suction device 26, and the like.

In addition, in the respective embodiments described above, although the optical path K on the emission side (the image plane side) of the terminating optical element 12 of the projection optical system PL is filled with the liquid LQ, a projection optical system may be employed in which the optical path on the incident side (object plane side) of the terminating optical element 12 is also filled with the liquid LQ, as disclosed in, for example, PCT International Publication No. 2004/019128.

In addition, in the respective embodiments described above, although water is used as the liquid LQ for exposure, a liquid other than water may be used. As the liquid LQ, a liquid which is transmissive with respect to exposure light EL, which has a high refractive index with respect to exposure light EL, and which is stable with respect to a film of a photosensitive material (photoresist) that forms the surface of the projection optical system PL or the substrate P is preferred. For example, hydro-fluoro-ether (HFE), perfluorinated polyether (PFPE), Fomblin oil, or the like can be used as the liquid LQ. Moreover, various fluids, for example, a supercritical fluid, can be used as the liquid LQ.

In addition, the substrate P of the respective embodiments described above is not limited to a semiconductor wafer for manufacturing semiconductor devices, but can also be applied to, for example, a glass substrate for display devices, a ceramic wafer for thin film magnetic heads, or the original plate (synthetic quartz or a silicon wafer) of a mask or a reticle used by an exposure apparatus.

The exposure apparatus EX can also be applied to a step-and-scan-type scanning exposure apparatus (a scanning stepper) that scans and exposes the pattern of the mask M by synchronously moving the mask M and the substrate P, as well as to a step-and-repeat-type projection exposure apparatus (a stepper) that successively steps the substrate P and performs a full-field exposure of the pattern of the mask M with the mask M and the substrate P in a stationary state.

Furthermore, when performing step-and-repeat-type exposure, after a reduced image of a first pattern is transferred onto the substrate P using a projection optical system in a state where the first pattern and the substrate P are substantially stationary, a reduced image of a second pattern may be exposed in a batch on the substrate P so as to partially overlap with the first pattern using the projection optical system in a state where the second pattern and the substrate P are substantially stationary (as in a stitch-type full-field exposure apparatus). Moreover, as the stitch-type exposure apparatus, the present invention can be applied to a step-and-stitch-type exposure apparatus in which at least two patterns are transferred onto the substrate P so as to partially overlap with each other, and the substrate P is sequentially moved.

Moreover, the present invention can also be applied to, for example, an exposure apparatus that combines on a substrate the patterns of two masks through a projection optical system and double exposes, substantially simultaneously, a single shot region on the substrate using a single scanning exposure, as disclosed in, for example, the specification of U.S. Pat. No. 6,611,316. Moreover, the present invention can also be applied to, for example, a proximity-type exposure apparatus and a mirror projection aligner.

Moreover, the present invention can also be applied to a twin stage-type exposure apparatus, which includes a plurality of substrate stages, as disclosed in, for example, in the specifications of U.S. Pat. Nos. 6,341,007, 6,208,407, and 6,262,796.

Moreover, the present invention can also be applied to an exposure apparatus that includes a plurality of substrate stages and measurement stages.

The-types of exposure apparatuses EX are not limited to a semiconductor device manufacturing exposure apparatus that exposes the substrate P with the pattern of a semiconductor device, but can also be widely applied to exposure apparatuses used to fabricate, for example, liquid crystal devices or displays, and to exposure apparatuses used to fabricate thin film magnetic heads, image capturing devices (CCDs), micromachines, MEMS devices, DNA chips, or reticles and masks.

In addition, in the embodiments described above, although an optically transmissive mask is used in which a prescribed shielding pattern (or phase pattern or dimming pattern) is formed on an optically transmissive substrate, instead of such a mask, a variable form mask (also called an electronic mask, an active mask, or an image generator), in which a transmissive pattern, a reflective pattern, or a light emitting pattern is formed based on electronic data of the pattern to be exposed, may be used as disclosed in, for example, the specification of U.S. Pat. No. 6,778,257. Moreover, instead of a variable form mask that includes a non-emissive-type image display device, a pattern forming apparatus that includes a self-luminous-type image display device may be provided.

In the respective embodiments described above, an exposure apparatus furnished with a projection optical system PL was described as an example, however the present invention can also be applied to an exposure apparatus and an exposure method which does not use a projection optical system PL. For example, the immersion space may be formed between an optical member such as a lens and the substrate, and the substrate may be irradiated with exposure light via the optical member.

Moreover, the present invention can also be applied to an exposure apparatus (lithography system) which exposes a run-and-space pattern on a substrate P by forming interference fringes on the substrate P, as disclosed for example in PCT International Patent Publication No. 2001/035168.

As described above, the exposure apparatus EX of the embodiments of this application is manufactured by assembling various subsystems, including the respective constituent elements, so that the prescribed mechanical precision, electrical precision and optical precision can be maintained. To ensure these respective precisions, performed before and after this assembly are adjustments for achieving optical precision with respect to the various optical systems, adjustments for achieving mechanical precision with respect to the various mechanical systems, and adjustments for achieving electrical precision with respect to the various electrical systems. The process of assembly from the various subsystems to the exposure apparatus includes mechanical connections, electrical circuit wiring connections, gas pressure circuit piping connections, and the like among the various subsystems. Obviously, before the process of assembly from these various subsystems to the exposure apparatus, there are the processes of individual assembly of the respective subsystems. When the process of assembly to the exposure apparatuses of the various subsystems has ended, overall assembly is performed, and the various precisions are ensured for the exposure apparatus as a whole. Note that it is preferable that the manufacture of the exposure apparatus be performed in a clean room in which the temperature, the degree of cleanness, and the like are controlled.

As shown in FIG. 33, a micro-device, such as a semiconductor device, is manufactured through: a step 201 of designing the functions and performance of the micro-device; a step 202 of creating the mask (reticle) based on this designing step; a step 203 of manufacturing the substrate which is the base of the device; a substrate-processing step 204 that includes exposing the substrate with exposure light from the pattern of the mask and developing the exposed substrate in accordance with the embodiments described above; a device assembly step 205 (which includes fabrication processes such as a dicing process, a bonding process, and a packaging process); an inspection step 206; and the like. The substrate-processing step includes the first and second periods described above.

Furthermore, the features of the respective embodiments described above can be appropriately combined with each other. In addition, there may be cases where some of the constituent elements are not used. In addition, as far as is permitted by law, the disclosures in all of the Japanese Patent Publications and US Patents related to exposure apparatuses and the like cited in the above respective embodiments and modified examples, are incorporated herein by reference.

1. An exposure apparatus that exposes a substrate with exposure light via a liquid, comprising:
an optical member having an emission surface from which exposure light is emitted;
a substrate holding apparatus including a first holding portion that releasably holds a lower surface of the substrate, a first surface that defines an aperture in which the substrate can be disposed and that is disposed around an upper surface of the substrate in a state where the substrate is held on the first holding portion, and a first space portion that is in communication with a gap between the upper surface of the substrate and the first surface;
a drive apparatus that moves the substrate holding apparatus in a state where an immersion space is formed with the liquid between the optical member and at least one of the upper surface of the substrate and the first surface;
a suction port through which fluid in the first space portion is suctioned; and
a control apparatus that sets a suction force of the suction port in at least a part of a first period in which exposure of the substrate is executed so as to be smaller than a suction force of the suction port in a second period in which exposure of the substrate is not executed.

2. The exposure apparatus according to claim 1, wherein at least a part of the liquid of the immersion space flows into the first space portion through the gap, and
wherein the suction port suctions the liquid flowed into the first space portion.

3. The exposure apparatus according to claim 1, wherein the second period includes a period occurring after irradiation with the exposure light with respect to the substrate ends.

4. The exposure apparatus according to claim 3, wherein a plurality of shot areas of the substrate is sequentially irradiated with the exposure light in the first period, and
wherein the second period includes a period occurring after irradiation with the exposure light with respect to the plurality of shot areas ends.

5. The exposure apparatus according to claim 4, wherein in the first period, the suction port continuously suctions fluid after exposure of the first shot area among the plurality of shot areas starts and until exposure of the last shot area ends.

6. The exposure apparatus according to claim 3, wherein the second period includes a period in which the immersion space is formed between the optical member and at least one of the upper surface of the substrate and the first surface after irradiation with exposure light ends.

7. The exposure apparatus according to claim 3, wherein the second period includes a period starting when irradiation with exposure light ends and ending when the substrate is unloaded from the first holding portion.

8. The exposure apparatus according to claim 1, wherein the second period includes a period in which the substrate is not held on the first holding portion.

9. The exposure apparatus according to claim 1, wherein the first period includes a period in which the substrate holding apparatus is disposed at a first position where the immersion space can be formed between the optical member and at least one of the upper surface of the substrate and the first surface, and
wherein the second period includes a period in which the substrate holding apparatus is disposed at a second position where the immersion space cannot be formed.

10. The exposure apparatus according to claim 9, wherein the second position includes a substrate replacement position where at least one of an operation of unloading the substrate after exposure from the first holding portion and an operation of loading the substrate before exposure on the first holding portion is executed.

11. The exposure apparatus according to claim 1, wherein the second period includes at least a part of a period starting when the exposure of a first substrate ends and ending when the first substrate is unloaded from the first holding portion, a second substrate before exposure is loaded on the first holding portion, and detection of an alignment mark of the second substrate starts.

12. The exposure apparatus according to claim 1, further comprising a porous member that is disposed in the first space portion,
wherein the suction port includes holes of the porous member.

13. The exposure apparatus according to claim 1, further comprising a thermal insulating material that is disposed on an inner surface that defines the first space portion.

14. The exposure apparatus according to claim 1, further comprising a second holding portion that is disposed around the first holding portion so as to releasably hold a cover member,
wherein the cover member includes the first surface.

15. The exposure apparatus according to claim 14, wherein the first holding portion includes a first circumferential wall portion which the lower surface of the substrate can face,
wherein the second holding portion includes a second circumferential wall portion which the lower surface of the cover member can face, and
wherein the first space portion includes a space between the first circumferential wall portion and the second circumferential wall portion.

16. The exposure apparatus according to claim 1, wherein the first holding portion includes a first circumferential wall portion which the lower surface of the substrate faces, a negative pressure space can be formed in at least a part of a position between the first circumferential wall portion and the lower surface of the substrate, and
wherein the first space portion includes a space around the first circumferential wall portion.

17. The exposure apparatus according to claim 15, wherein the first holding portion includes a third circumferential wall portion which is disposed inside the first circumferential wall portion and which the lower surface of the substrate can face, and
wherein the exposure apparatus further comprises a gas supply port through which gas is supplied to a second space portion between the third circumferential wall portion and the first circumferential wall portion.

18. The exposure apparatus according to claim 17, further comprising a discharge port through which fluid in the second space portion is discharged.

19. The exposure apparatus according to claim 1, further comprising a temperature regulator that adjusts temperature of the substrate holding apparatus.

20. The exposure apparatus according to claim 1, further comprising:
a chamber member that forms a space in which at least the optsical member and the substrate holding apparatus are disposed;
a conditioning system that includes a gas supply portion that supplies gas to the space and that adjusts an environment of the space; and
a suppression mechanism that suppresses at least a part of the gas from the gas supply portion from being supplied to the substrate holding apparatus in at least a part of the second period.

21. An exposure apparatus that exposes a substrate with exposure light via a liquid, comprising:
an optical member having an emission surface from which the exposure light is emitted;
a substrate holding apparatus including a first holding portion that releasably holds the substrate;
a chamber member that forms a space in which at least the optical member and the substrate holding apparatus are disposed;
a conditioning system that includes a gas supply portion that supplies gas to the space and that adjusts an environment of the space; and
a suppression mechanism that suppresses gas from being supplied from the gas supply portion in at least a part of a first period in which the exposure of the substrate is executed and that suppresses at least a part of the gas from the gas supply portion from being supplied to the substrate holding apparatus in at least a part of a second period in which the exposure of the substrate is not executed.

22. The exposure apparatus according to claim 21, wherein the suppression mechanism includes a first shutter member that shuts the gas supply portion in at least a part of the second period.

23. The exposure apparatus according to claim 21, wherein the suppression mechanism includes a second shutter member that shuts at least a part of the substrate holding apparatus in at least a part of the second period.

24. The exposure apparatus according to claim 21, wherein the second period includes a period in which the substrate is not held on the first holding portion.

25. The exposure apparatus according to claim 21, wherein the second period includes a period starting when the substrate after exposure is unloaded from the first holding portion and ending when the substrate before exposure is loaded on the first holding portion.

26. An exposure apparatus that exposes a substrate with exposure light via a liquid, comprising:
an optical member having an emission surface from which the exposure light is emitted;
a substrate holding apparatus including a first holding portion that releasably holds a lower surface of the substrate, a first surface that defines an aperture in which the substrate can be disposed and that is disposed around an upper surface of the substrate in a state where the substrate is held on the first holding portion, a second surface which a side surface of the substrate can face, and a first space portion that is in communication with a gap between the upper surface of the substrate and the first surface; and
a suction port through which fluid in the first space portion is suctioned,
wherein a contact angle of the second surface with respect to the liquid is smaller than a contact angle of the side surface of the substrate.

27. The exposure apparatus according to claim 26, further comprising a second holding portion that is disposed around the first holding portion so as to releasably hold a cover member,
wherein the cover member includes the first surface and the second surface.

28. An exposure apparatus that exposes a substrate with exposure light via a liquid, comprising:
an optical member having an emission surface from which the exposure light is emitted;
a first holding portion that releasably holds a lower surface of the substrate;
a first surface that defines an aperture in which the substrate can be disposed and that is disposed around an upper surface of the substrate in a state where the substrate is held on the first holding portion;
a first space portion that is in communication with a gap between the upper surface of the substrate and the first surface;
a porous member disposed in the first space portion; and
a second surface in which at least a part thereof faces an upper surface of the porous member and which is inclined downward in an outward direction with respect to a center of the aperture,
wherein an immersion space is formed between the optical member and at least one of the upper surface of the substrate and the first surface, and at least a part of liquid of the immersion space, which has been flowed into between the second surface of the first space portion and the upper surface of the porous member through the gap, is recovered via holes of the porous member.

29. The exposure apparatus according to claim 28, wherein at least a part of the second surface faces a side surface of the substrate.

30. The exposure apparatus according to claim 28, further comprising a third surface that faces in a direction opposed to a facing direction of the first surface and that is connected to an lower end of the second surface,
wherein a boundary portion between the second surface and the third surface faces the upper surface of the porous member.

31. The exposure apparatus according to claim 30, further comprising a second holding portion that is disposed around the first holding portion so as to releasably hold a cover member,
wherein the cover member includes the first surface, the second surface, and the third surface.

32. The exposure apparatus according to claim 28, wherein a contact angle of the second surface with respect to the liquid is smaller than a contact angle of the side surface of the substrate.

33. An exposure apparatus that exposes a substrate with exposure light via a liquid, comprising:
an optical member having an emission surface from which the exposure light is emitted;
a first holding portion that releasably holds a lower surface of the substrate;
a first surface that defines an aperture in which the substrate can be disposed and that is disposed around an upper surface of the substrate in a state where the substrate is held on the first holding portion;
a first space portion that is in communication with a gap between the upper surface of the substrate and the first surface;
a porous member disposed in the first space portion;
a second surface in which at least a part thereof faces a side surface of the substrate and which is inclined upward in an outward direction with respect to a center of the aperture; and
a third surface which faces in a direction opposed to a facing direction of the first surface and in which at least a part thereof faces an upper surface of the porous member,
wherein an immersion space is formed between the optical member and at least one of the upper surface of the substrate, the first surface, and the second surface, and at least a part of liquid of the immersion space, which has been flowed into between the third surface of the first space portion and the upper surface of the porous member via the gap, is recovered via holes of the porous member.

34. The exposure apparatus according to claim 33, further comprising a second holding portion that is disposed around the first holding portion so as to releasably hold a cover member,
wherein the cover member includes the first surface, the second surface, and the third surface.

35. The exposure apparatus according to claim 33, wherein a contact angle of the second surface with respect to the liquid is smaller than a contact angle of the side surface of the substrate.

36. An exposure apparatus that exposes a substrate with exposure light via a liquid, comprising:
an optical member having an emission surface from which the exposure light is emitted;
a substrate holding apparatus including a first holding portion that releasably holds the lower surface of the substrate, a first surface that defines an aperture in which the substrate can be disposed and that is disposed around an upper surface of the substrate in a state where the substrate is held on the first holding portion, and a first space portion that is in communication with a gap between the upper surface of the substrate and the first surface; and
a porous member that is disposed in the first space portion, that has an upper surface that faces the gap, and which has holes through which fluid in the first space portion is suctioned,
wherein a contact angle of an upper surface of the porous member with respect to the liquid is larger than a contact angle of the upper surface of the substrate.

37. An exposure apparatus that exposes a substrate with exposure light via a liquid, comprising:
an optical member having an emission surface from which the exposure light is emitted;
a substrate holding apparatus including a first holding portion that releasably holds a lower surface of the substrate, a first surface that defines an aperture in which the substrate can be disposed and that is disposed around an upper surface of the substrate in a state where the substrate is held on the first holding portion, and a first space portion that is in communication with a gap between the upper surface of the substrate and the first surface;
a porous member that is disposed in the first space portion, that has an upper surface that faces the gap, and that has holes through which fluid in the first space portion is suctioned; and
a liquid-repellent member which is disposed in at least a part of the upper surface, and which has a surface of which a contact angle with respect to the liquid is larger than that of the upper surface of the substrate.

38. An exposure apparatus that exposes a substrate with exposure light via a liquid, comprising:
an optical member having an emission surface from which the exposure light is emitted;
a substrate holding apparatus including a first holding portion that releasably holds a lower surface of the substrate, a first surface that defines an aperture in which the substrate can be disposed and that is disposed around an upper surface of the substrate in a state where the substrate is held on the first holding portion, and a first space portion that is in communication with a gap between the upper surface of the substrate and the first surface;
a first porous member that is disposed in the first space portion and that has first holes through which fluid in the first space portion is suctioned; and
a second porous member that is disposed in the upper surface of the first porous member so as to face the gap and that has second holes smaller than the first holes.

39. An exposure apparatus that exposes a substrate with exposure light via a liquid, comprising:
an optical member having an emission surface from which the exposure light is emitted;
a substrate holding apparatus including a first holding portion that releasably holds the lower surface of the substrate, a first surface that defines an aperture in which the substrate can be disposed and that is disposed around the upper surface of the substrate in a state where the substrate is held on the first holding portion, and a first space portion that is in communication with a gap between the upper surface of the substrate and the first surface;
a porous member that is disposed in the first space portion and that has first holes through which fluid in the first space portion is suctioned; and
a wire member disposed in the gap so that at least a part thereof is in contact with the porous member.

40. The exposure apparatus according to claim 36, further comprising:
a drive apparatus that moves the substrate holding apparatus in a state where the immersion space is formed with the liquid between the optical member and at least one of the upper surface of the substrate and the first surface; and
a gas supply port through which gas is supplied to the first space portion through the porous member when at least the immersion space is disposed on the gap.

41. An exposure apparatus that exposes a substrate with exposure light via a liquid, comprising:
an optical member having an emission surface from which the exposure light is emitted;
a first member that includes a first upper surface in which an immersion space of the liquid is formed between the emission surface and the first upper surface and that is movable to an irradiation position such that the first member is irradiated with the exposure light from the emission surface; and
a second member that includes a second upper surface which is disposed with a gap between the first upper surface and the second upper surface and in which the immersion space of the liquid is formed between the emission surface and the second upper surface, and that is movable to the irradiation position together with the first member,
wherein at least one of a first side surface of the first member that faces the second member and a second side surface of the second member that faces the first member is inclined upward in an outward direction with respect to a center of the first member.

42. An exposure apparatus that exposes a substrate with an exposure light via a liquid, comprising:
an optical member having an emission surface from which the exposure light is emitted;
a first member that includes a first upper surface in which an immersion space of the liquid is formed between the emission surface and the first upper surface and that is movable to an irradiation position such that the first member is irradiated with the exposure light from the emission surface; and
a second member that includes a second upper surface which is disposed with a gap between the first upper surface and the second upper surface and in which the immersion space of the liquid is formed between the emission surface and the second upper surface, and that is movable to the irradiation position together with the first member,
wherein at least one of a first side surface of the first member that faces the second member and a second side surface of the second member that faces the first member is inclined downward in an outward direction with respect to a center of the first member.

43. An exposure apparatus that exposes a substrate with an exposure light via a liquid interposed, comprising:
an optical member having an emission surface from which the exposure light is emitted;
a first member that includes a first upper surface; and
a second member that includes a second upper surface,
wherein the first member and the second member are movable to a position in a state where the first upper surface and the second upper surface are arranged in parallel with a gap interposed, an immersion space formed close to the emission surface is formed on the gap, and
wherein a first side surface of the first member that faces the second member includes an inclined surface that extends upward toward the second member.

44. The exposure apparatus according to claim 43,
wherein a second side surface of the second member that faces the first member includes an inclined surface that extends upward toward the first member.

45. The exposure apparatus according to claim 41,
wherein the first member and the second member are moved together so that the immersion space moves from one of the first upper surface and the second upper surface to the other upper surface.

46. The exposure apparatus according to claim 41, further comprising:
a first movable member that includes a first holding portion that holds and can release a lower surface of the substrate,
wherein the first member is held on the first movable member.

47. The exposure apparatus according to claim 46,
wherein the second member is held on the first movable member.

48. The exposure apparatus according to claim 47,
wherein the second member is disposed in at least a part of the position around the first member.

49. The exposure apparatus according to claim 47,
wherein the first member has an aperture, and
wherein the second member is disposed in the aperture.

50. The exposure apparatus according to claim 47,
wherein the second member includes a measuring member.

51. The exposure apparatus according to claim 46, further comprising:
a second movable member,
wherein the second member is held on the second movable member.

52. The exposure apparatus according to claim 51,
wherein the second movable member includes a second holding portion that holds and can release the lower surface of the substrate.

53. The exposure apparatus according to claim 41, further comprising:
a space portion that is in communication with the gap; and
a suction port that suctions fluid in the space portion.

54. The exposure apparatus according to claim 53,
wherein the liquid of the immersion space flowed into the space portion via the gap is suctioned from the suction port.

55. The exposure apparatus according to claim 53, further comprising:
a porous member that is disposed in the space portion,
wherein the liquid of the space portion is recovered via holes of the porous member.

56. The exposure apparatus according to claim 41,
wherein the first member includes at least one of the substrate, a substrate stage that holds the substrate and is movable, a measuring stage, a measuring member, a cover member, a dummy substrate, a scaling member, and an optical sensor.

57. The exposure apparatus according to claim 41,
wherein the second member includes at least one of the substrate, a substrate stage that holds the substrate and is movable, a measuring stage, a measuring member, a cover member, a dummy substrate, a scaling member, and an optical sensor.

58. A device-manufacturing method comprising:
exposing a substrate using the exposure apparatus according to claim 1; and
developing the exposed substrate.

59. An exposure method of exposing a substrate with exposure light via a liquid, comprising:
executing the exposure of the substrate while moving a substrate holding apparatus including a first holding portion that releasably holds a lower surface of the substrate, a first surface that defines an aperture in which the substrate can be disposed and that is disposed around the upper surface of the substrate in a state where the substrate is held on the first holding portion, and a first space portion that is in communication with a gap between the upper surface of the substrate and the first surface, in a state where an immersion space is formed with the liquid between an optical member having an emission surface from which the exposure light is emitted and at least one of the first surface of the substrate holding apparatus and the upper surface of the substrate;
suctioning fluid in the first space portion from a suction port with a first suction force in at least a part of a first period in which the exposure of the substrate is executed; and
suctioning fluid in the first space portion from the suction port with a second suction force larger than the first suction force in a second period in which the exposure of the substrate is not executed.

60. An exposure method of exposing a substrate with exposure light via a liquid, comprising:
executing the exposure of the substrate in a state where an immersion space is formed with the liquid between an optical member having an emission surface from which the exposure light is emitted and a substrate held on a first holding portion of a substrate holding apparatus;
adjusting the environment of a space in which the optical member and the substrate holding apparatus are disposed by supplying gas from a gas supply portion of a conditioning system to the space in at least a part of a first period in which the exposure of the substrate is executed; and
executing a process of suppressing at least a part of the gas from the gas supply portion from being supplied to the substrate holding apparatus in at least a part of a second period in which the exposure of the substrate is not executed.

61. The exposure method according to claim 60, wherein the second period includes a period in which the substrate is not held on the first holding portion, and
wherein at least a part of the gas from the gas supply portion is suppressed from being supplied to the first holding portion.

62. The exposure method according to claim 60, wherein the processing of suppressing includes shutting the gas supply portion with a shutter member.

63. The exposure method according to claim 60, wherein the process of suppressing includes holding a dummy substrate by the first holding portion.

64. An exposure method of exposing a substrate with exposure light via a liquid, comprising:
executing the exposure of the substrate in a state where an immersion space is formed with the liquid between an optical member having an emission surface from which the exposure light is emitted and at least one of a first surface of a substrate holding apparatus and an upper surface of the substrate, the substrate holding apparatus including a first holding portion that releasably holds a lower surface of the substrate, the first surface that defines an aperture in which the substrate can be disposed and that is disposed around the upper surface of the substrate in a state where the substrate is held on the first holding portion, a second surface which a side surface of the substrate faces, and of which a contact angle with respect to the liquid is smaller than that of the side surface of the substrate, and a first space portion that is in communication with a gap between the upper surface of the substrate and the first surface;
suctioning fluid in the first space portion from a suction port in at least a part of a first period in which the exposure of the substrate is executed; and
suctioning fluid from the suction port in a state where an object is held on the first holding portion in at least a part of a second period in which the exposure of the substrate is not executed.

65. An exposure method of exposing a substrate with exposure light via a liquid, comprising:
executing the exposure of the substrate in a state where an immersion space is formed with the liquid between an optical member having an emission surface from which the exposure light is emitted and at least one of a first surface of a substrate holding apparatus and an upper surface of the substrate, the substrate holding apparatus including a first holding portion that releasably holds a lower surface of the substrate, the first surface that defines an aperture in which the substrate can be disposed and that is disposed around the upper surface of the substrate in a state where the substrate is held on the first holding portion, a second surface which a side surface of the substrate faces, and a first space portion that is in communication with a gap between the upper surface of the substrate and the first surface;
suctioning fluid in the first space portion from a suction port in at least a part of a first period in which the exposure of the substrate is executed; and
suctioning fluid in the first space portion from the suction port in a state where an immersion space is formed with the liquid between the optical member and the first surface and the upper surface of an object held on the first holding portion in at least a part of a second period in which the exposure of the substrate is not executed.

66. The exposure method according to claim 65, wherein a contact angle of a side surface of the object facing the second surface with respect to the liquid is smaller than that of the side surface of the substrate.

67. An exposure method of exposing a substrate with exposure light via a liquid, comprising:
exposing the substrate in a state where an immersion space is formed with the liquid between an optical member having an emission surface from which the exposure light is emitted and at least one of an upper surface of the substrate held on a first holding portion that releasably holds a lower surface of the substrate and a first surface that defines an aperture in which the substrate can be disposed and that is disposed around an upper surface of the substrate in a state where the substrate is held on the first holding portion; and
recovering, via holes of a porous member, at least a part of the liquid of the immersion space, which has been flowed via a gap between the upper surface of the substrate and the first surface and into between an upper surface of the porous member disposed in a first space portion that is in communication with the gap and a second surface in which at least a part thereof faces the upper surface of the porous member and which is inclined downward in an outward direction with respect to a center of the aperture.

68. An exposure method of exposing a substrate with exposure light via a liquid, comprising:
exposing the substrate in a state where an immersion space is formed with the liquid between an optical member having an emission surface from which the exposure light is emitted and at least one of an upper surface of the substrate held on a first holding portion that releasably holds the lower surface of the substrate, a first surface that defines an aperture in which the substrate can be disposed and that is disposed around the upper surface of the substrate in a state where the substrate is held on the first holding portion, and a second surface in which at least a part thereof faces the side surface of the substrate and which is inclined upward in an outward direction with respect to a center of the aperture; and
recovering, through the holes of a porous member, at least a part of the liquid of the immersion space, which has been flowed via a gap between an upper surface of the substrate and the first surface and into between an upper surface of the porous member disposed in a first space portion that is in communication with the gap and a third surface which faces in a direction opposed to a facing direction of the first surface, and in which at least a part thereof faces the upper surface of the porous member.

69. An exposure method of exposing a substrate with exposure light via a liquid interposed, the method comprising:
exposing the substrate in a state where an immersion space is formed with the liquid between an optical member that includes an emission surface from which the exposure light is emitted and an upper surface of the substrate that is held on a first holding portion that releasably holds a lower surface of the substrate; and
forming the immersion space between the emission surface and at least one of a first upper surface of a first member that is movable to an irradiation position such that the first member is irradiated with the exposure light from the emission surface and a second upper surface of a second member that is disposed with a gap interposed between the first upper surface and the second upper surface and is movable to the irradiation position together with the first member,
wherein at least one of a first side surface of the first member that faces the second member and a second side surface of the second member that faces the first member is inclined upward in an outward direction with respect to a center of the first member.

70. An exposure method of exposing a substrate with an exposure light via a liquid interposed, comprising:
exposing the substrate in a state where an immersion space is formed with the liquid between an optical member that includes an emission surface from which the exposure light is emitted and an upper surface of the substrate that is held on a first holding portion that releasably holds a lower surface of the substrate; and
forming the immersion space between the emission surface and at least one of a first upper surface of a first member that is movable to an irradiation position such that the first member is irradiated with the exposure light from the emission surface and a second upper surface of a second member that is disposed with a gap interposed between the first upper surface and the second upper surface and is movable to the irradiation position together with the first member,
wherein at least one of a first side surface of the first member that faces the second member and a second side surface of the second member that faces the first member is inclined downward in an outward direction with respect to a center of the first member.

71. A device-manufacturing method comprising:
exposing a substrate using the exposure method according to claim 59; and
developing the exposed substrate.

72. A program for causing a computer to execute control of an exposure apparatus that exposes a substrate with exposure light via a liquid, the control comprising:
executing the exposure of the substrate while moving a substrate holding apparatus including a first holding portion that releasably holds a lower surface of the substrate, a first surface that defines an aperture in which the substrate can be disposed and that is disposed around the upper surface of the substrate in a state where the substrate is held on the first holding portion, and a first space portion that is in communication with a gap between the upper surface of the substrate and the first surface, in a state where an immersion space is formed with the liquid between an optical member having an emission surface from which the exposure light is emitted and at least one of the first surface of the substrate holding apparatus and the upper surface of the substrate;
suctioning fluid in the first space portion from a suction port with a first suction force in at least a part of a first period in which the exposure of the substrate is executed; and
suctioning fluid in the first space portion from the suction port with a second suction force larger than the first suction force in a second period in which the exposure of the substrate is not executed.

73. A program for causing a computer to execute control of an exposure apparatus that exposes a substrate with exposure light via a liquid, and to execute the steps of:
executing the exposure of the substrate in a state where an immersion space is formed with the liquid between an optical member having an emission surface from which the exposure light is emitted and a substrate held on a first holding portion of a substrate holding apparatus;
adjusting the environment of a space in which the optical member and the substrate holding apparatus are disposed by supplying gas from a gas supply portion of a conditioning system to the space in at least a part of a first period in which the exposure of the substrate is executed; and
executing a process of suppressing at least a part of the gas from the gas supply portion from being supplied to the substrate holding apparatus in at least a part of a second period in which the exposure of the substrate is not executed.

74. A program for causing a computer to execute control of an exposure apparatus that exposes a substrate with exposure light via a liquid, and to execute the steps of:
executing the exposure of the substrate in a state where an immersion space is formed with the liquid between an optical member having an emission surface from which exposure light is emitted and at least one of a first surface of a substrate holding apparatus and the upper surface of the substrate, the substrate holding apparatus including a first holding portion that releasably holds a lower surface of the substrate, the first surface that defines an aperture in which the substrate can be disposed and that is disposed around the upper surface of the substrate in a state where the substrate is held on the first holding portion, a second surface which the side surface of the substrate faces, and of which the contact angle with respect to the liquid is smaller than that of the side surface of the substrate, and a first space portion that is in communication with a gap between the upper surface of the substrate and the first surface;
suctioning fluid in the first space portion from a suction port in at least a part of a first period in which the exposure of the substrate is executed; and
suctioning fluid from the suction port in a state where an object is held on the first holding portion in at least a part of a second period in which the exposure of the substrate is not executed.

75. A program for causing a computer to execute control of an exposure apparatus that exposes a substrate with exposure light via a liquid, and to execute the steps of:
executing the exposure of the substrate in a state where an immersion space is formed with the liquid between an optical member having an emission surface from which exposure light is emitted and at least one of a first surface of a substrate holding apparatus and the upper surface of the substrate, the substrate holding apparatus including a first holding portion that releasably holds a lower surface of the substrate, the first surface that defines an aperture in which the substrate can be disposed and that is disposed around the upper surface of the substrate in a state where the substrate is held on the first holding portion, a second surface which the side surface of the substrate faces, and a first space portion that is in communication with a gap between the upper surface of the substrate and the first surface;
suctioning fluid in the first space portion from a suction port in at least a part of a first period in which the exposure of the substrate is executed; and
suctioning fluid in the first space portion from the suction port in a state where an immersion space is formed with the liquid between the optical member and the first surface and the upper surface of an object held on the first holding portion in at least a part of a second period in which the exposure of the substrate is not executed.

76. A program for causing a computer to execute control of an exposure apparatus that exposes a substrate with exposure light via a liquid, and to execute the steps of:
exposing the substrate in a state where an immersion space is formed with the liquid between an optical member having an emission surface from which exposure light is emitted and at least one of the upper surface of the substrate held on a first holding portion that releasably holds the lower surface of the substrate and a first surface that defines an aperture in which the substrate can be disposed and that is disposed around the upper surface of the substrate in a state where the substrate is held on the first holding portion; and
recovering, through the holes of a porous member, at least a part of the liquid of the immersion space, which has been flowed via a gap between the upper surface of the substrate and the first surface and into between the upper surface of the porous member disposed in a first space portion that is in communication with the gap and a second surface in which at least a part thereof faces the upper surface of the porous member and which is inclined downward in an outward direction with respect to a center of the aperture.

77. A program for causing a computer to execute control of an exposure apparatus that exposes a substrate with exposure light via a liquid, and to execute the steps of:
exposing the substrate in a state where an immersion space is formed with the liquid between an optical member having an emission surface from which the exposure light is emitted and at least one of an upper surface of the substrate held on a first holding portion that releasably holds the lower surface of the substrate, a first surface that defines an aperture in which the substrate can be disposed and that is disposed around the upper surface of the substrate in a state where the substrate is held on the first holding portion, and a second surface in which at least a part thereof faces a side surface of the substrate and which is inclined upward in an outward direction with respect to a center of the aperture; and
recovering, via holes of a porous member, at least a part of the liquid of the immersion space, which has been flowed via a gap between the upper surface of the substrate and the first surface and into between an upper surface of the porous member disposed in a first space portion that is in communication with the gap and a third surface which faces the opposite direction of the first surface, and in which at least a part thereof faces the upper surface of the porous member.

78. A program for causing a computer to execute control of an exposure apparatus that exposes a substrate with exposure light via a liquid interposed, and to execute the steps of:
exposing the substrate in a state where an immersion space is formed with the liquid between an optical member that includes an emission surface from which the exposure light is emitted and an upper surface of the substrate that is held on a first holding portion that releasably holds a lower surface of the substrate; and
forming the immersion space between the emission surface and at least one of a first upper surface of a first member that is movable to an irradiation position such that the first member is irradiated with the exposure light from the emission surface and a second upper surface of a second member that is disposed with a gap interposed between the first upper surface and the second upper surface and is movable to the irradiation position together with the first member,
wherein at least one of a first side surface of the first member that faces the second member and a second side surface of the second member that faces the first member is inclined upward in an outward direction with respect to the center of the first member.

79. A program for causing a computer to execute control of an exposure apparatus that exposes a substrate with exposure light via a liquid, and to execute the steps of:
exposing the substrate in a state where an immersion space is formed with the liquid between an optical member that includes an emission surface from which the exposure light is emitted and an upper surface of the substrate that is held on a first holding portion that holds and can release a lower surface of the substrate; and
forming the immersion space between the emission surface and at least one of a first upper surface of a first member that is movable to an irradiation position such that the first member is irradiated with the exposure light from the emission surface and a second upper surface of a second member that is disposed with a gap interposed between the first upper surface and the second upper surface and is movable to the irradiation position together with the first member,
wherein at least one of a first side surface of the first member that faces the second member and a second side surface of the second member that faces the first member is inclined downward in an outward direction with respect to a center of the first member.

80. A computer-readable recording medium in which the program according to claim 72 is recorded.
